(19) United States
(12) Patent Application Publication
(10) Pub. No.: US 2024/0296352 A1
(43) Pub. Date: Sep. 5, 2024

(54) ARTIFICIAL INTELLIGENCE ENHANCED KNOWLEDGE FRAMEWORK

(71) Applicant: KPMG LLP, New York, NY (US)

(72) Inventors: John A. YANOSY, JR., Grapevine, TX (US); Anu PUVVADA, Houston, TX (US); Stephanie KIM, New York, NY (US); Andrew URBAN, Seattle, WA (US); Michael SISSELMAN, Lakeville, CT (US)

(21) Appl. No.: 18/477,817

(22) Filed: Sep. 29, 2023

Related U.S. Application Data
(63) Continuation-in-part of application No. 18/116,176, filed on Mar. 1, 2023.
(60) Provisional application No. 63/468,192, filed on May 22, 2023.

(51) Int. Cl. G06N 5/022

(52) U.S. Cl. CPC G06N 5/022

(57) ABSTRACT

A computer-implemented system, a method, and computer products for development and use of a knowledge framework are provided. The system comprises one or more processors and a memory including computer program code. The computer program code is configured to, when executed, cause the one or more processors to perform various tasks. These tasks include receive session data related to responses received from a participant in a session, receive machine learning data, create or enhance the knowledge framework based on the machine learning data and the session data, and create additional machine learning data using the knowledge framework as a source of information. The method performs these tasks, and the computer readable medium contains similar computer program code. The method can perform these tasks with computer synergistic generative artificial intelligence, machine learning, and knowledge framework subsystems.

### CROSS REFERENCE TO RELATED APPLICATIONS

This patent application claims priority to and is a continuation-in-part of U.S. patent application Ser. No. 18/116,176 entitled “Universal Assessment System”, which was filed on Mar. 1, 2023, and also claims priority to U.S. Provisional Pat. App. No. 63/468,192 entitled “Artificial Intelligence Enhanced Knowledge Framework”, which was filed on May 22, 2023, and the disclosure of each is incorporated by reference herein in their entireties as part of the present application.

### FIELD OF THE INVENTION

Embodiments of the present invention relate generally to a system for generating a knowledge framework that integrates knowledge obtained from a machine learning unit, sessions focused on acquiring knowledge from participants, external information sources, and embodiments of the present invention also relate to an assessment theory model and, in particular, to a universal assessment theory model that can be refined for a specific assessment object being assessed, which can be of various types.

### BACKGROUND OF THE INVENTION

Current assessments ignore context and the causal influential relationships between intrinsic characteristics of an assessment object and the extrinsic characteristics of an external environment. Current assessments do not specify the semantics of its core concepts, specify any logical relationships in a model, or impose any requirements for data driven evidence-based objectivity. Thus, the determinations made by current assessment models tend to have lower accuracies. Current assessment models are unable to discover, semantically integrate, and interpret information acquired from multiple sources that are relevant to an assessment object having various levels of common understanding and maturity of embodiment.

Furthermore, the intrinsic characteristics of an object are at best subjective assessments relying on experts (or even non-experts) to examine their experiences and to make inferences based on their experiences. Often times, there is not specific information provided to enable a judgement of the trustworthiness of the response. Thus, these approaches have a high risk of subjectivity and low trustworthiness of the responses, depending on the information source's credibility. With current assessment models, specific knowledge of the necessary information is required to provide an objective assessment. Any weighting or scoring system cannot resolve such difficulties, since there is no way to identify those responses that are based on some evidence and those that were not.

There is a need for a theory to transform subjective assessments into objective assessments that account for the context of an assessment and help define what should be assessed in this context, and how the causal effects of an assessment object's intrinsic characteristics affect or are affected by the environmental context.

Large language models that currently exist are currently static and do not evolve over time. Further large language models that are currently available often lack a focus on critical context areas, making the large language models that are available have limited benefit to a particular client.

### BRIEF SUMMARY OF THE INVENTION

Various embodiments described herein provide a computer-implemented system, a method, and computer products for development and use of a knowledge framework. In developing the knowledge framework, session data and machine learning data can be used, with session data being from sessions with participants. Even after the knowledge framework has been developed, the knowledge framework may be enhanced further over time as additional session data or machine learning data is received. The knowledge framework can eventually be used to assist in creating additional machine learning data. Thus, there can effectively be a “two way street” between the knowledge framework and machine learning units that provide machine learning data, with machine learning data being provided in one direction to the knowledge framework to assist in creating or improving the knowledge framework, and with the knowledge framework providing information in the opposite direction to machine learning units to help facilitate the creation of additional machine learning data. The knowledge framework can be a large language model in some embodiments, but other types of knowledge frameworks are also contemplated.

In one example embodiment, a hybrid system of a knowledge framework and generative artificial intelligence is provided having one or more ontologies representing different areas of knowledge in the knowledge framework. The hybrid system can also include knowledge graphs consistent with the ontologies in the knowledge framework representing instance data, and the hybrid system can also include generative artificial intelligence technologies. The hybrid system can enable evolution of the ontologies via use of generative artificial intelligence discovering concepts in information sources and its corpus. The hybrid system can also enable expansion of the knowledge graphs by discovering and extracting data using generative artificial intelligence guided by the ontologies in the knowledge framework. Additionally, the hybrid system can enable discovery of facts relevant to a question or query in natural language via the combined sue of generative artificial intelligence to interpret the natural language question or query and then to create a standards based machine query to the knowledge graph to find relevant facts to the query and provide answers to the question. The hybrid system can also enable discovery of facts in external documents relevant to the natural language question guided by the ontology and the use of generative artificial intelligence to find and extract facts from external sources and assert them to the knowledge graphs and to provide answers to the questions.

Various embodiments described herein provide an assessment theory model for use in making assessments of certain assessment objects, with the assessment object being provided in some environment context. The assessment theory model can provide a semantic and logical knowledge framework that can be used to design any assessment model for any kind of assessment object, for a wide variety of environment contexts, and with any number of extrinsic characteristics. The assessment theory model can help identify causal relationships between the intrinsic characteristics of the assessment object and the environment context.

The assessment theory model guides the creation and definition of more specific models by helping to define the understanding of what should be considered in an assessment. The assessment theory model also helps to ensure that the assessment takes into account environmental context for the assessment object being assessed as well as the potential categories for the assessment object. The assessment theory model also guides the determination of the scope and focus of the questions, which can be defined to solicit responses that will illuminate or clarify the intrinsic characteristics of the assessment object in each environmental context.

In addition, the assessment theory model can support objectivity and high-quality assessments. The assessment theory model can permit or require evidence and/or rationales in support of answers. Further, the assessment theory model can require that necessary objective evidence be provided to support the rationale for each response. The semantics of the core concepts of the assessment theory model are defined as having a specific role and meaning in the overall model as well as a set of relationships between them that form the logical ontological model, and the logical model can be defined with model level axioms in an ontology.

In some embodiments, methods and approaches for scoring responses can be provided. These methods can provide base scores based on the particular response, and various factors can be used to provide a weighted score that is adjusted up or down from the base score. Factors that can be used include an importance factor, a trustworthiness factor, and a certainty factor. Using the factors, weighted scores can be provided for each response. Additionally or alternatively, weighted scores can be provided for certain intermediary decisions (e.g. total risk level, opportunity level, etc.) or to provide an overall score so that a final decision can be made. Through the use of the scoring approaches, scoring can be conducted in a manner that reduces or completely eliminates bias so that more accurate decisions can be made based on the scoring.

Various screens can be presented to respondents in a display, and the screens can elicit responses from the respondents and/or present information about the assessment to the respondent. The screens can prompt users to provide responses, which can include a specific answer, a supporting rationale, and supporting evidence. As more and more responses are received, the information about the assessment can be further refined. Screens can present various metric information to the user, and this metric information can include a final decision, intermediate decisions (e.g. risk level, opportunity level, etc.), or more specific information. In some embodiments, screens can present information about a specific characteristic. Metric information can be presented to the user in an easily understandable manner, with metric information indicating whether a certain assessment value response is high, medium, or low in value. The screens can be generated by a user interface generator.

In some embodiments, an exemplary innovation assessment knowledge system can be provided. This system can have a designed architecture that defines and semantically integrates logical and computational models to transform subjective assessments into objective assessments. The system can be defined with multiple ontologies representing specific and universal assessment model knowledge. Additionally, ontologies enable flexible definitions of multiple models to be provided for interpreting assessment responses with different scoring models, categories, questions, etc. In some embodiments, models can adapt the assessment model as responses are received (e.g., to better focus on areas of uncertainty, etc.). The system can include innovation taxonomy concepts organized as assessment categories, assessment types, and weighting factor concepts to represent levels of certainty and importance, defined default answers for each question with base score contribution value for answers to each question, and various assessment phase modules for organizing sequential assessment phases and relevant questions and categories. The system can also include an assessment classification and scoring model that represents the impact of each question to an overall assessment as well as the question's scoring impact by category and assessment phase. The system can also include a decision classification system (e.g. perish, pivot, or persevere) that is objectively determined by the survey response scoring model and the categories and questions relevant to that phase of the assessment. Various embodiments of the system beneficially enable objective decision classifications using semantic, logical, and quantitative reasoning, where the categories, environment context, questions, default answers and decision phases are defined semantically by the system ontologies. The logical definitions can organize the semantic concepts just mentioned by relationships defined in the ontology, while quantitative reasoning can be enabled by the base score values assigned to each question's set of default answers and a set of ontology inferential reasoning and knowledge queries to aggregate the assessment score by question, category, phase, and total for previously defined decision classifications. The system can include definitions for categories with specific questions defined to illuminate the innovation characteristics effects from different perspectives. Categories also have specific questions defined to explore the nature of the intrinsic or extrinsic category. Questions can be provided with default answers that the user can select from, and default answers can have a base score (e.g. in the range of −5 to +5). Weighted scores can be generated based on answers, evidence, and rationales provided in response to questions, with the weighted scores being adjusted based on trustworthiness of responses, uncertainty in the responses, and/or importance in the responses.

Various systems described herein can integrate knowledge obtained from a machine learning unit or from other external information sources with other information obtained from sessions to generate a knowledge framework. The sessions can be conducted with a participant and/or a client. Systems can have the unique capability of creating a structured design session instance based on an agenda or goal and a context focused session guidance structure ontology instance. Information can be obtained in sessions to obtain information about areas that are important to a client, and the knowledge framework can be updated based on input from the session.

Session ontologies can provide a structure of prompt-response patterns correlated with the agenda, topics of interest, and aspects of topics that are most likely in a relevant context. An initial session design can create the hierarchical tree-like structure of prompt-response patterns. Creation of prompt-response patterns can be initiated by starting from more general topics or aspects of a topic and developing over time to a more detailed prompt-response pattern. Prompt-response patterns can all be related to specific taxonomies.

Various embodiments enable identification of keyword phrases or aspirational statements based on a context. Various keyword phrases and aspirational statements can be particularly relevant in one context and can be completely irrelevant in another context. For example, where a company is in the oil and gas industry and a session is being conducted with a person in a functional role of analyst, then keyword phrases and aspirational statements with positive, negative, or neutral connotations can be significantly different from another context where the company is in the legal industry and a session is being conducted with a person in the functional role of human resources. Identification of keyword phrases or aspirational statements based on a context can provide a potential advantage over other standards-based datasets, which do not integrate and interpret such identification based on context like the industry and functional role. By having knowledge of context for responses (e.g., an industry of a client, a functional role of a participant at the client company, etc.), unique aspirational statements and keyword phrases can be identified that are not contained in other standard datasets for statement analysis. Statements can be evolved for focus topics as the understanding of the context is refined.

Various embodiments of the present invention discussed herein provide numerous benefits. For example, various embodiments provide a capability to learn knowledge about various perspectives of different topics from sessions, with knowledge being obtained based on the specific context and about different aspects of the topics. Embodiments also provide a capability to dynamically adjust sessions interactions to focus on relevant topics, aspects, and contexts based on responses in sessions. Some embodiments provide a capability to define and evolve unique sessions for defining prompt-response patterns related to different focus topics. Resulting participant responses to prompts tend to increase understanding of a client perspective for one or more aspects of the focus topic. Responses can possibly also increase understanding of a client perspective within one or more contexts. Some embodiments provide a capability to evolve taxonomies described herein over the course of one or more sessions.

For some embodiments, a structured hierarchy of prompt-response patterns is initially created. Some aspects or all aspects of this structured hierarchy can optionally be created using a machine learning unit. This structured hierarchy can be formed so that it will accomplish a session agenda and strategic goal. The session agenda and strategic goal can help to extract a meaning for each prompt-response pattern in the session with the seed top taxonomies.

In some embodiments, the prompt-session patterns that are utilized in a session can dynamically evolve by considering actual participant responses. Embodiments can potentially include the ability to modify a prompt-response pattern itself within a session with additional prompt-response patterns to focus on more details in response to the client. Additional embodiments can optionally include the ability to evolve the topic taxonomies with new data about more specialized contexts.

The knowledge framework unit stores a knowledge framework. The knowledge framework can initially include multiple a priori defined perspectives. These a priori defined perspectives can have focus topic, aspect, and structure prompts for client response. Over time, the knowledge framework can evolve as session data is added, with the session data being related to a priori defined focus topic taxonomies. The focus topic taxonomies can include the context, the aspect of the topic, and relevant concepts as keyword phrases (potential responses) expressing some aspect of the focus topic to an associated prompt, and related prompt-response patterns in sessions that trigger the response.

The knowledge framework can also work in conjunction with other high level purposeful insight ontologies. The purposeful insight ontologies can infer from the asserted session facts about the focus areas, aspects of the topic, and responses to structured prompts from a defined perspective. The purposeful insight ontologies can also obtain a set of both semantic and quantified insights from axioms defined in the purposeful insight ontologies.

As sessions are conducted, purposeful insight ontologies can work to infer new facts from the asserted session data. For example, a session can indicate a high level of positive interest for any innovation that would increase the efficiency of their manufacturing operations or a need for some innovation that would increase employee retention. This response can trigger a machine learning unit to change the path from the current prompt-response pattern to another node in the structure or to search for and append a different prompt-response pattern from its understanding of the actual response with a specific prompt-response pattern that is relevant to a specific topic, prompt, or response in another topic taxonomy.

Another capability is to integrate multiple perspectives of defined sessions with clients with a defined goal informed by a focus topic and an aspect of a topic from client perspectives. Systems can be capable of evolving both a universal session structure taxonomy and the universal topic taxonomy from machine learning unit inferences about the session responses across participants in a session. Systems can also be capable of evolving both the universal session structure taxonomy and the universal topic taxonomy from machine learning unit inferences about the session responses across different sessions.

Some embodiments provide a capability to define multiple contexts by which the system interprets a client response as being either unique to a particular context or generic in nature. Aspirational statement a priori beliefs have been found, and these can include unique keyword phrases for industry and functional role contexts. This can be advantageous over other approaches that fail to account for industry and functional role contexts.

Some embodiments provide a capability to evolve aspirational statements for particular focus topic, contexts, etc. This can be accomplished by comparing client aspirational statements to aspirational statements already existing in a knowledge framework unit. If client aspirational statements are unique to the statements already existing in the knowledge framework unit, they are added to this knowledge framework unit. As aspirational statements are added to a knowledge framework unit the aspirational statements can be added with context and/or metadata associated with the aspirational statements. Aspirational statements and associated data can be added in a semantically appropriate format so that they can be added to the knowledge framework unit, and hypernym and hyponym relationships to other statement keywords and synonyms can be identified and stored in the knowledge framework unit.

Some embodiments provide a capability to use machine learning unit discover an initial set of aspirational statements based on context (e.g. for a particular focus topic, context, industry, functional role, etc.). This capability was also able to create syntactically correct data assertions to the knowledge base ontologies and taxonomies, and this can be accomplished using the domain language defined for ontologies and taxonomies. Systems can have a capability to automatically infer insights about a client's or client participant's perspective of an innovation opportunity. The insights can be obtained to evaluate whether there is a positive or negative view towards an innovation opportunity. The insights can provide the ability to understand which functional areas would have the most benefit. Systems can have a capability to align client data of innovation statement with larger industry and functional role statements. This capability can enable identification of focus areas for a particular client or client participant.

Focus topics and taxonomies for prompt-response patterns can represent a set of possible responses according to some aspect or perspective of the focus topic, and this can enable interpretation of the responses according to the context of the session, the prompt, and the current context knowledge for the topic and aspect. The interpretation of responses can then be used to evolve the overall focus topic context knowledge from the session, and the interpretation of responses can enable multiple queries and uses of this knowledge to support different organization purposes.

In an example embodiment, a system capable of making an assessment of an assessment object is provided. The system comprises an inquiry module configured to generate questions, a user interface module configured to receive from a user responses to the questions, a scoring module configured to generate a score based on the responses from the user, and a decision module that generates the assessment based on the score and the responses. Additionally, in some embodiments, the system can also comprise a relationship module configured to identify a causal relationship between an extrinsic characteristic of an environment context and an intrinsic characteristic of the assessment object, and the decision module can be configured to make the assessment based on the causal relationship.

In some embodiments, the system can be capable of making assessments of different assessment object types within one or more influencing environments. The system can have one or more defined assessment models defining sets of questions for a defined assessment object and extrinsic characteristics, and each defined assessment model of the defined assessment model(s) can have one or more scoring models. Furthermore, in some embodiments, the inquiry module can be configured to generate a refined question based on a previous response.

In some embodiments, the scoring module can comprise a base scoring module that is configured to generate a base score for at least one response of the responses, one or more additional modules that are configured to provide one or more scoring adjustments to the base score for the response(s), and a weighted scoring module that generates the score for the response(s) based on the base score and the scoring adjustment(s). The decision module can make the assessment based on the score. Additionally, in some embodiments, the additional module(s) can include an importance module, and the importance module can be configured to provide an importance level scoring adjustment based on an importance level of the response(s). In some embodiments, the additional module(s) can include a trustworthiness module. The trustworthiness module can be configured to provide a trustworthiness scoring adjustment based on a trustworthiness of the response(s), and the trustworthiness scoring adjustment can be impacted by at least one of a detected bias in the response(s), consistency with an additional response, or inconsistency with the additional response. Furthermore, in some embodiments, the additional module(s) can include a certainty module, and the certainty module can be configured to provide a certainty scoring adjustment based on an uncertainty level of the response(s). Additionally, the response(s) can include an answer, a rationale in support of the answer, and evidence in support of at least one of the answer or the rationale, and the additional module(s) can be configured to provide one or more scoring adjustments to the base score for the response(s) based on the rationale and the evidence.

In some embodiments, the system can also comprise an assessment knowledge module that stores one or more ontologies, a knowledge base query module that is configured to load material for use in the assessment, and an extraction module that receives the responses and extracts relevant answers, rationales, and evidence from the responses. Furthermore, in some embodiments, the one or more ontologies can include an assessment theory ontology, a question survey ontology, a journey ontology, a decision ontology, a decision gate ontology, and an assessment analysis ontology.

In some embodiments, the system can also include a display, the system can be configured to cause the presentation of questions on the display, and the system can be configured to present metric information with a final decision or an intermediate decision of the assessment. Additionally, in some embodiments, the system can also comprise an improvement module that assesses a potential task that improves the score, and the improvement module can cause presentation of the potential task on a display.

In some embodiments, the system also includes a machine learning module that uses machine learning to carry out other tasks. The machine learning module can be configured to receive one or more data points, create a model that is configured to generate a model predicted output, minimize error between the model predicted output and an actual output for the one or more data points, calculate an error rate between the model predicted output and the actual output for the one or more data points, determine whether the error rate is sufficiently low, receive additional data points upon a determination that the error rate is sufficiently low, provide a predicted output data value for the additional data points using the model upon a determination that the error rate is sufficiently low, and modify the model based on the supplemental data points upon a determination that the error rate is sufficiently low.

In some embodiments, the system also includes a scoring module that generates a weighted score for the assessment. The scoring module can be configured to receive at least one response from a user, determine a base score for the response(s), determine at least one scoring adjustment based on at least one additional factor, and determine the weighted score for the response using the base score and the scoring adjustment(s).

In another example embodiment, a method capable of making an assessment of an assessment object is provided. The method comprises receiving at least one response, determining a base score for the response(s), determining at least one scoring adjustment based on at least one additional factor, determining a weighted score for the response(s) using the base score and the scoring adjustment(s), and making the assessment based on the weighted score. In some embodiments, the scoring adjustment(s) can include an importance level scoring adjustment based on an importance level of the response. Additionally, in some embodiments, the scoring adjustment(s) can include a trustworthiness scoring adjustment based on a trustworthiness of the response(s), and the trustworthiness scoring adjustment can be impacted by at least one of a detected bias in the response(s), consistency with an additional response, or inconsistency with the additional response. Furthermore, in some embodiments, the scoring adjustment(s) can include a certainty scoring adjustment based on an uncertainty level of the response.

In another example embodiment, a non-transitory computer readable medium is provided having stored thereon software instructions that, when executed by a processor, cause the processor to receive at least one response, determine a base score for the response(s), determine at least one scoring adjustment based on at least one additional factor, determine a weighted score for the response(s) using the base score and the scoring adjustment(s), and make an assessment based on the weighted score. In some embodiments, the scoring adjustment(s) can include an importance level scoring adjustment based on an importance level of the response. Additionally, in some embodiments, the scoring adjustment(s) can include a trustworthiness scoring adjustment based on a trustworthiness of the response(s), and the trustworthiness scoring adjustment can be impacted by at least one of a detected bias in the response(s), consistency with an additional response, or inconsistency with the additional response. Furthermore, in some embodiments, the scoring adjustment(s) include a certainty scoring adjustment based on an uncertainty level of the response.

In another example embodiment, a system for making an assessment of an assessment object is provided. The system comprises a processor and memory. The memory has stored thereon software instructions that, when executed by a processor, cause the processor to receive at least one response, determine a base score for the response(s), determine at least one scoring adjustment based on at least one additional factor, determine a weighted score for the response(s) using the base score and the scoring adjustment(s), and make an assessment based on the weighted score. In some embodiments, the scoring adjustment(s) include an importance level scoring adjustment based on an importance level of the response. Additionally, in some embodiments, the scoring adjustment(s) include a trustworthiness scoring adjustment based on a trustworthiness of the response(s), wherein the trustworthiness scoring adjustment is impacted by at least one of a detected bias in the response(s), consistency with an additional response, or inconsistency with the additional response. In some embodiments, the scoring adjustment(s) include a certainty scoring adjustment based on an uncertainty level of the response.

In an example embodiment, a computer-implemented system for development and use of a knowledge framework is provided. The system comprises one or more processors and a memory including computer program code. The computer program code is configured to, when executed, cause the processor(s) to receive session data related to responses received from a participant in a session, to receive machine learning data, to create or enhance the knowledge framework based on the machine learning data and the session data, and create additional machine learning data using the knowledge framework as a source of information.

In some embodiments, the processor(s) can include a session unit, a machine learning unit, and a knowledge framework unit. The session unit can be configured to generate the session data, and the machine learning unit can be configured to generate the machine learning data. Additionally, the knowledge framework unit can be configured to develop the knowledge framework by receiving the machine learning data from the machine learning unit, by receiving the session data from the session unit, and by creating or enhancing the knowledge framework based on the machine learning data and the session data.

In some embodiments, the knowledge framework can be iteratively enhanced based on the machine learning data and the session data. In some embodiments, the computer program code can be configured to, when executed, cause the processor(s) to filter the machine learning data and the session data before use of the machine learning data and the session data in creating or enhancing the knowledge framework. Additionally, in some embodiments, the machine learning data and the session data can be filtered by identifying data that is trustworthy and data that is untrustworthy, and only the data that is trustworthy can be used to create or enhance the knowledge framework.

In some embodiments, the computer program code can be configured to, when executed, cause the processor(s) to verify further machine learning data using the knowledge framework. Additionally, in some embodiments, verifying the further machine learning data using the knowledge framework can be performed automatically and periodically.

In some embodiments, the knowledge framework is a large language model. Furthermore, in some embodiments, the knowledge framework comprises an ontology or a taxonomy, and creating or enhancing the knowledge framework is performed by evolving the ontology or the taxonomy within the knowledge framework unit based on the machine learning data.

In some embodiments, the computer program code can be configured to, when executed, cause the processor(s) to receive input data from at least one external source and classify the input data to form classified input data for use in the knowledge framework. Also, in some embodiments, the computer program code can be configured to, when executed, cause the processor(s) to transform the classified input data into a different format for use in the knowledge framework. Additionally, in some embodiments, the computer program code can be configured to, when executed, cause the processor(s) to transform the classified input data so that the classified input data semantically aligns with language of a taxonomy or an ontology in the knowledge framework. Furthermore, in some embodiments, the session data can include a participant response, and the computer program code can be configured to, when executed, cause the processor(s) to assess whether a topic taxonomy instance is applicable to the participant response and can optionally cause the processor(s) to search for a second topic taxonomy instance to identify a match for the participant response. In some embodiments, the knowledge framework can be created or enhanced based on the machine learning data, the session data, and the classified input data. Also, in some embodiments, the input data can include data from one or more external sources, and the input data can include data related to at least one of a domain, a stakeholder, an assessment, an opportunity, a use case, a challenge, a capability maturity level, a session focus, a survey focus, a guidance focus, an insight focus, a data interpretation focus, a foundational models focus, an external web source, a standard, a framework, a best practice, a regulation, a taxonomy, an ontology, a lexicon, a machine learning corpus, or another document.

In some embodiments, the session data can include an ontology or a taxonomy, and the ontology or the taxonomy can guide a client session. In some embodiments, the computer program code can be configured to, when executed, cause the processor(s) to receive at least one response, determine a base score for the response(s), determine one or more scoring adjustments, and determine a weighted score for the response(s) based on the base score and the scoring adjustment(s). Furthermore, the scoring adjustment(s) can include at least one of an importance level scoring adjustment based on an importance level of the response(s), a trustworthiness scoring adjustment based on a trustworthiness of the response(s), or a certainty scoring adjustment based on an uncertainty level of the response(s). In some embodiments, creating or enhancing the knowledge framework can be performed using the weighted score for the response(s).

In another example embodiment, a method for development and use of a knowledge framework is provided. The method comprises receiving session data related to responses received from a participant in a session, receiving machine learning data, creating or enhancing the knowledge framework based on the machine learning data and the session data, and creating additional machine learning data using the knowledge framework as a source of information.

In some embodiments, the method also includes filtering the machine learning data and the session data before use of the machine learning data and the session data in creating or enhancing the knowledge framework. Furthermore, in some embodiments, machine learning data and session data are filtered by identifying data that is trustworthy and data that is untrustworthy, and only the data that is trustworthy is used to create or enhance the knowledge framework.

In some embodiments, the knowledge framework can be iteratively enhanced based on the machine learning data and the session data. In some embodiments, the method also includes verifying further machine learning data using the knowledge framework, and verifying the further machine learning data using the knowledge framework can be performed automatically and periodically. In some embodiments, the knowledge framework can be a large language model. In some embodiments, the knowledge framework can comprise an ontology or a taxonomy, and creating or enhancing the knowledge framework can be performed by evolving the ontology or the taxonomy within the knowledge framework unit based on the machine learning data.

In some embodiments, the method also includes receiving input data from at least one external source and classifying the input data to form classified input data for use in the knowledge framework. Furthermore, in some embodiments, the method includes transforming the classified input data into a different format for use in the knowledge framework. Additionally, in some embodiments, the method can also include transforming the classified input data so that the classified input data semantically aligns with language of a taxonomy or an ontology in the knowledge framework. In some embodiments, the session data can include a participant response, and the method can further comprise assessing whether a topic taxonomy instance is applicable to the participant response and searching for a second topic taxonomy instance to identify a match for the participant response. Also, in some embodiments, the knowledge framework can be created or enhanced based on the machine learning data, the session data, and the classified input data. In some embodiments, the input data can include data from one or more external sources, and the input data can include data related to at least one of a domain, a stakeholder, an assessment, an opportunity, a use case, a challenge, a capability maturity level, a session focus, a survey focus, a guidance focus, an insight focus, a data interpretation focus, a foundational models focus, an external web source, a standard, a framework, a best practice, a regulation, a taxonomy, an ontology, a lexicon, a machine learning corpus, or another document. In some embodiments, the session data can comprise an ontology or a taxonomy, and the ontology or the taxonomy can guide a client session.

In some embodiments, the method comprises receiving at least one response, determining a base score for the response(s), determining one or more scoring adjustments, and determining a weighted score for the response(s) based on the base score and the scoring adjustment(s). Additionally, in some embodiments, the scoring adjustment(s) include at least one of an importance level scoring adjustment based on an importance level of the response(s), a trustworthiness scoring adjustment based on a trustworthiness of the response(s), or a certainty scoring adjustment based on an uncertainty level of the response(s). Furthermore, in some embodiments, creating or enhancing the knowledge framework can be performed using the weighted score for the response(s).

In another example embodiment, a non-transitory computer readable medium is provided for the development and use of a knowledge framework. The non-transitory computer readable medium has stored thereon software instructions that, when executed by one or more processors, cause the processor(s) to receive session data related to responses received from a participant in a session, receive machine learning data, create or enhance the knowledge framework based on the machine learning data and the session data, and create additional machine learning data using the knowledge framework as a source of information. In some embodiments, the knowledge framework can be iteratively enhanced based on the machine learning data and the session data. Furthermore, in some embodiments, the software instructions can, when executed by the processor(s), cause the processor(s) to filter the machine learning data and the session data before use of the machine learning data and the session data in creating or enhancing the knowledge framework. In some embodiments, the machine learning data and the session data can be filtered by identifying data that is trustworthy and data that is untrustworthy, and only the data that is trustworthy is used to create or enhance the knowledge framework.

In some embodiments, the software instructions, when executed by the processor(s), can cause the processor(s) to verify further machine learning data using the knowledge framework. Additionally, in some embodiments, verifying the further machine learning data using the knowledge framework can be performed automatically and periodically.

In some embodiments, the knowledge framework can be a large language model. In some embodiments, the knowledge framework can comprise an ontology or a taxonomy, and creating or enhancing the knowledge framework can be performed by evolving the ontology or the taxonomy within the knowledge framework unit based on the machine learning data.

In some embodiments, the software instructions can, when executed by the processor(s), cause the processor(s) to receive additional data from one or more sources, and the knowledge framework can be created or enhanced based on the machine learning data, the session data, and the additional data.

In some embodiments, the software instructions can, when executed by the processor(s), cause the processor(s) to receive input data from at least one external source and classify the input data to form classified input data for use in the knowledge framework.

In some embodiments, the software instructions can, when executed by the processor(s), cause the processor(s) to transform the classified input data into a different format for use in the knowledge framework. Furthermore, in some embodiments, the software instructions can, when executed by the processor(s), cause the processor(s) to transform the classified input data so that the classified input data semantically aligns with language of a taxonomy or an ontology in the knowledge framework. In some embodiments, the session data can comprise a participant response, and, when executed by the processor(s), the software instructions can cause the processor(s) to assess whether a topic taxonomy instance is applicable to the participant response, and search for a second topic taxonomy instance to identify a match for the participant response. Furthermore, in some embodiments, the knowledge framework can be created or enhanced based on the machine learning data, the session data, and the classified input data. Additionally, in some embodiments, the input data can include data from one or more external sources, and the input data includes data related to at least one of a domain, a stakeholder, an assessment, an opportunity, a use case, a challenge, a capability maturity level, a session focus, a survey focus, a guidance focus, an insight focus, a data interpretation focus, a foundational models focus, an external web source, a standard, a framework, a best practice, a regulation, a taxonomy, an ontology, a lexicon, a machine learning corpus, or another document.

In some embodiments, the session data comprises an ontology or a taxonomy, and the ontology or the taxonomy can be used to guide a client session. In some embodiments, when executed by the processor(s), the software instructions can cause the processor(s) to receive at least one response, determine a base score for the response(s), determine one or more scoring adjustments, and determine a weighted score for the response(s) based on the base score and the scoring adjustment(s). Additionally, in some embodiments, the scoring adjustment(s) can include at least one of an importance level scoring adjustment based on an importance level of the response(s), a trustworthiness scoring adjustment based on a trustworthiness of the response(s), or a certainty scoring adjustment based on an uncertainty level of the response(s). In some embodiments, creating or enhancing the knowledge framework can be performed using the weighted score for the response(s).

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram illustrating an innovation product assessment system, in accordance with some embodiments discussed herein;

FIG. 2 is a schematic diagram illustrating an exemplary scoring module and various modules provided therein, in accordance with some embodiments discussed herein;

FIG. 3 is a schematic diagram illustrating an example assessment theory model for assessing an assessment object, in accordance with some embodiments discussed herein;

FIG. 4 is a schematic diagram illustrating exemplary modules that can be included in processing circuitry in some environment context, in accordance with some embodiments discussed herein;

FIGS. 5A and 5B-1 to 5B-2 are schematic diagrams illustrating example ontology class diagrams with associations between different characteristics, in accordance with some embodiments discussed herein;

FIGS. 6A-6C are schematic views illustrating example screens that can be presented on a display, in accordance with some embodiments discussed herein;

FIG. 7 is a flow chart illustrating an example method for making universal assessments, in accordance with some embodiments discussed herein;

FIG. 8 is a flow chart illustrating an example method for scoring, in accordance with some embodiments discussed herein;

FIG. 9 is a flow chart illustrating an example method of machine learning that can be utilized in making universal assessments, in accordance with some embodiments discussed herein;

FIG. 10 is a schematic view illustrating an exemplary architecture of the processing circuitry 1000, in accordance with some embodiments discussed herein;

FIG. 11 is a flow chart illustrating an example method for defining assessment models, in accordance with some embodiments discussed herein;

FIG. 12 is a flow chart illustrating an example method for assessment execution and selection of what defining models to apply to the assessment, in accordance with some embodiments discussed herein;

FIG. 13 is a flow chart illustrating an example method with operations to create a scoring model for a related assessment model, in accordance with some embodiments discussed herein;

FIG. 14 is a block diagram illustrating an example system providing a common session knowledge architecture, in accordance with some embodiments discussed herein;

FIG. 15A is a block diagram illustrating an example system having a knowledge architecture, in accordance with some embodiments discussed herein;

FIG. 15B is a block diagram illustrating a guidance and assessment knowledge system that is supported by machine learning techniques such as generative artificial intelligence, in accordance with some embodiments discussed herein;

FIG. 16 is a block diagram illustrating a hierarchy of prompt-response patterns and certain aspects that the prompt-response patterns can be focused on, in accordance with some embodiments discussed herein;

FIG. 17 is a block diagram illustrating an example session conceptual model, in accordance with some embodiments discussed herein;

FIG. 18 is a block diagram illustrating an example knowledge base comprising a knowledge framework, in accordance with some embodiments discussed herein;

FIGS. 19-1 to 19-2 are schematic diagrams illustrating an example ontology class diagram with associations between different characteristics, in accordance with some embodiments discussed herein;

FIG. 20 is a flow chart illustrating an example method for discovering statements for a focus topic aspect sentiment, in accordance with some embodiments discussed herein;

FIG. 21A is a flow chart illustrating an example method for discovering concepts and keywords related to a topic and metadata, in accordance with some embodiments discussed herein;

FIG. 21B is a flow chart illustrating an example method for obtaining existing knowledge, in accordance with some embodiments discussed herein;

FIG. 21C is a flow chart illustrating an example method for utilizing existing knowledge, in accordance with some embodiments discussed herein;

FIG. 21D is a flow chart illustrating an example method for discovering and/or integrating concepts, in accordance with some embodiments discussed herein;

FIG. 21E is a flow chart illustrating an example method for creating ontologies, in accordance with some embodiments discussed herein;

FIG. 21F is a flow chart illustrating an example method for validating ontologies, in accordance with some embodiments discussed herein;

FIG. 22 is an example diagram illustrating a taxonomy with various major business entity functional areas, in accordance with some embodiments discussed herein;

FIG. 23 is a flow chart illustrating an example method for developing a knowledge system using machine learning techniques, in accordance with some embodiments discussed herein; and

FIG. 24 is a method for the development and use of a knowledge framework, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention can be embodied in many different forms and should not be construed as limited to the example embodiments set forth herein; rather, these embodiments are provided so that this disclosure will satisfy applicable legal requirements. Additionally, any connections or attachments can be direct or indirect connections or attachments unless specifically noted otherwise.

As used herein, a response is intended to include an answer, rationale provided in support of that answer, and evidence provided in support of the answer and/or the rationale. Furthermore, independent intrinsic characteristics are those characteristics of the assessment object that are inherent to the assessment object and that are not affected by other characteristics. Dependent intrinsic characteristics are those characteristics of the assessment object that are affected by a relationship with other characteristics. Additionally, extrinsic characteristics are characteristics of the environment context that the assessment object is in. As used herein, a business use case is a meaningful use of some system or technology to provide capabilities to a user and to the business.

As used herein, the term “machine learning” is intended to mean the application of one or more software application techniques or models that process and analyze data to draw inferences and/or predictions from patterns in the data. Machine learning techniques can process and analyze data to enable computer systems to autonomously learn and improve their performance over time from the data, to automatically identify patterns, extract insights, and make informed decisions or predictions without explicit programming for each scenario. The machine learning techniques can include a variety of models or algorithms, including supervised learning techniques, unsupervised learning techniques, reinforcement learning techniques, knowledge-based learning techniques, natural-language-based learning techniques such as natural language generation, natural language processing (NLP) and named entity recognition (NER), deep learning techniques, and the like. The machine learning techniques are trained using training data. The training data is used to modify and fine-tune any weights associated with the machine learning models, as well as record ground truth for where correct answers can be found within the data. As such, the better the training data, the more accurate and effective the machine learning model. Machine learning models utilize statistical methods and optimization processes and techniques to adaptively refine their internal parameters, allowing them to generalize from past observations and efficiently solve complex tasks, including classification, regression, clustering, and more. The models can include supervised learning models (e.g., linear regression models, logistic regression models, decision tree models, random forest models, support vector models, neural network models), unsupervised learning models (e.g., K-Means clustering models, hierarchical clustering models, principal component analysis (PCA) models, gaussian mixture models (GMM)), semi-supervised learning models (e.g., a combination of supervised and unsupervised learning approaches where the model is trained on a partially labeled dataset), reinforcement learning models (e.g., agents and Q-learning and deep Q networks (DQNs)), deep learning models (e.g., neural networks), transfer learning models, ensemble learning models, on-line learning models, and instance-based learning models. The supervised learning models can be trained on labeled datasets to learn to map input data to desired output data or labels. This type of learning model can involve tasks like classification and regression. The unsupervised learning model involves models that analyze and identify patterns in unlabeled data. Clustering and dimensionality reduction are common tasks in unsupervised learning. The semi-supervised learning models combine elements of both supervised and unsupervised learning models, utilizing limited labeled data alongside larger amounts of unlabeled data to improve model performance. The reinforcement learning model involves training models to make sequential decisions by interacting with a selected environment. The models learn through trial and error, receiving feedback in the form of rewards or penalties. The deep learning models utilizes neural networks with multiple layers to automatically learn hierarchical features from data. The neural networks can include interconnected nodes, or “neurons,” organized into layers. Each connection between neurons is assigned a weight that determines the strength of the signal being transmitted. By adjusting the weights based on input data and desired outcomes, neural networks can learn complex patterns and relationships within the data. The neural networks can include feedforward neural networks (FNNs), convolutional neural networks (CNNs), recurrent neural networks (RNNs), long short-term memory (LSTM) networks, gated recurrent units (GRUs), autoencoders, generative adversarial networks (GANs), transformers, and the like.

The transformer type model or architecture can be configured to process sequences of data, making the model particularly suitable for tasks involving natural language processing (NLP) or benefit from the processing using NLP. The transformer model can include a number of primary elements or components, including input embeddings, encoder and decoder stacks, self-attention and multi-head attention mechanisms, positional encoders, feedforward neural networks, normalization and residual connections, one or more output linear layers, and the like. During processing, input sequence can be divided into individual tokens, which can be words, subwords, or characters, based on the input data, which can include textual data. The input embeddings are an input sequence that is transformed into a series of embeddings, where each token is represented as and is mapped to a high-dimensional embedding vector, which captures positional information and the semantic meaning of the token. The embeddings can be a combination of learned token embeddings and positional encodings.

The encoder and decoder stacks can include multiple identical layers. The encoder stack when employed processes the input sequence, while the decoder stack when employed generates the output sequence in selected types of tasks, such as for example translation and other types of activities. The encoder stack can include a self-attention mechanism allows the model to weigh the importance of different tokens in the input sequence relative to a selected token, such as a query token. Each token can generate a plurality of vectors, including for example a query vector, a key vector, and a value vector. The attention score between a query and a vector key determines how much focus the model gives to the corresponding value when generating an output. The self-attention mechanism enables each word/token to consider all other words/tokens in the sequence while computing any associated representations. The self-attention mechanism captures dependencies and relationships between different words or portions of data regardless of the position of the data in the data sequence. Specifically, the self-attention mechanism allows the transformer model to weigh the importance of different elements or positions in the input sequence when making predictions and helps capture dependencies and relationships between words in the sequence. The encoder stack can also include a position-wise feed-forward network that consists of a fully connected layers and a non-linear activation function that can be independently applied to each position. The primary purpose of the position-wise feed-forward network is to introduce non-linearity and enable the model to capture complex interactions between different positions within the input sequence. The self-attention mechanism and the position-wise feed-forward network allow the model to capture both local and global dependencies within the input sequence.

The decoder stack can include, in addition to the above, can also include the attention mechanism for enabling the model to consider the context and relationships between different parts of the sequence (context-dependent information), making the model highly effective for capturing long-range dependencies in language. The decoder stack can also include a masked self-attention mechanism that ensures that each position can only attend to its preceding positions. During training, the decoder can attend to positions before the current position to prevent information leakage from the future.

The model can also include the multi-head attention mechanism that can be configured to employ multiple sets of self-attention mechanisms in parallel, each mechanism focusing on a different aspect of the input sequence. The multiple attention heads capture different types of information, enabling the model to learn diverse patterns.

The model can also include an output layer that generates the final predictions or outputs based on the representations generated by the decoder stack. In selected types of tasks (e.g., machine translation), the output layer can produce a probability distribution over a target vocabulary for each position in the output sequence. Specifically, the final output of the decoder stack can be passed through the output linear layer to produce a probability distribution of the words/vocabulary for generating the next token. The transformer components cooperate or work together to capture long-range dependencies, effectively process sequential data, and easily perform natural language processing tasks. The positional encodings can be added to the embeddings to provide information about the position of each element in the sequence. This helps the model understand the order of the sequence. The encodings provide information about the relative positions of tokens in the sequence.

The transformer type machine learning model can involve training a model on one task and transferring the learned knowledge to a related task, often enhancing efficiency and performance. The model can be configured as an ensemble learning model that combines multiple models to make more accurate predictions. Common techniques include bagging and boosting.

An example of a transformer type machine learning model suitable for the system of the present invention can include, for example, large language models (LLMs). The large language models can be configured to understand and generate human language by learning patterns and relationships from vast amounts of input textual data. The model configuration can include setting selected hyperparameters, including the number of layers, hidden units per layer, attention mechanisms, and other architectural details. The LLMs can utilize deep learning techniques, particularly the foregoing transformer architectures, to process and generate text. The models can be pre-trained and trained on massive data corpora (e.g., text corpora, image corpora, and the like) and can perform tasks such as text generation, language translation, text summarization, image generation, sentiment analysis, and the like. The LLMs can include, by simple way of example, generative artificial intelligence (AI) or machine learning models. The generative artificial intelligence (AI) model refers to a computational system designed to create new and original data based on patterns and information learned from existing datasets. The generative AI model can employ selected machine learning techniques to generate content, such as text, images, audio, or other forms of media or data, that closely resembles the input data but is not an exact replication. The generative AI models can leverage neural networks and probabilistic methods to produce outputs that exhibit creativity and diversity while maintaining coherence with the input data distribution.

The large language models can be trained or pre-trained. The training and pre-training can involve a combination of data collection, data pre-processing, model architecture design, and optimization. For example, and by simple way of illustration, the model can process selected input data. The input data can include a diverse and extensive dataset of any type, such as image and text data. In the case of text data, the text data can be collected from a wide range of sources, such as books, websites, articles, and the like. The dataset can include text in multiple different languages and domains to ensure the model's versatility. The collected text data can be pre-processed to remove any noise, irrelevant information, or sensitive data. The text data can then be tokenized into smaller units, such as words or subwords, which the model can understand and process. The model can build a vocabulary by selecting a set of tokens from the tokenized input data, which can be used to represent words and subwords as numerical values. The model architecture can determine how the input data is processed. For example, the transformer type model can employ an encoder stack and a decoder stack. In the case of certain models, only the decoder stack need be employed in order to implement autoregressive language generation.

The model can be pre-trained on the input text data. During the pretraining step, the model learns to predict the next word in a sequence of text data given the preceding words in the sequence. As such, the model can be trained to learn and to capture or identify language patterns, grammar, and semantics, from the input data. The model can be configured and trained to predicts the next word by attending to the context words using the self-attention mechanism, which enables the model to consider different parts of the input text. The objective function used during pre-training is to determine the likelihood of the next word in the sequence given the context of the word. The model is trained so as to minimize, as best possible, the difference between the predicted word in the sequence and the actual next words in the training data. The model parameters cam be updated using optimization algorithms, such as stochastic gradient descent (SGD) or its variants. The process involves backpropagation to adjust the weights of the neural network layers.

After pre-training, the model can be further fine-tuned on specific tasks or domains. The tuning methodology involves training the model on a narrower dataset and adjusting any associated parameters so as to perform at a selected level on a desired task, such as translation, summarization, or question answering. The fine-tuning adapts the model to produce more contextually relevant and task-specific responses. The training process can also involve multiple iterations of pre-training and fine-tuning. With each iteration, the model's architecture, training techniques, and datasets can be refined and tuned to improve performance. Further, throughout the training process, the model is evaluated on validation datasets to monitor the performance of the model and to prevent overfitting. The evaluation metrics can include language generation quality, coherence, relevance, and task-specific metrics, depending on the intended use of the model.

The machine-learning processes as described herein can also be used to generate machine-learning models. A machine-learning model or model, as used herein, is a mathematical representation of a relationship between inputs and outputs, as generated using any machine-learning process including without limitation any process as described above and stored in memory. An input can be submitted to a machine-learning model once created, which generates an output based on the relationship that was derived. For example, a linear regression model, generated using a linear regression algorithm, may compute a linear combination of input data using coefficients derived during machine-learning processes to calculate an output datum. As a further non-limiting example, a machine-learning model may be generated by creating an artificial neural network, such as a convolutional neural network comprising an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

In the present disclosure, data used to train a machine learning model, such as a neural network, can include data containing correlations that a machine-learning process or technique may use to model relationships between two or more types or categories of data elements (“training data”). For instance, and without limitation, the training data may include a plurality of data entries or datasets (e.g., data entries that are related and organized in a structured manner), where each data entry represents a set of data elements that are recorded, received, and/or generated together. The data elements can be correlated by shared existence in a given data entry, such as by proximity in a given data entry, or the like. Multiple data entries in the training data may evince one or more trends in correlations between categories or types of data elements. For instance, and without limitation, a higher value of a first data element belonging to a first category or types of data element may tend to correlate to a higher value of a second data element belonging to a second category or type of data element, indicating a possible proportional or other mathematical relationship linking values belonging to the two categories. Multiple categories of data elements may be related in training data according to various correlations, and the correlations may indicate causative and/or predictive links between categories of data elements, which may be modeled as relationships such as mathematical relationships by the machine-learning processes as described herein. The training data may be formatted and/or organized by categories of data elements, for example by associating data elements with one or more descriptors corresponding to categories of data elements. As a non-limiting example, training data may include data entered in standardized forms by persons or processes, such that entry of a given data element in a given field in a given form may be mapped or correlated to one or more descriptors of categories. Elements in training data may be linked to descriptors of categories or types by tags, tokens, or other data elements. For example, and without limitation, training data may be provided in fixed-length formats, formats linking positions of data to categories such as comma-separated value (CSV) formats and/or self-describing formats such as extensible markup language (XML), enabling processes or devices to detect categories of data.

Alternatively, or additionally, the training data may include one or more data elements that are not categorized, that is, the training data may not be formatted or include descriptors for some elements of data. Machine-learning models or algorithms and/or other processes may sort the training data according to one or more categorizations using, for instance, natural language processing algorithms, tokenization, detection of correlated values in raw data and the like. The categories may be generated using correlation and/or other processing algorithms. The training data can correlate to any input data as described in this disclosure to any output data as described in this disclosure.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

As used herein, the term “trustworthiness” is intended to mean the ability to be relied upon as being honest or truthful. As used herein, the term “certainty” is intended to mean a quality of being reliably true. As used herein, the term “uncertainty” is intended to mean a quality of not being reliably true.

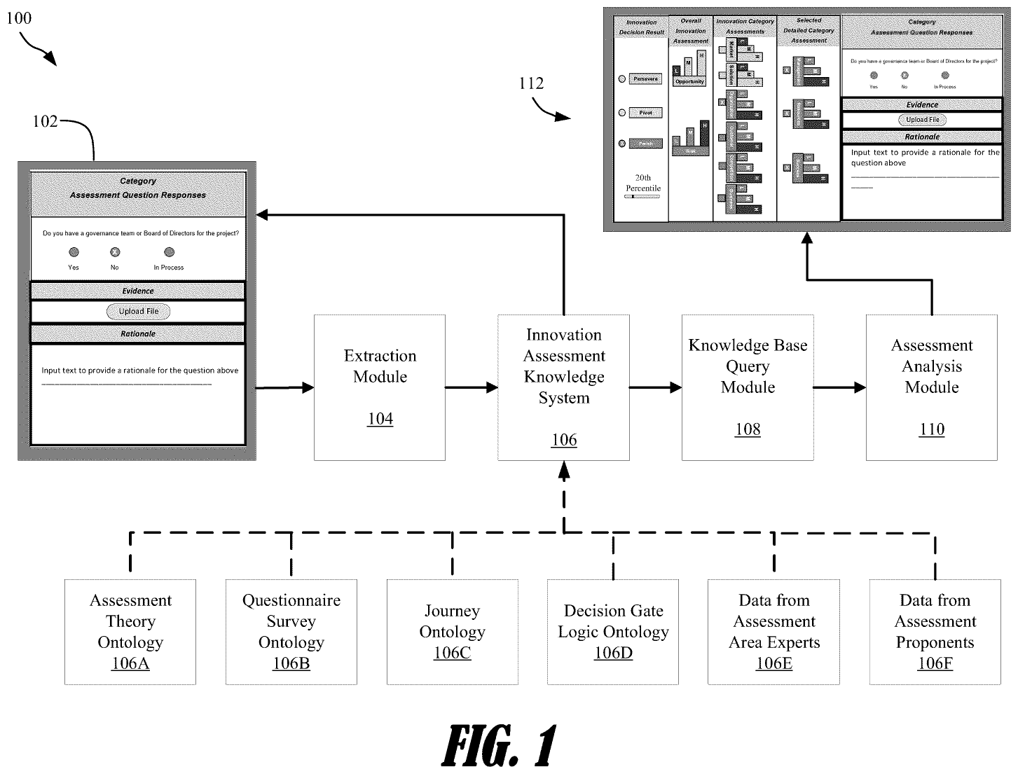

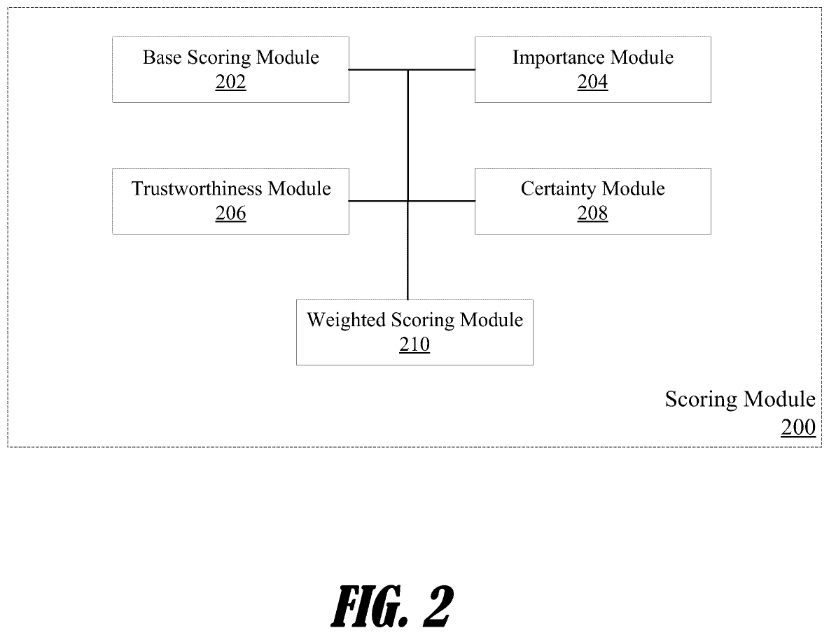

FIG. 1 is a schematic diagram illustrating an innovation product assessment system 100. A questionnaire 102 can be provided to users to elicit responses to various questions. In the response, the user can provide an answer to a specific question, a rationale in support of the answer, and evidence to support the answer and/or the rationale. A dedicated module (e.g., a questionnaire module having a questionnaire ontology 106B provided thereon) can be used to provide the questionnaire 102 in some embodiments.

An extraction module 104 can receive the responses that were input by the user, and the extraction module 104 can extract the relevant answers, rationales, and evidence. The extraction module 104 can also transform the answers, rationales, and evidence into an appropriate data format so that this information can be easily asserted as facts in the innovation assessment knowledge system 106, which can semantically represent these asserted facts in the form of the data from assessment area experts 106E or data from assessment proponents 106F from the questionnaire 102 by the questionnaire survey ontology 106B. Information can be interpreted using an assessment theory ontology 106A, the journey ontology 106C, a category ontology, and the decision gate logic ontology 106D. The extraction module can load the answers, rationales, and evidence into innovation assessment knowledge system 106.

The innovation assessment knowledge system 106 can receive various inputs. These inputs can include data from assessment area experts 106E and data from assessment proponents 106F in some embodiments. This data can also be represented as answers to questions defined by the questionnaire survey ontology 106B. Additionally, the innovation assessment knowledge system 106 includes multiple interrelated ontologies to semantically represent the assessment models including the questions and their default answers 106B. The ontologies assist in the semantic interpretation of features as intrinsic and extrinsic characteristics in the assessment theory ontology 106A, and the questions and their assessment journey phase can be categorized in the journey ontology 106C. For example, the innovation assessment knowledge system 106 can include an assessment theory ontology 106A, a questionnaire survey ontology 106B, a journey ontology 106C, and a decision gate logic ontology 106D, and an assessment analysis ontology on the assessment analysis module 110. However, in other embodiments, other ontologies and other inputs can be provided at the innovation assessment knowledge system 106.

The innovation assessment knowledge system 106 can be configured to make assessments based on the responses provided by users. The innovation assessment knowledge system 106 beneficially makes incremental assessments that improve the accuracy of the decisions at different phases. Additionally, as further knowledge is obtained about an assessment object, the innovation assessment knowledge system 106 beneficially refines questions presented to users. Thus, the questions can be more refined to target particular aspects of the assessment categories that illuminate the extrinsic and intrinsic characteristics of the assessment object, allowing for better decisions to be made.

Data from the innovation assessment knowledge system 106 can be accessible to a knowledge base query module 108. The knowledge base query module 108 can be configured to perform SPARQL queries in some embodiments, which are pre-defined to provide fine granular analysis at the question/response level, to enable the analysis defined by the assessment analysis ontology of the assessment analysis module 110. The knowledge base query module 108 can be configured to load material from the innovation assessment knowledge system 106 into an appropriate data format so that this material can be easily utilized alongside other data at the assessment analysis module 110. In some embodiments, the queries can additionally or alternatively be stored in the innovation assessment knowledge system 106 for subsequent use in accessing the stored facts for one or more assessments of an innovation object.

The assessment analysis module 110 can analyze data available to provide an assessment output 112. The assessment output 112 is exemplary in nature, and other formats and interactions can be utilized to present the results of the assessment. These results can be final results of an assessment, or alternatively, the assessment output 112 can be intermediary results of an assessment that are presented, and the assessment output 112 can be refined further as additional responses to the questionnaire 102 are received from the user. One beneficial assessment knowledge enabler is the combined hierarchical semantic representation assessment by question-answer, category, journey phase, with the quantitative analysis scoring contained and summarized level of abstraction, including adjustments made to remove bias and to accurately represent the trustworthiness and certainty of the responses.

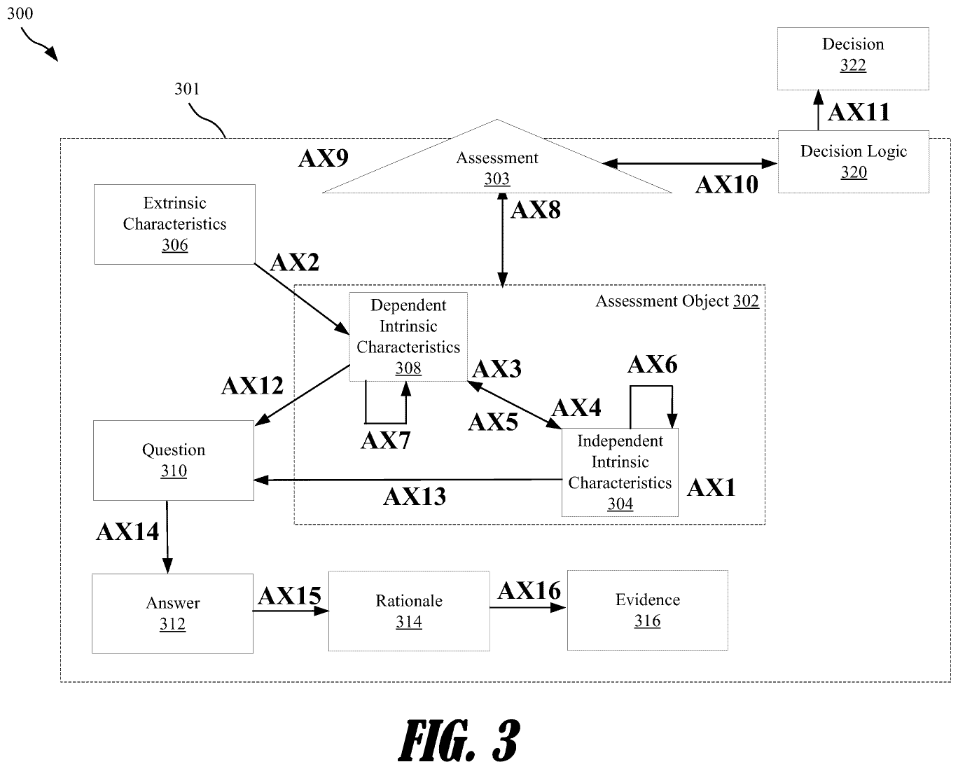

FIG. 2 is a schematic diagram illustrating an exemplary scoring module 200 and various modules provided therein. This scoring module 200 can be provided as part of the innovation product assessment system 100 of FIG. 1 (e.g., as the assessment analysis module 110 or a component thereof). The scoring module 200 can receive data from the knowledge base query module 108 of FIG. 1 about responses from one or more respondents and the question and data stored in the innovation assessment knowledge system 106 for the purpose of analyzing that data to develop a score per response. The scoring module 200 can have one or more modules therein that assist in adjusting scores. For example, the scoring module 200 can include an importance module 204, a trustworthiness module 206, and a certainty module 208 that modify the question/response scores for its default answers as initially defined in the base scoring module 202. In some embodiments, the effect of the adjustment score for each question default answer is predefined if specific assessment response conditions are satisfied. In other embodiments, some of the adjustment factors can be more dynamic and can depend on the response conditions and other responses. For example, the importance factor defined in the importance module 204 is predefined and its weighted impact affects all assessment responses as a static factor applied to each question. The trustworthiness factor can be more dynamic in that its adjustment depends on the type of respondent, so the score can optionally be adjusted or can optionally not be adjusted based on the type of respondent. Even here, the adjustment scores can be predefined for all types of respondents and stored in the innovation assessment knowledge system 106. The scoring module 200 can evaluate answers that are provided by the respondent to specific questions, and the scoring module 200 can also assess any supporting rationales that are provided to support the answers of a respondent. For example, in evaluating supporting rationales, the scoring module 200 can simply identify whether any supporting rationale is provided in determining an appropriate adjustment to the score. However, in other embodiments, a more detailed analysis of the supporting rationale can be conducted.

In some embodiments, various data points can be adjusted in weighting to make some data points have more relevance and to make other data points have less relevance. For example, answers to questions, external data, and data from other respondents (which can be aggregated and/or anonymized) can assist in performing this weighting. In some embodiments, the effect of the adjusted scoring weights can incrementally impact the assessment scores as various questions are responded to and as more data is obtained.

The scoring module 200 can evaluate trustworthiness of response and/or bias of a response with a trustworthiness module 206, and this can, for example, be accomplished by assessing the trustworthiness of the responder providing the information. The trustworthiness module 206 can evaluate inconsistencies between responses and reduce weight of responses to the extent there are inconsistencies. There can be defined different categories of responders with different adjustment factors for different categories of questions. For example, an innovation proponent can be biased as to the potential commercial success potential of the innovation, which would indicate that answers to questions related to innovation commercial success potential should be adjusted accordingly to have less impact on the overall score. The trustworthiness module 206 can identify irreconcilable contradictions in the answers, evidence, and/or rationales and can also identify instances where the answers, evidence, and/or rationales are consistent, and the trustworthiness module 206 can provide adjustments to the scoring accordingly.

In some embodiments, the inquiry module 406 (see FIG. 4) can be configured to craft and present redundant questions to the respondent. Slight differences in wording can be present in the redundant questions. The trustworthiness module 206 can assess the consistency or inconsistency in the answers, evidence, and rationales provided in response to redundant questions and adjust the scoring accordingly. However, in other embodiments, the inquiry module 406 can be configured to minimize or eliminate redundant questions.

Objectivity is an important design characteristic for assessment models. Objectivity can be improved by requiring that an explanatory rationale be provided in support of some or all of the answers and by requiring that objective evidence be provided in support of some or all of the answers and/or rationales. This immediately provides a basis for rating the trustworthiness of the response to a question and its use in assessment logical decisions. The scoring module 200 or the trustworthiness module 206 therein can assess the rationale and any objective evidence provided and can make appropriate adjustments to the score based on the rationale and objective evidence. Different types of evidence often have different levels of truthfulness or risks of use. Assessments of the truthfulness, risks of use, and/or benefits of use can be made using algorithms, or these assessments can be made using machine learning and/or artificial intelligence. In some embodiments, the scoring module 200 can simply look to see if any rationale and/or objective evidence is provided in support and make scoring adjustments based on the presence or absence of this information, but the scoring module 200 can be used to more thoroughly evaluate the provided information to determine an appropriate score.

The scoring module 200 can be configured to provide various scoring adjustments based on the answers, evidence, and rationales provided by the respondent. For each response, a base scoring module 202 is configured to provide a base score. The base score can be a score ranging from −5 to +5, a score ranging from −5 to 0, or a score ranging from 0 to +5, with the relevant scoring range being provided based on questions asked. For example, where a question is directed towards risks for a given assessment object, then the score range of −5 to 0 can be appropriate, and where a question is directed towards the opportunities provided by an assessment object, then the score range of 0 to +5 can be appropriate. However, a wide variety of other scoring ranges can be utilized. Each question's possible default answer within the set of default answers can be assigned a score within the question's answer range (e.g., −5 to 0, 0 to +5, −5 to +5). For a specific assessment by a responder, each question's answer is assigned the relevant score value from this predefined score value for this answer.

Additionally, various factors can be used to assist in making scoring determinations in the scoring module 200. These factors can be assessed at dedicated modules within the scoring module 200, with each of the dedicated modules assessing the factors and providing an appropriate score adjustment based on the impact of the factor. In the illustrated embodiment of FIG. 2, an importance module 204, a trustworthiness module 206, and a certainty module 208 are provided. However, other modules can be provided within the scoring module 200 in other embodiments where additional factors are considered in scoring determinations.

Each adjustment factor can be applied to the base scores for each default answer to each question in such a manner that the relative impact of a question's score is modified with respect to the impact of all other questions, thus leaving the minimum and maximum values for the total possible base score for all questions the same. What is adjusted is the relative impact of the response to the overall assessment score. In this way, the factor's impact on the score is adjusted instead of the score ranges. Multiple factors can be defined as illustrated in the exemplary set of adjustment factors as shown in FIG. 2.

An importance factor can be assessed at the importance module 204. This importance factor can be dependent upon the importance of certain questions, and this weight can, for example, be an integer weighed from 1 to 10. Increasing the weight of one response can effectively reduce the weight of another response. Importance can be determined based on input from subject matter experts, based on information obtained from other users, or using other approaches. Additionally, the importance can be higher or lower for a given question based on the strength of a relationship between a characteristic of an assessment object with some other characteristic (e.g., an extrinsic characteristic of the environmental context or another intrinsic characteristic of the assessment object).

In some embodiments, a trustworthiness factor can be assessed at a trustworthiness module 206. The focus of the trustworthiness factor is the level of trust associated with a particular type of respondent, where various biases can be associated with a respondent that cause high or low assessment scores for an assessment object. For example, an inventor of a particular innovation can respond with a more positive bias for commercial success of that innovation than a responder without a stake in the innovation. To some extent, this can be remediated by the rationale and evidence to support a specific answer, and the trustworthiness factor will not affect the score where this is the case in some embodiments. Where there is no rationale or evidence, the trustworthiness factor can affect the response score. The trustworthiness module 206 can assess appropriate scoring adjustments where the answers, evidence, and/or rationales provided in response to the question are inconsistent with answers, evidence, and/or rationales provided in response to another question. The trustworthiness module 206 can also provide appropriate scoring adjustments associated with a particular question downwardly where answers, evidence, and/or rationales indicate some bias in how the respondent is answering the questions. Biases can be detected by analysis of a single answer, a single piece of evidence, and/or just one rationale. Alternatively, biases can be detected by analysis of patterns in multiple answers, pieces of evidence, and/or rationales. Trustworthiness, consistency, and biases can be identified through the use of machine learning, artificial intelligence, or man-made algorithms or by predefined responder types, which have the potential for bias. Where responses are consistent and/or there is no bias detected, the trustworthiness module 206 can adjust the score associated with a particular question upwardly in some embodiments.

In some embodiments, the determination can be weaker where there is inherent uncertainty regarding some aspects of the assessment. The certainty module 208 can be included in the scoring module 200 to account for uncertainty in responses. Where limited information is available regarding a certain question, a certainty factor provided by the certainty module 208 can be reduced to effectively adjust the score downwardly for the given question. In some embodiments, where the information available for a certain characteristic of an assessment object is relatively high, the certainty module 208 can increase the certainty factor so that the score is improved due to the increased certainty. In some embodiments, the limited information can be based on the lack of supporting evidence and/or supporting rationales. Certainty initially can be categorized by two classes of questions, factual questions and judgement or estimation questions. Factual questions can have a high certainty as responses should be based on facts with evidence, while judgement or estimation questions can have an inherent uncertainty due to the possible subjective nature relying on the judgement of a respondent or an uncertainty due to the need to predict based on estimation. Even here, the certainty module can initially apply an adjustment based on the class ((i) factual or (ii) judgement/estimation questions) and store the adjustments in the innovation assessment knowledge system 106. In some embodiments, the certainty module 208 can account for rationale and evidence and modify the negative or positive effect of the certainty factor. The certainty or uncertainty can be directly related to the nature of the information necessary to enable a response. Questions designed to elicit a response that is based on knowledge of objective facts can have a more certain scoring value than a question designed to elicit a response relying on estimates or judgement.

The scoring module 200 also includes a weighted scoring module 210. A weighted score can be determined at the weighted scoring module 210 using the base score provided by the base scoring module 202 and one or more of the factors from the other modules. In some embodiments, the base score and the various factors being used (e.g. the importance factor, the trustworthiness factor, the certainty factor) can be multiplied or added together at the weighted scoring module 210 to get a weighted score for the question. In some embodiments, a cross-product can be used to get the cumulative impact of the various responses. However, the weighted scores can be obtained in other ways. Through the scoring approach taken by the scoring module 200, an objective score can be obtained to provide increased accuracy in assessments. Examples of various modules within the scoring module 200 and potential scoring adjustments are provided here, but various other modules and scoring adjustments can be utilized. Some adjustments can remove bias and transform a subjective assessment into an objective assessment that is not easily gamed by assessment responders.

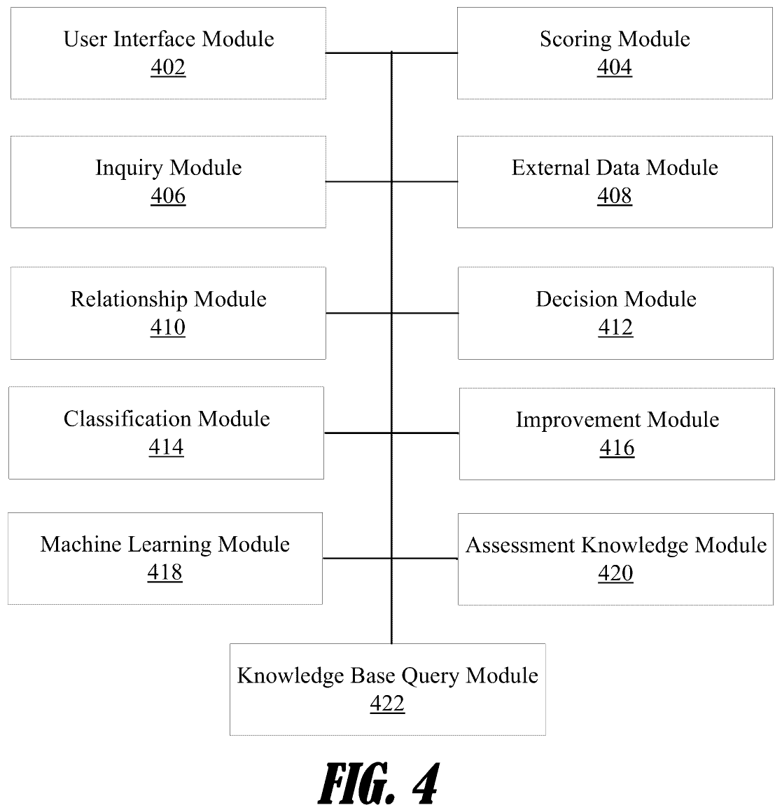

FIG. 3 is a schematic diagram illustrating an example assessment theory model 300 for assessing an assessment object 302. The assessment theory model 300 can be utilized by the innovation assessment knowledge system 106 of FIG. 1. For example, the assessment theory model 300 can serve as the assessment theory ontology 106A of FIG. 1 or as a portion of the assessment theory ontology 106A. The assessment theory model 300 is based on the concept that any assessment is focused on understanding or evaluating an assessment object 302 within some environmental context. The assessment theory model 300 can provide a logical model framework with specified logical necessary conditions to ensure that any assessment made using the assessment theory model 300 is semantically and logically valid. The assessment theory model 300 can accomplish this by including defined semantics for core model concepts, logical axioms, and required conditions for a specific assessment model definition to satisfy. One beneficial aspect of the assessment theory model 300 is that the model can be capable of identifying relationships between different properties, such as the relationship between dependent intrinsic characteristics 308 of an assessment object 302 and the extrinsic characteristics 306.

The assessment theory model 300 can be “universal” in that it is capable of being adapted to a wide variety of assessment objects 302 and to a wide variety of different environmental contexts and extrinsic characteristics 306, and with a variety of different defined assessments 303. For example, in assessing a potential business that can be acquired, the assessment theory model 300 can be used to determine whether or not the business is a good investment opportunity. In such a scenario, the assessment object 302 can be the particular business as well as some innovation object, and independent intrinsic characteristics 304 can include features related to the uniqueness of the business such as proprietary advantages in the form of intellectual property, proprietary processes, and object differentiation, and other independent intrinsic characteristics 304, while the innovation object can include such independent intrinsic characteristics as product cost, which would affect the financial expenses for the business with respect to a product offering. Other extrinsic characteristics 306 can include the market environment and revenue and profit margins in the relevant field. Extrinsic characteristics 306 can also include the supply chain environment and the available suppliers, logistics, available partnerships, stability, and competitive risk in the relevant field.

The assessment theory model 300 can also be used to evaluate potential product ideas that have been conceptualized, to assess the readiness of a business idea to evaluate whether that business idea is ready to be implemented, or in other ways. As another example, the assessment theory model 300 can be used to determine whether one should consider building a product internally or buying the product from another external supplier or manufacturer.

In the context of the decision to build or buy, various factors can be appropriate. For example, various factors that can be relevant in the decision to buy can include the quantities that are involved, whether drawings need modification, whether the product falls within the company's core competencies, whether demand will be temporary or permanent, whether demand will likely fluctuate, whether special manufacturing techniques or equipment are required, whether there are issues of maintaining secrecy, the likely markets for the product, the degree of design changes that will be necessary, the difficulty of quality control, the ability to obtain and retain production personnel, transportation expenses, whether relevant intellectual property would serve as a potential barrier to entry, the relevant amount of royalties that would be required, pricing and quantities required for purchases, presence of specialized techniques for production, whether raw material is readily available or difficult to obtain, and taxes and other costs. While various factors are listed here, various other factors can be relevant to the build/buy decision.

In the assessment theory model 300, various classes are defined in a semantic model with definitions for each class and a defined set of relationships that are asserted between the classes. The assessment theory model 300 can be defined to assess a specific kind of assessment object 302 that is in an assessment operating environment 301.

Assessment characteristics are provided for the assessment object 302 in the assessment theory model 300. These assessment characteristics, take the form of categories with their associated unique questions that are either intrinsic to the assessment object or are extrinsic in some assessment operating environment 301 with some extrinsic characteristics 306, that have the objective of describing the relationship between the assessment object and the assessment characteristic. Each question is aligned within a category which is synonymous with the assessment characteristic semantics or meaning. An assessment object 302 can take a variety of forms. For example, the assessment object 302 can be a tax audit service or something simpler like an electric motor. The primary focus of the assessment theory model 300 is to evaluate some assessment object 302 of some type that is being assessed with the assessment characteristics defined in the assessment theory model 300, with the assessment characteristics being either independent intrinsic characteristics 304 or dependent intrinsic characteristics 308. The kind of assessment object 302 can be a product offered in the buy/sell market, a service offering to the market, a new manufacturing process, an innovative employment candidate selection process, a problem presented by a customer, etc. There is no constraint of the kind of assessment object 302 to be assessed, only that the assessment 303 should reflect those assessment contexts, independent intrinsic characteristics 304, extrinsic characteristics 306, and dependent intrinsic characteristics 308 relevant to the kind of object and the context.

In the assessment theory model 300 of FIG. 3, an assessment object 302 within a given assessment operating environment 301 is assessed. The assessment theory model 300 is beneficial in that it evaluates the relationships between various properties to identify causal dependencies that would not otherwise be identified by other approaches. Where simple approaches are taken, these causal dependencies will not be evaluated in some embodiments, leading to reduced accuracy in assessments. The assessment theory model 300 is beneficial as it can be used to form an assessment theory ontology (e.g., the assessment theory ontology 106A of FIG. 1), and the assessment theory model 300 can be implemented using W3C OWL2 ontology languages or some other ontology language.

The assessment operating environment 301 can have an environment context that represents the kind of assessment operating environment 301 that the assessment object 302 should be evaluated from. The environment context forms a prism in which extrinsic characteristics 306 of the context are selected that are affected by or that affect an assessment object 302. The environment context therefore has a defined set of extrinsic characteristics 306 that are selected to be relevant to an assessment of the assessment object 302. Extrinsic characteristics 306 are those characteristics of the environment context that are affected by or affect the assessment object 302. The selection of the extrinsic characteristics 306 should be specific to an environment context in which the assessment object 302 is being assessed. For any assessment of an assessment object 302, there might be multiple environment contexts that are relevant to the overall assessment of the assessment object 302. An example of an environment context could be a buy/sell product or service competitive market context, an organization context who owns the object, or a regulatory context, etc.

There are two different types of assessment characteristics for an assessment object 302, independent intrinsic characteristics 304 and dependent intrinsic characteristics 308. Independent intrinsic characteristics 304 are those characteristics of the assessment object 302 that are inherent to the assessment object 302 and that are not affected by other characteristics. Dependent intrinsic characteristics 308 are those characteristics of the assessment object 302 that are affected by a relationship with other characteristics. Dependent intrinsic characteristics 308 can be affected by extrinsic characteristics 306 of the environmental context that the assessment object 302 is in, or the dependent intrinsic characteristics 308 can be affected by other intrinsic characteristics. For example, as changes are made in certain extrinsic characteristics 306, there can be corresponding changes made in the dependent intrinsic characteristics 308 of the assessment object 302. The assessment theory model 300 recognizes and defines the ability to represent causal effects and dependency effects between dependent intrinsic characteristics 308, independent intrinsic characteristics 304, and extrinsic characteristics 306. The assessment theory model 300 also recognizes and defines the ability to represent causal effects and dependency effects between two or more different dependent intrinsic characteristics 308.

Furthermore, characteristics can be permanent or temporary, and the appropriate classification can depend on the specific assessment object, the environmental context, and other factors. For example, the mass of an object can be considered a permanent characteristic for some objects, but a temporary characteristic for other objects—the mass of an electric motor does not change with operation, while the mass of a living organism might change through the life of the organism due to a variety of causes. The mass is a permanent intrinsic characteristic for the electric motor, and the mass is a temporary characteristic that might change over time for the organism.

What can be considered to be an independent intrinsic characteristic 304 in some instances can be appropriately considered to be a dependent intrinsic characteristic 308 in other instances. The determination of the appropriate classification for a given characteristic can be made based on the assessment object 302 being assessed, the environmental context, and other factors.

Dependent intrinsic characteristics 308 are those characteristics of the assessment object 302 that are subject to change based on changes in other characteristics. Examples of dependent intrinsic characteristics 308 for a market context include estimated revenue and market share. The estimated revenue and market share are both items that are subject to changes based on other characteristics such as the amount of competition in a given field, the current economic situation, etc. Example of dependent intrinsic characteristics 308 for a manufacturing context could include manufacturing capacity and manufacturing yield-manufacturing capacity and manufacturing yield can be impacted by extrinsic characteristics 306 such as the availability or lack of availability for certain materials, the number of available workers, or other extrinsic characteristics 306. Additionally, examples of dependent intrinsic characteristics 308 for an organization might include available resources, geographic scope, management governance, and type of entity. As another simple example, the weight of an object can serve as a dependent intrinsic characteristic 308—the weight of the object can be dependent on the environmental context that the object is in because the gravitational force acting on the object can be different depending on whether or not the object is on Earth, in orbit, or on some other planet. For example, an object located on the moon has a lower weight compared to its weight on earth.

The possible values for a characteristic are dependent on the nature of the environment context, the assessment object 302, and/or the understood range of values that are used to value the characteristic state itself. For example, where an assessment object 302 is an electric motor, one dependent intrinsic characteristic 308 might be the maximum horsepower of the electric motor. The electric motor will have well-understood horsepower values for different models and for different kinds of electric motors in the market on any date. As another example, where someone is estimating financial benefits of offering a product for sale in the competitive market, another potential dependent intrinsic characteristic 308 would be the expected revenue for the next five years—the expected revenue is a more complex characteristic that can depend on various factors such as the kind of good or service being offered, the current size of the market in sales volume, the expected take rate by population of customers, estimates of market share each year, and the price value comparison of existing products.

Specific questions 310 can be provided that are designed to solicit information from respondents for the purpose of determining a value of a characteristic. For example, in the case of the maximum horsepower of an electric motor object, we might ask the direct question: “What is the maximum horsepower output of the electric motor in a normal operating environment of −20 deg C. to 80 deg C?” The respondent can be prompted to provide a specific answer, and this answer can be provided as a specific quantitative value. Depending on the value of the answer, the advantage or risk of the answer with competitive products in the market can be assessed. A follow up question would be “does this product have a performance advantage in the market?” More complex questions such as “what is the estimated revenue for offering this product in the market, over a period of five years?” is much more complex, and a simple quantitative answer will be sufficient in some instances. Since there is much uncertainty for this answer due to the extrinsic operating context of a competitive market, additional analytical evidence can be requested. Questions can be defined for each independent intrinsic characteristic 304 and for each dependent intrinsic characteristic 308 to acquire sufficient information through their answers that enable additional insights about the status/impact of the assessment object 302 through the lens of this independent intrinsic characteristic 304 or dependent intrinsic characteristic 308.

Respondents can be prompted to provide answers 312 to questions 310. In some embodiments, various default answers can be presented to the respondent that the respondent can select from, and available default answers can be influenced by a variety of factors. Available default answers can be directly influenced by the question 310, the nature of the independent intrinsic characteristics 304, dependent intrinsic characteristic 308, and the extrinsic characteristics 306. For example, where the assessment object 302 is an electric motor and a question 310 is presented to ask for the maximum horsepower of the electric motor, the expected answer 312 will be a quantitative value with a unit of measurement in horsepower. Evidence 316 can be requested or required to support the answer 312. In the example with the electric motor, evidence 316 can be vendor operational test results or third party test results.

In another more complex example, a question 310 can be presented about expected revenues for an offering of an electric motor as a new product. For such a question 310, the respondent can be required to provide evidence 316 and a rationale 314 explaining how the evidence 316 supports the answer 312. Providing answers 312 alongside a rationale 314 and supporting evidence 316 can impact the trustworthiness of the answer 312 positively or negatively, and the impact of the rationale 314 can depend upon the substance of the rationale 314 and evidence 316 provided in support of the rationale 314.

The assessment theory model 300 can also require evidence 316 in support of answer 312 and/or supporting rationales 314. Requiring evidence 316 can aid in promoting high objectivity for an assessment 303. Evidence 316 can be in the form of test data, analysis, external relevant trustworthy supporting information, simulations, direct respondent feedback about the assessment object 302 in the environment context of that assessment operating environment 301. In general, obtaining more data results in higher trustworthiness as increased amounts of data result in a higher sample size. Various predefined types of evidence and rationales can be created and used in some implementations for the default answers to questions 310, and the evidence and rationales can further refine the certainty and trustworthy factors for scoring adjustments as previously described.

One purpose of the assessment theory model 300 is to make an assessment 303 of some assessment object 302 by asking questions to understand the nature of the effects of an independent intrinsic characteristic 304 of the assessment object 302 or to understand the effects of the relationship between an assessment object 302 and an extrinsic characteristic 306 of the environment context. An overall assessment could be the result of analysis of multiple assessments with different respondents providing data. In some embodiments, individuals with various roles in an organization would respond to questions by providing answers, rationale, and evidence commensurate with their role in the organization. Another approach that could be taken is to assign the assessment to multiple individuals, for the purpose of statistically analyzing those assessment results to discover response commonality of significance criteria, i.e., those having higher agreement.

In the decision logic 320, logical inferences and analysis are defined in such a manner that they can interpret the results the assessment theory model 300. The first requirement for a valid decision is that the assessment 303 captures all the necessary information. Minimally necessary conditions can be designed into the logic of the assessment theory model 300. The decision logic 320 itself can also be represented as an ontology with its own concepts and necessary information requirements for a valid logical inference of some decision. The decision logic 320 will reference a subset of the assessment model theory concepts, relationships, and asserted data instances relevant to the logical inferences for that kind of decision. The decision logic 320 can utilize Bayesian techniques in some embodiments, but other approaches can be utilized as well. Assessment decisions can utilize the adjusted weights of category scoring and/or question scoring.

A decision 322 can be output for a specific decision logic 320. The decision logic 320 interprets a subset of the data for an assessment object 302. In one example embodiment of the universal assessment, a default value for a decision 322 can be “NotSatisfied” so that the assessment does not support a positive decision. The decision logic 320 can assert its interpretation of a portion of the assessment and its inference results to the decision class by asserting a relationship from the decision logic 320 results class to a “Satisfied” or “NotSatisfied” value in the decision class. Many different decisions can be supported by multiple decision logics, and the decisions can all interpret various subsets of the assessment model data. In some embodiments, a top level decision can be made as well as other lower level decisions, and the top level decision could logically integrate all or most of the lower level decisions to ultimately make an overall assessment of the object considering all relevant contexts and characteristics. In some embodiments, the decision 322 can be a persevere, pivot, or perish decision for a business opportunity. Where this is the case, there can be different decision classes for persevere, pivot, and perish. However, other decisions can be made such as a build or buy decision, a decision on whether or not to acquire or invest in a business, etc.

The decision logic interprets the facts asserted for each assessment and the scoring associated with each response in a specific assessment according to the predefined scoring module 200 of FIG. 2. This interpretation can be used to form a combined semantic and quantitative model that enables a deep understanding of the details of the assessment score for each intrinsic and extrinsic characteristic and their effects on the decision 322. The semantic representation defined by the assessment theory model 300 provides a contextual meaning that decision makers can understand. Additionally, the scoring module 200 of FIG. 2 provides an objective scoring approach that can be interpreted by the decision logic 320 of FIG. 3.

In the illustrated assessment theory model 300 of FIG. 3, various axioms are illustrated by arrows. In some embodiments, each of these axioms can be provided as necessary inquiries in the assessment theory model 300 to ensure that the specific assessment theory is valid. The logical axioms of the assessment theory model 300 can define the conditions of satisfaction that are required for an instance of an assessment concept to be considered a member of a concept class. The conditions typically define a necessary relationship between one concept instance of one concept (e.g. an independent intrinsic characteristic of an assessment object) to a necessary existence of another concept instance (e.g. a dependent intrinsic characteristic of an assessment object). In this way the axioms described here define the overall set of concept instances necessary for an assessment theory model 300 having improved accuracy in decisions.

For the first axiom (AX1), the assessment object 302 is evaluated to see whether the assessment object 302 has an independent intrinsic characteristics 304, and an asserted property “hasIndependentIntrinsicCharacteristic” can be provided to an instance of the independent intrinsic characteristic class where an independent intrinsic characteristic 304 is present. An assessment object 302 can have a plurality of independent intrinsic characteristics 304.

For the second axiom (AX2), the assessment object 302 is evaluated to see whether the assessment object 302 has any dependent intrinsic characteristics 308. The dependent intrinsic characteristic 308 is dependent upon some extrinsic characteristic 306 of the environmental context. An assessment object 302 can have a plurality of dependent intrinsic characteristics 308.

For the third axiom (AX3) through the fifth (AX5) axiom, the relationship between independent intrinsic characteristics 304 and dependent intrinsic characteristics 308 are analyzed. For the third axiom (AX3), the effect of an independent intrinsic characteristic 304 on a dependent intrinsic characteristic 308 is analyzed. Where the independent intrinsic characteristic 304 does in fact affect a dependent intrinsic characteristic 308, the independent intrinsic characteristic 304 in question can have the property “affectsIC.” For the fourth axiom (AX4), the effect of a dependent intrinsic characteristic 308 on an independent intrinsic characteristic 304 is analyzed. The dependent intrinsic characteristic 308 in question can have the property “affectsIC” where this is the case. Where an independent intrinsic characteristic 304 is impacted by another characteristic, it can be appropriate to reclassify the independent intrinsic characteristic 304 as a dependent intrinsic characteristic 308. For the fifth axiom (AX5), a dependent intrinsic characteristic 308 must not also be classified as an independent intrinsic characteristic 304 and vice versa.

The causal relationships AX3 and AX4 defined between intrinsic characteristics can vary in complexity and can vary based on the environment. In some embodiments, these causal relationships AX3 and AX4 can be predefined. However, in other embodiments, these causal relationships AX3 and AX4 can be discovered by subsequent analysis, and the specific assessment theory ontology can be updated based on the discovered causal relationships.

For the sixth axiom (AX6), the effect of one independent intrinsic characteristic 304 on another independent intrinsic characteristic 304 is analyzed. For example, where an intrinsic characteristic is a temporary intrinsic characteristic that might change over time, other intrinsic characteristics can impact that temporary intrinsic characteristic. For example, the age or gender of an organism can impact the weight of that organism.

For the seventh axiom (AX7), the effect of one dependent intrinsic characteristic 308 on another dependent intrinsic characteristic 308 is analyzed. For example, the expected revenue for a company in a calendar year can affect the expected profits and the expected market share for the company.

For the eighth axiom (AX8), an assessment is made of the assessment object 302. In some cases, the assessment must assess a dependent intrinsic characteristic or an independent intrinsic characteristic of the assessment object.

For the ninth axiom (AX9), an assessment is made of the assessment operation environment 301.

For the tenth axiom (AX10), the decision logic must analyze the results of the assessment 303. The eleventh axiom (AX11) can analyze whether sufficient information is present to make a decision 322.

For the twelfth axiom (AX12), potential questions are developed to help evaluate certain dependent intrinsic characteristics 308 of an assessment object 302. Furthermore, potential questions are developed for the thirteenth axiom (AX13) to help evaluate certain independent intrinsic characteristics 304 of the assessment object 302.

For the fourteenth axiom (AX14), potential answer 312 are obtained for given questions 310. The answer 312 can be default answers that are prepared in advance for each question.

For the fifteenth axiom (AX15), the rationale 314 provided in support of any answer 312 is analyzed, and, for the sixteenth axiom (AX16), the evidence 316 provided in support of the answer 312 and/or the rationale 314 is analyzed.

In some embodiments, ISO 56000:2020 innovation management principles and other principles from the ISO series on innovation management can be utilized in the assessment theory model 300. The assessment theory model 300 will ideally add value to the organization, challenge the strategy and objectives of the organization, motivate and mobilize for organizational development, be timely and focused on the future, allow for consideration of context, promote the adoption of best practice, be flexible and holistic, and be an effective and reliable process.

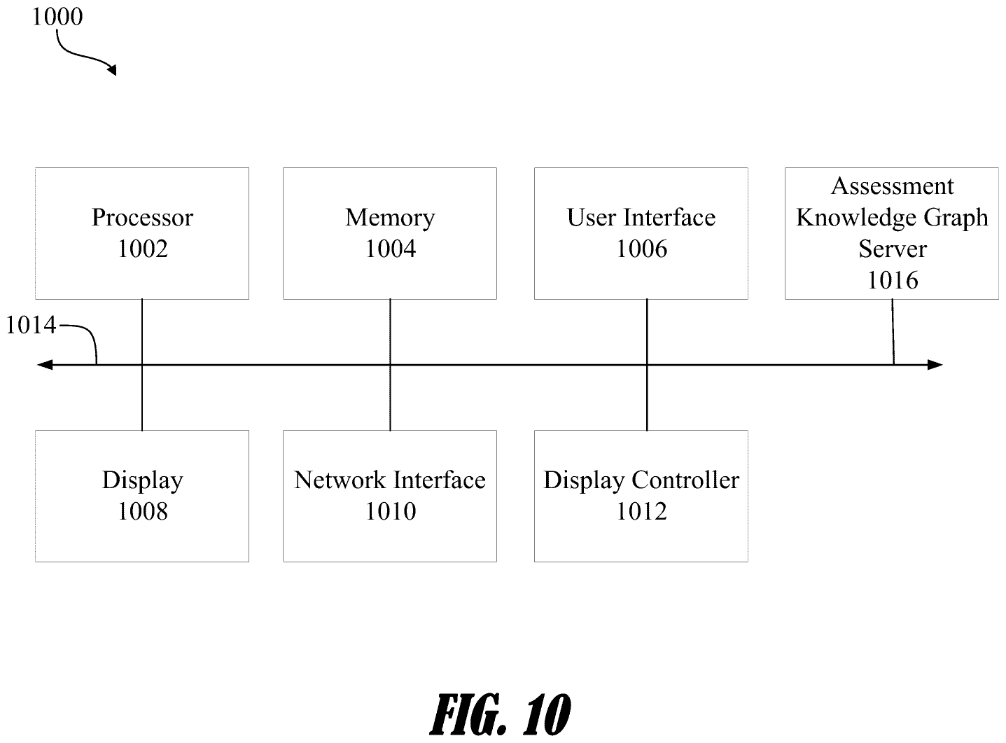

The various functions described herein can be logically described as being performed by one or more modules of the processing circuitry 1000 (see FIG. 10). It will be appreciated that such modules can be implemented in hardware, software, or a combination thereof. It will further be appreciated that, when implemented in software, modules can be part of a single program or one or more separate programs, and can be implemented in a variety of contexts (e.g., as part of an operating system, a device driver, a standalone application, and/or combinations thereof). In addition, software embodying one or more modules can be stored as an executable program on one or more non-transitory computer-readable storage mediums. Functions disclosed herein as being performed by a particular module can also be performed by any other module or combination of modules.

If definitions and relationships provided are consistent with the assessment theory model 300 and satisfy the required axioms, then the specific assessment model will be valid semantically and logically. This validity is focused on the validity of the assessment model and associated ontologies representing the semantics and necessary conditions of the ontologies.

Using the assessment theory model 300, incremental assessments can be made that improve the accuracy of the decisions at different phases of the assessment. There can be a defined sequence of assessment states or phases with specific intrinsic and extrinsic characteristics selected that are relevant for that phase, as well as activated questions for each characteristic or category relevant to that phase. The same category can be relevant for more than one phase of the assessment journey with specific questions associated with that characteristic defined for that phase. Incremental assessments can be beneficial in situations where not all information is readily available for an assessment. As more and more information is obtained through the incremental assessments, the understanding of the assessment object and the environmental context can evolve, and questions can be modified or substituted to obtain necessary information for making specific decisions. This enables the decision logic 320 to provide not only scores for each category but also for each phase. The decision logic 320 also has the capability to define different approaches to combine scores from the characteristics for each phase. In one exemplary approach, a decision classification is made at each phase as more information is gathered by the questions and answers.

The assessment theory model 300 can be used to represent knowledge provided by respondents in various roles at a specific point in time, and this can be similar to how a balance sheet represents the financial state of a company at some point in time. A specific population can be asked to respond to the assessment, and subsequent aggregate analysis can be used to create sample population statistical data from which insights for judgement about the assessment object 302 can be made.

Additionally, the assessment theory model 300 can be used to specify or select different subsets of the assessment model assessment criteria for information collection and classification of different sequential states along a path of an assessment journey. Distinct decision gates can be provided at different points of an assessment, and the decision logic can be executed against the evidence collected for assessment criteria since the last decision gate. Based on the decision made at the decision gates, the assessment can be continued or the assessment can cease.

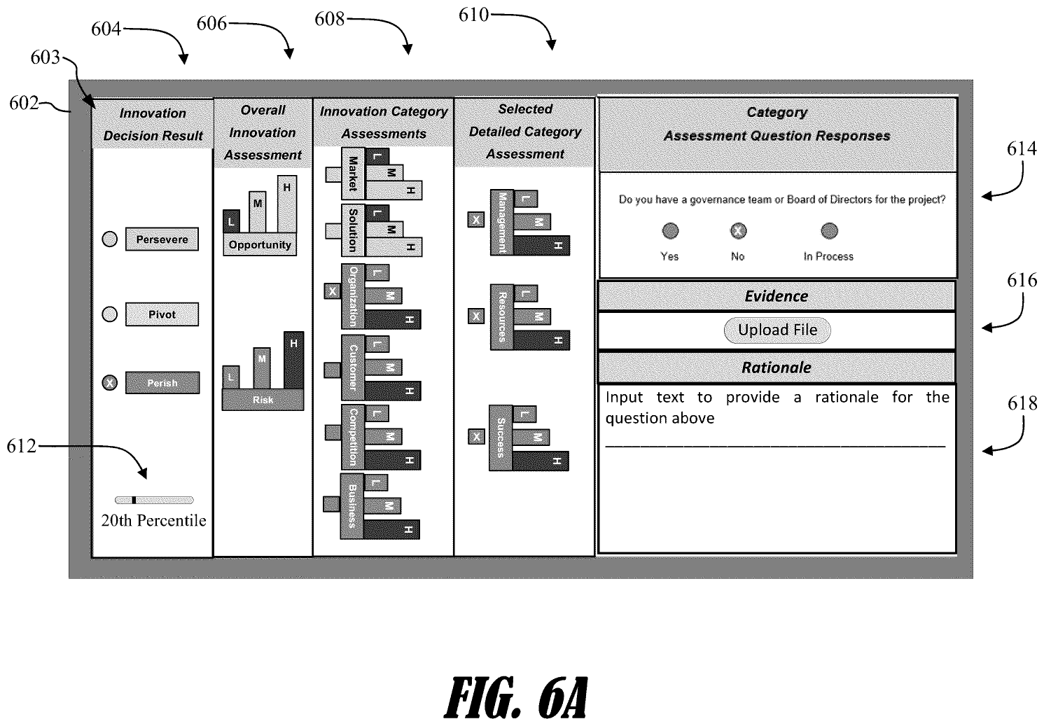

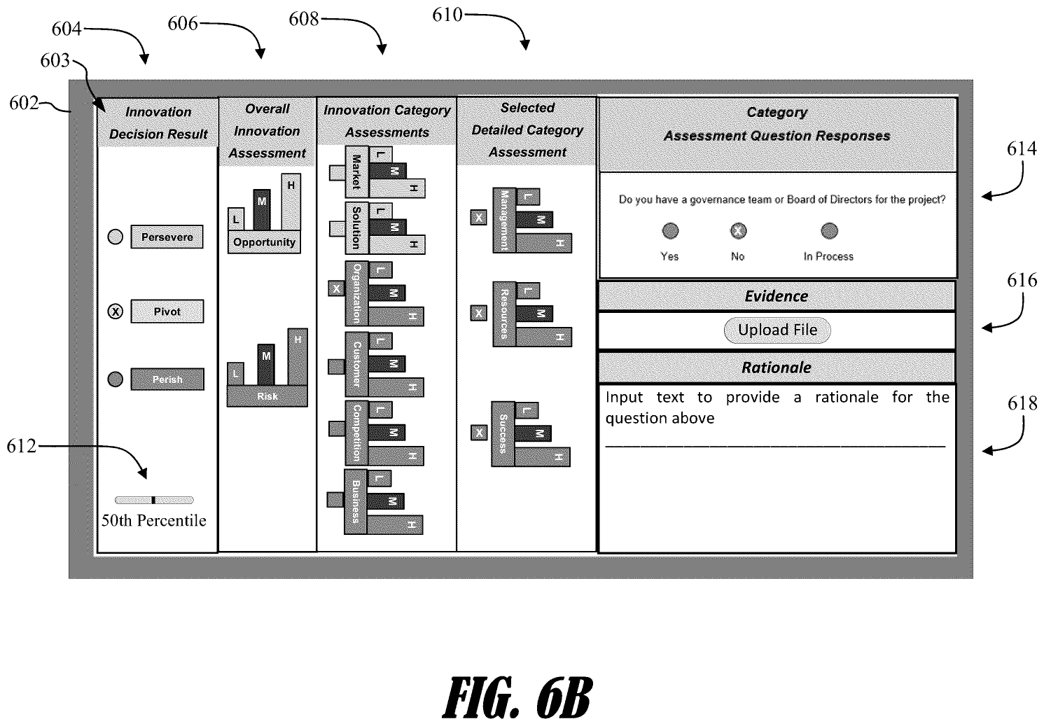

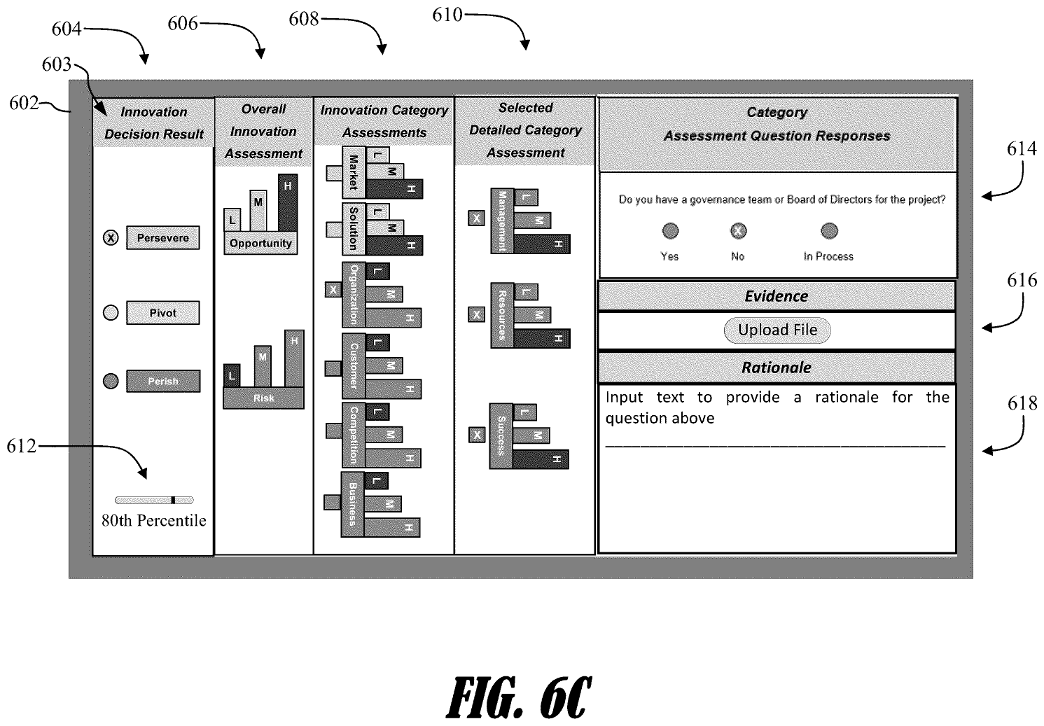

FIG. 4 is a schematic diagram illustrating exemplary modules that can be included in processing circuitry 1000 (see FIG. 10). A user interface module 402 can be provided. This user interface module 402 can receive inputs from a respondent, and the user interface module 402 can also present information to the respondent or provide prompts with questions to the respondent. For example, the user interface module 402 can be responsible for presenting screens illustrated in FIGS. 6A-6C. The user interface module 402 can be configured to receive input data from one or more sensors—for example, the user interface module 402 can be configured to receive input data from a respondent from sensors associated with the display, from input buttons, from a microphone, from a joystick, or from some other sensor.

As noted in reference to FIG. 2, various modules can be provided within the scoring module 404 that are related to specific aspects of scoring determinations. A base scoring module 202 is provided that provides a base score for each response. Furthermore, the scoring module 200 can also include other modules therein to assist in assessing factors that impact scoring. These modules include an importance module 204 that assesses the importance of a given response, a trustworthiness module 206 that analyzes the trustworthiness of a given response, and a certainty module 208 that makes adjustments based on the level of uncertainty associated with a given response. A weighted scoring module 210 is also provided that provides a weighted score based on a base score provided at the base scoring module and based on outputs of the importance module 204, the trustworthiness module 206, and the certainty module 208.

An inquiry module 406 can be included that can craft various questions that are prompted to the respondent. The inquiry module 406 can craft questions that are geared towards obtaining information regarding characteristics (e.g. intrinsic characteristics) of an assessment object as well as extrinsic characteristics of the environment context, and the inquiry module 406 can also present questions related to other features. The inquiry module 406 can incrementally craft more refined questions on certain issues as answers, evidence, and supporting rationales are provided in order to provide more accurate decisions. In other embodiments, the inquiry module 406 can beneficially permit the respondent to respond to questions in the respondent's desired order. Doing so can be beneficial as it can permit the respondent to select respond to certain questions that the respondent considers to be important first, allowing additional questions to be crafted based on these initial responses. Furthermore, the respondent can deselect certain questions that are not relevant, and a respondent can respond to those questions that are relevant. In some embodiments, questions are provided to the respondent in a specified order, and the respondent can be required to respond to each of the questions sequentially.

As the questions from the inquiry module 406 are responded to by the respondent, the inquiry module 406 can develop additional questions to obtain details regarding important features of an assessment object, and the inquiry module 406 can cause these additional questions to be presented to the respondent. By forming and presenting these additional questions, the processing circuitry 1000 (see FIG. 10) can be configured to make incremental assessments with improved accuracy, and the questions being asked can evolve and improve based on the already received responses. Incremental assessments can be particularly beneficial in situations where not all information is readily available at the initial stage of an assessment. As more and more information is obtained through the incremental assessments, the understanding of the assessment object and the environmental context can evolve, and questions can be modified or substituted to obtain necessary information for making specific decisions. Incremental assessments can enable greater contextual focus on specific areas based on the responses, reduce the time required to complete assessments in some embodiments, and provide assessments that are more tailored to the particular assessment object and environmental context.

An external data module 408 can be included that can obtain data from external sources for use in assessments. In one exemplary approach, the external data module 408 can be used to provide evidence, and this evidence can be evaluated by a responder for selecting an answer. The external data can be discovered to be relevant to an intrinsic characteristic, and the external data can then be subsequently classified as relevant to a specific question associated with that characteristic. In some embodiments, the external data module 408 can be beneficially seek information from non-biased sources. The external data module 408 can be used to obtain various types of information, including but not limited to trends for venture capital investment and client early adopters. By obtaining the data from external sources, the external data from these external sources can be used to assist in determining which survey categories should have more relevance in any assessment, which can occur due to the scoring module 200 for having evidence for answers. The external data module 408 can obtain relevant external data based on the environmental context and/or the assessment object that is being assessed. In some cases, the initial data input by the respondent can be weighted less and given less consideration than other external data, but the relative weighting of initial data inputs and/or other external data can be different in other embodiments. External data can be obtained from non-biased sources such as the American Productivity & Quality Center (APQC), the ISO series on innovation management (e.g. ISO 56000:2020 innovation management principles), Eurostat Community Innovation Surveys (CISs), the Wharton Mack Institute for Innovation Management, and/or the American Society for Quality (ASQ). However, external data can be obtained from other sources. In some embodiments, data can be obtained from other sources that can be prone to bias; algorithms, artificial intelligence, and/or machine learning can be used to identify and account for the biases in the data.

A relationship module 410 can be provided that evaluates relationships between the assessment object and its environment context. The relationship module 410 can identify relationships between an independent intrinsic characteristic of an assessment object and a dependent intrinsic characteristic of an assessment object, between one dependent intrinsic characteristic and another dependent intrinsic characteristic, and between an extrinsic characteristic and a dependent intrinsic characteristic. As more and more questions are responded to and as more data is obtained, the understanding of the relationships between various characteristics can be altered. For example, as more questions are responded to, it can become clearer that a strong relationship exists between one extrinsic characteristic of the environment context and another characteristic of an assessment object. The relationship module 410 can continuously or periodically evaluate the relationships between various characteristics to identify whether there is a strong relationship between characteristics, a weak relationship between characteristics, or no relationship between the characteristics. The strength of relationships can be provided in a quantitative manner in some embodiments. Additionally, the relationship module 410 can help in developing ontologies and forming ontology class diagrams similar to those illustrated in FIGS. 5A and 5B-1 to 5B-2.

A decision module 412 can be provided that utilizes a developed ontology and evaluates input data, external data, and any other available data to make a decision. The decision module 412 can determine final innovation decision results such as persevere, pivot, perish determinations, and the decision module 412 can also be responsible for determining other final innovation decision results such as whether to build a new product internally or buy it from a third-party manufacturer, whether it is advisable to attempt to acquire or invest in another business, and to make other determinations. The decision module 412 can also be responsible for making intermediate level conclusions such as the opportunity and/or risk for a particular assessment object, and the decision module 412 can even be responsible for making lower level determinations such as the risk associated with lack of resources and/or a lack of customers.

A classification module 414 can be provided that organizes data points into various data types such as intrinsic characteristic data, extrinsic characteristic data, and other data types. The classification module 414 can be configured to organize the data based on the relevant context and the assessment object that is being assessed. For example, in some situations, the maximum performance or maximum capacity of an object can be appropriately considered to be an independent intrinsic characteristic and can be appropriately considered to be a dependent intrinsic characteristic in other examples. The maximum performance or maximum capacity of an object, the maximum number of respondents for a service offering, or the maximum number of data elements that can be stored in a database server can be appropriately considered to be an independent intrinsic characteristic in some instances. In these examples, the independent intrinsic characteristic 304 is permanent in specifying a maximum performance capacity that is realized when the object performs its function, and the independent intrinsic characteristic is not subject to change based on changes in the environment context. However, in other instances, the maximum realizable performance can be dependent on other extrinsic characteristics of the environment context, and the maximum realizable performance can be appropriately related to as a dependent intrinsic characteristic 308. For example, an electric motor can be configured to operate in an operating temperature range, so the maximum horsepower output can be dependent upon the operating temperature, with the operating temperature being an extrinsic characteristic. In such an instance, the maximum horsepower output can be considered to be a dependent intrinsic characteristic 308. The classification module 414 can work in conjunction with the relationship module 410. As relationships are identified or as it is determined that no relationship exists between characteristics, the classification module 414 can adjust the classification of various characteristics as an independent intrinsic characteristic 304, extrinsic characteristic 306, or a dependent intrinsic characteristic 308.

An improvement module 416 can be provided that assesses potential tasks that can be taken to improve ratings. For example, the improvement module 416 can analyze potential responses that are of high importance and inform the respondent to take a second look at the responses to those questions. Furthermore, the improvement module 416 can identify questions of high importance where the respondent provided minimal supporting evidence and rationales, and the improvement module 416 can prompt the respondent to consider providing further support for those questions. In some embodiments, the improvement module 416 can analyze the difficulty of completing various tasks to direct respondents to impactful tasks that are easier to complete. For example, where a start-up company is being assessed, the improvement module 416 can provide suggestions for reducing risk and/or improving opportunities—e.g., the improvement module 416 can suggest changes in company type (e.g. sole proprietorship to LLC), to obtain critical documents, to hire certain personnel having appropriate qualifications, etc. As another example, the improvement module 416 can identify various responses which have a factors with a low score and can indicate to the respondent certain actions that can be taken to improve the factor—for example, the improvement module 416 can identify a response having a low certainty factor or a low trustworthiness factor, and the improvement module 416 can make a suggestion to the respondent to provide further evidence in support of the response. The improvement module 416 can beneficially increase the relevant scoring for a certain assessment to potentially improve the final decision to an improved category (e.g. moving from the perish category to the pivot category or moving from the pivot category to the persevere category).

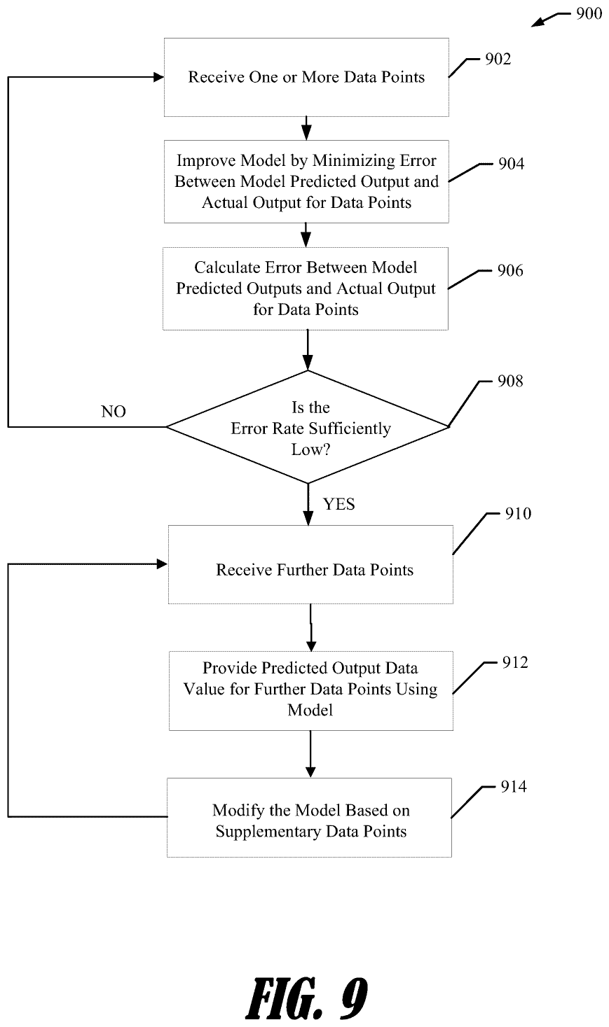

A machine learning module 418 can be provided that uses machine learning to help carry out various tasks. In some embodiments, the machine learning module 418 can be configured to execute the method 900 illustrated in FIG. 9. Machine learning can also be used in other respects. For example, machine learning can be used to assist in scoring, determining the trustworthiness of responses, identifying biases in one or more responses, to generate inquiries or select among potential inquiries, to identify relationships between various characteristics of an assessment object and/or an environmental context, to make classifications for characteristics of an assessment object and/or an environmental context, to generate potential improvements, or to make decisions. Machine learning can analyze data using the semantics of the assessment theory model 300 (see FIG. 2) and/or scoring model 200 (see FIG. 2) to formulate improvements, relationships, classifications, and decisions.

An assessment knowledge module 420 can be provided that can serve as the primary module for storing all the ontologies and assessment data consistent with W3C ontology languages (e.g., OWL/rdf). Additionally or alternatively, a knowledge base query module 422 can be provided having characteristics similar to the knowledge base query module 108 of FIG. 1. The assessment knowledge module 420 can support the W3C SPARWL query language that the knowledge base query module 422 defines and executes to gather the relevant assessment result information and to update the assessment models and scoring models.

While various modules are discussed herein, it should be understood that a variety of other modules can be provided in addition to the listed modules. Additionally, some of the modules that are illustrated in FIG. 4 and described herein are not provided in some embodiments, and the functionality of multiple modules can be combined together in other embodiments. The modules can be used to perform different tasks in other embodiments as well.

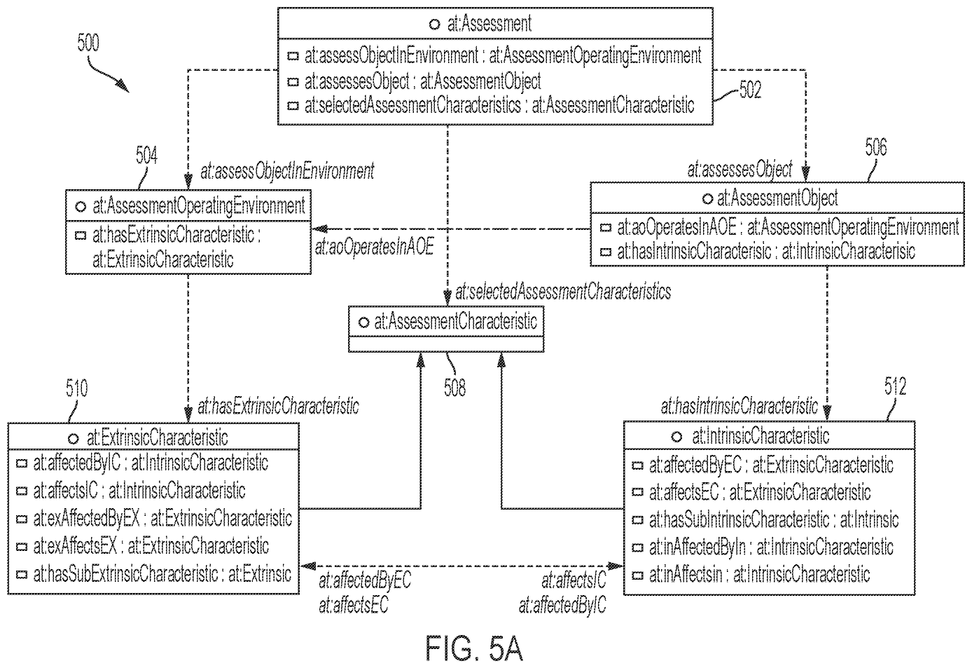

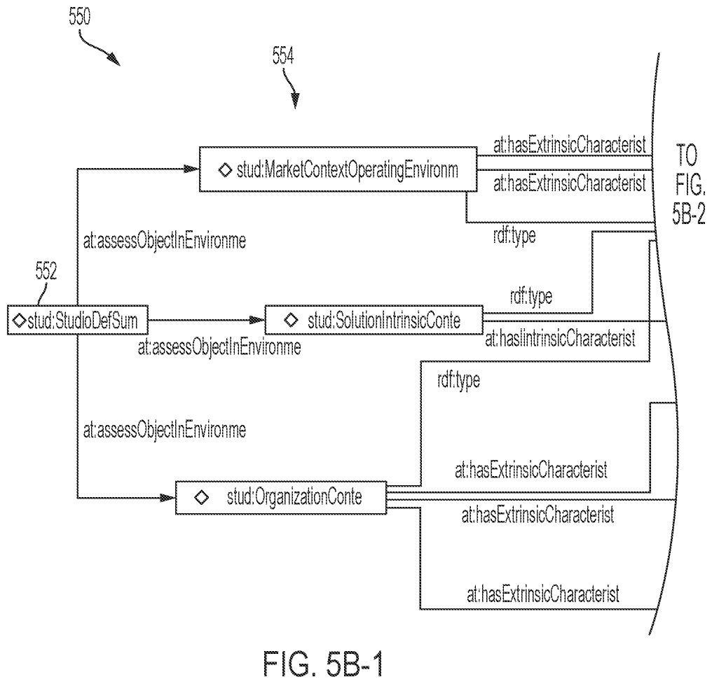

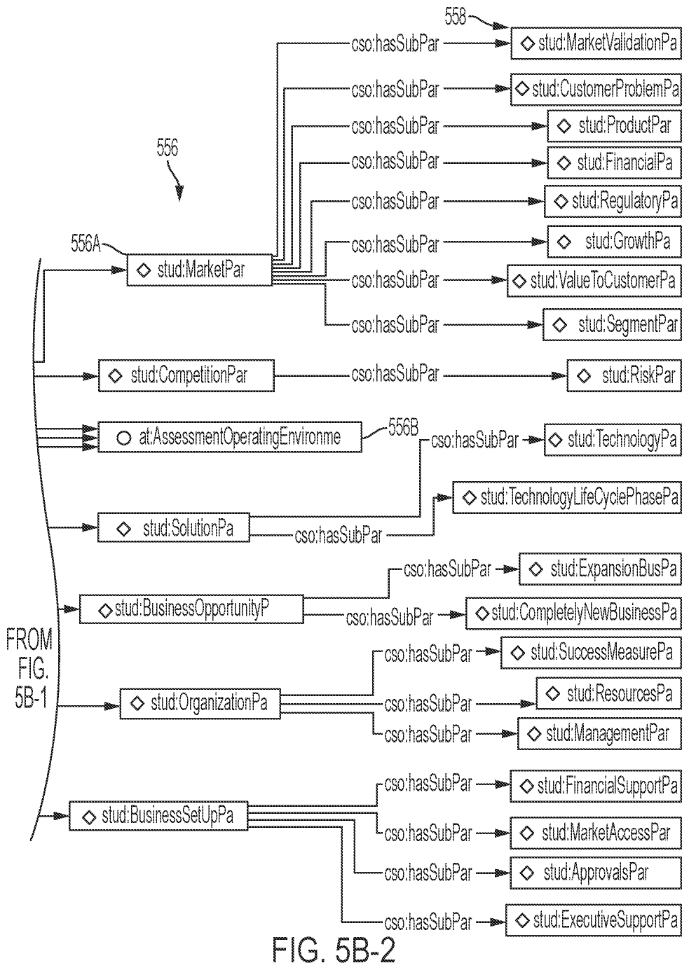

FIG. 5A is a schematic diagram illustrating an example assessment theory ontology class diagram 500 with associations between different characteristics. Various classes are presented in the diagram 500, including an assessment class 502, an assessment object environment class 504, an assessment object class 506, an assessment characteristic class 508, an extrinsic characteristic class 510, and an intrinsic characteristic class 512. Each class can have relationships with other classes, and these relationships are listed for the different classes. For example, the assessment class 502 has a relationship with the assessment object 506, with the assessment 502 identifying the given assessment object 506. In the assessment class 502, “at: assessesObject: at:AssessmentObject” can be provided as a result of this relationship.

Using the example assessment theory ontology class diagram 500, the ontology model can represent defined relationships that are used in the logic for the definitions of various axioms to define a valid assessment. In other words, when an assessment is defined, the axioms of described in the discussion of FIG. 3 can help identify what instances must be present as members of a specific class (e.g., in the independent intrinsic characteristic class 304) and what relationship object property assertions have to be made between various classes, and this can help realize a valid assessment theory semantic and logical model. FIG. 5A illustrates an example of a relatively simple ontology class diagram 500, but other ontology class diagrams 500 that can have increased complexity—as more and more relationships are identified, the complexity of the ontologies can increase. Furthermore, ontologies can be made more complex where multiple dependent intrinsic characteristics, multiple independent intrinsic characteristics, and multiple extrinsic characteristics are considered.

FIG. 5B-1 to 5B-2 provide another schematic diagram illustrating another example assessment theory ontology class diagram 550 with associations between different characteristics. In the illustrated ontology class diagram 550 of FIG. 5B-1 to 5B-2, the various characteristics and other items are organized in different categories. On the left, the defined innovation assessment 552 is provided. Furthermore, main parameters 554, primary assessment characteristics 556, and sub-assessment characteristics 558 are also illustrated. Connections are illustrated between various sub-assessment characteristics 558 with one or more primary assessment characteristics 556 to indicate the presence of a relationship between the two. Furthermore, connections are illustrated between the primary assessment characteristics 556 and the main parameters 554 to indicate a relationship between the two, and connections are illustrated between the main parameters 554 and the defined innovation assessment 552 in order to indicate a relationship between the two. In the illustrated embodiment, the main parameters 554 include the market operation context, the solution operation context, and the organization operation context, but other parameters can be included as main parameters in other embodiments. Furthermore, in the illustrated embodiment of FIG. 5B-1 to 5B-2, the primary assessment characteristics include the market, competition, the operating environment for the assessment, the business opportunities, the organization, and the set up for the business. Additionally, various sub-assessment characteristics 558 can be represented such as the customer problem, market validation, financial data, regulatory data, growth, risk, financial support, market access, etc. However, a wide variety of other parameters and characteristics can be considered.

As illustrated, some of the parameters and characteristics have relationships with multiple other parameters and/or characteristics. For example, the top primary assessment characteristic 556A related to the market in question has relationships with eight different sub-assessment characteristics 558, and the top primary assessment characteristic 556A has only one relationship with a main parameter 554 (the market operation context). As another example, the assessment operating environment primary assessment characteristic 556B has a relationship with all three of the main parameters 554.

Additional detail can be provided to the ontology class diagram 550 in other embodiments. For example, the ontology class diagram 550 can add more detailed items such as individual characteristics, and relationships can be represented between the individual characteristics and the other parameters and characteristics represented in the ontology class diagram 550 of FIG. 5B-1 to 5B-2.

In some embodiments, the ontology class diagrams 500, 550 can be modified to indicate the strength of relationships between different parameters and characteristics. For example, the strength of relationships can be indicated by adding another ontology property that defines weight values according to the scoring module 200 for questions associated with subassessment characteristics 558. This has been done in an ontology representing the scoring module 200. However, the strength can be indicated in other ways as well. However, in some embodiments, the ontology class diagrams 500, 550 can be presented to the respondent on a display or to the assessment designers for the purpose of defining the assessment characteristics relevant to the kind of assessment context.

FIG. 6A-6C are schematic views illustrating example windows or screens 603 defined for a user interface 402 that can be generated by a user interface generator and presented on a display 602. In some embodiments, the assessment theory model 300 can be utilized to make a determination as to whether a company should persevere, pivot, or perish with their business proposal. The exemplary screens 603 provided in FIGS. 6A-6C are provided where a persevere, pivot, or perish determination is being made.

Looking first at the screen 603 presented in FIG. 6A, a perish recommendation is provided. The screen 603 can be presented in a display 602 to the respondent. In the innovation decision result pane 604 on the left side of the screen 603, information can be provided to indicate that the ultimate decision 322 (see FIG. 3) is to perish.

In some embodiments, a percentile rating 612 for the business proposal can be presented in the screen 603. In the illustrated embodiment, this percentile rating 612 is provided in the innovation decision result pane 604, but the percentile rating 612 can be provided at another location on the screen 603. In FIG. 6A, the percentile rating 612 provides an overall percentile rating for the business proposal based on the scoring for the business proposal, with the presented business proposal having a percentile rating 612 being in the 20th percentile. However, in other embodiments, the percentile rating 612 can provide the percentile of the business proposal within its respective scoring group (e.g., 60th percentile in the perish group). The percentile scoring can be different based on variations in the granularity of the scoring, the overall assessment, the decision classification, the category, and/or the question.

In the overall innovation assessment pane 606, a high level summary is provided of the opportunity and the risk for the given business proposal. In the illustrated overall innovation assessment pane 606, a simple indication is provided as to whether the opportunity for the business opportunity is a low-level opportunity, a medium-level opportunity, or a high-level opportunity, and a simple indication is also provided as to whether the risk for the business opportunity is a low-level risk, a medium-level risk, or a high-level risk. This approach can be beneficial to present complex information to the respondent and/or other users in a simple and easy-to-understand manner. In other embodiments, the information provided regarding the opportunity and risk can be presented in other ways. For example, rather than simply indicating that the risk or opportunity is low, medium, or high, a numerical score can be provided, a percentile score can be provided similar to the overall percentile rating 612, or additional quantitative categories can be provided (e.g. very low, low, medium, high, very high). In the overall innovation assessment pane 606 of FIG. 6A, an indication is provided that the opportunity is low and that the risk is high. In another exemplary embodiment, the overall summary provides only the total assessment score and its location within the range of the specific decision result (e.g., −50 within a Perish range of −100 to 0).

In the innovation category assessments pane 608, more detailed metric information can be provided. For example, with respect to metric information related to the opportunity associated with a business opportunity, market and solution metrics can be provided. Furthermore, with respect to metric information related to risk associated with a business opportunity, organization, customer, competition, and business metrics can be provided. Furthermore, in the selected detailed category assessment pane 610, additional metric information can be provided related to the risk or opportunity associated with the given business opportunity. In the illustrated embodiment, the selected detailed category metrics are related to the management, resources, and success of the business opportunity, but other detailed category metrics can be selected. In the illustrated embodiment of FIG. 6A, the market and solution metrics are both low and the risk metrics for organization, customers, competition, and business are each high in the innovation category assessments pane 608. Furthermore, in the illustrated embodiment of FIG. 6A, the risk metrics for management, resources, and success are each high. Given the poor results for the metrics provided in the overall innovation assessment pane 606, the innovation category assessments pane 608, and the selected detailed category assessment pane 610, the innovation decision result pane indicates that a perish innovation decision has bene made, and a poor percentile score in the 20^{th} percentile is provided. Metric information presented in the various panes can take into account just one independent intrinsic characteristic 304 (see FIG. 3), extrinsic characteristic 306 (see FIG. 3), or just one dependent intrinsic characteristic 308 (see FIG. 3), but metric information can instead be compiled based on multiple characteristics.

Various screens can be presented in the display to show the respondent's response to a question relevant to the selected detailed category, which in this diagram is the question about management. For example, the question pane 614 can present one or more questions 310 (see FIG. 3) provided by the respondent alongside selected answers 312 (see FIG. 3). In the illustrated embodiment of FIGS. 6A-6C, the answers 312 are the default answers selected by the respondent in an assessment. Default answers can be provided to limit the potential number of answers and to simplify processing of answers. In the illustrated embodiment, the question presented asks whether the business has a governance team or a Board of Directors for its business, and the default answers are yes, no, or in process and the respondent selected no. However, other questions can be presented, and other default answers can be provided in some situations (e.g., answer to indicate that question is not applicable to the business). In another embodiment, the user can modify the answer for the selected category, detailed category and question to observe its effect on the category scores and the overall decision result. This capability for user feedback provides “What if?” scenarios where it is possible to have different answers with more available information or with changes to the assessment object.

While the default answers are provided in FIGS. 6A-6C as select qualitative answers, respondents can instead be prompted to provide quantitative answers in some situations where it is appropriate to do so based on the question. For example, in evaluating a business, various questions can seek quantifiable metrics such as spending on research and development, number of personnel devoted to various aspects of the business, number of intellectual property filings, number of research projects in active development, percentage of products being made internally versus being made by external manufacturers, available budgets, time to market for ideas, sales from new products over past three years, revenue, customer satisfaction rates, etc. However, various other questions can be asked to seek other quantifiable metrics.

An evidence pane 616 and a rationale pane 618 can also be presented. For the result scenario, the evidence pane 616 can display the content of the evidence information or provide a link to access an appropriate file. In some embodiments, a “what if?” feedback could be provided to enable an operator to explore the effects of additional or alternative evidence and rationales on the scores. The evidence pane 616 can permit the respondent to upload a file to provide evidence 316 (see FIG. 3) to support the answer, and the rationale pane 618 can permit the respondent to input text to provide a rationale 314 (see FIG. 3) for the provided answer. Any evidence or rationales provided in support of the answer or the lack of any evidence or rationales in support of the answer can be considered in determining the trustworthiness of the answer, and this can have an effect on the question's score impact due to the factor adjustments for evidence and rationale. While the various panes are presented in the manner illustrated in FIG. 6A, additional panes can be provided and/or some of the panes can be omitted in other embodiments. Furthermore, the panes can be rearranged or sized differently in other embodiments. For example, the question pane 614 can be increased in size so that multiple questions can be presented to the respondent at one time so that the respondent can select which question the respondent would like to respond to first.

FIG. 6B illustrates another example of the screen presented on the display 602 where the innovation decision is to pivot. In this example, the percentile rating is in the 50^{th} percentile, and the various risk metrics and opportunity metrics are each in the medium range. However, in other examples, a pivot determination can be provided even where various risk and opportunity metrics are provided in the low or high ranges. FIG. 6C illustrates another example of the screen presented on the display 602 where the innovation decision is to persevere. In this example, the percentile rating is in the 80^{th} percentile, and the various risk metrics are each in the low range while the various opportunity metrics are each in the high range. However, in other examples, a persevere determination can be provided even where the various risk metrics fall in the medium or high range and where various opportunity metrics fall in the medium or low range.

The screens illustrated in FIGS. 6A-6C are merely exemplary, and the screens can be modified in other embodiments. For example, in one embodiment, three different scoring ranges were defined for Perish, Pivot and Persevere, and the aggregation of the category scores from the aggregation of their question/response score for a specific phase are displayed rather than a high, medium, and low score. This can effectively simplify the logic for summarizing the scores to a simple one of weighted scoring with multiple scoring definitions possible. The information presented in the screens can be modified where the relevant determinations are different (e.g. where a build or buy determination is being made). The information presented can also be different based on differences in the environment context and/or the assessment object. While the various panes are all provided in a single screen 603 in FIGS. 6A-6C, some of the panes can be provided in different screens in other embodiments.

The universal assessment system enables the creation of multiple assessment theory models 300 to support decisions 322 resulting from an assessment 303. Any universal assessment model 303 can be created from a fixed set of concepts defined in FIG. 3 (e.g., assessment 303, assessment object 302, assessment environment and its extrinsic characteristics 306, etc.).

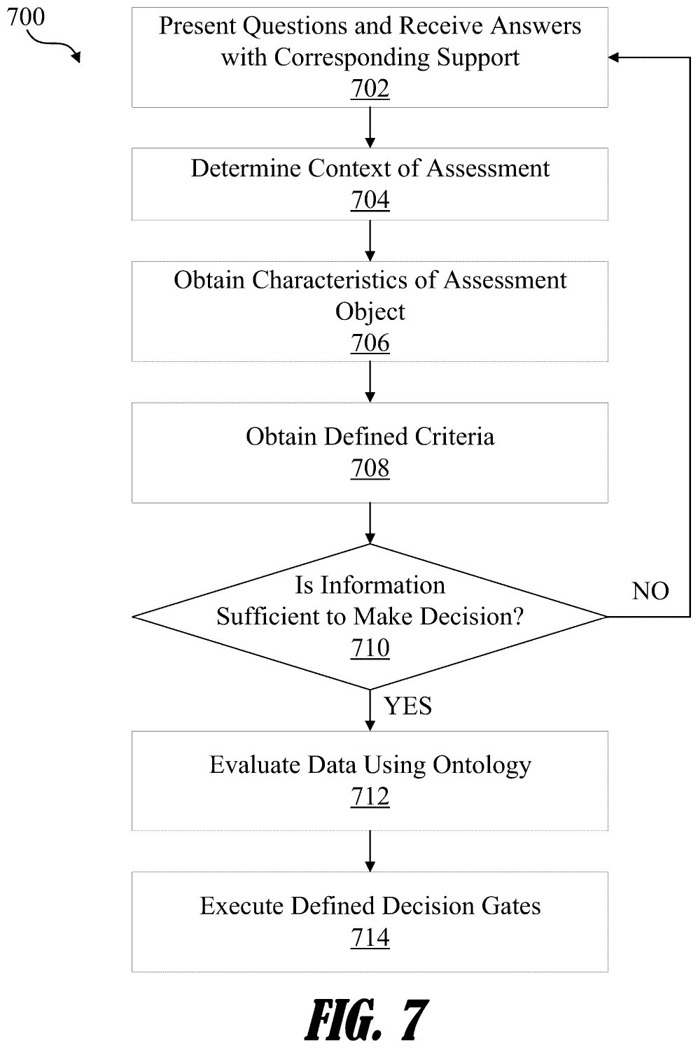

Various methods of making universal assessments are also contemplated. FIG. 7 is a flow chart illustrating one such example method 700. The method 700 is beneficial in that it can be adapted for making a wide variety of determinations and to assess a wide variety of assessment objects. Notably, the operations of FIG. 7 can be performed in various orders, and the operations need not proceed in the order specified in FIG. 7.

At operation 702, questions are presented to the respondent, and respondents are prompted to provide an answer. The answer can be in the form of a default answer in some embodiments, and this can be beneficial where the answer is a qualitative one. However, the respondent can be prompted to provide a quantitative answer by inserting a numerical value where it is appropriate to do so for the particular question. Respondents can be prompted to provide answers alongside corresponding evidence and rationales for some or all of the questions. Questions can be developed using the inquiry module 406 (see FIG. 4), and the respondent can be prompted to address the questions.

At operation 704, the environment context of the assessment is determined. The object qualities are obtained at operation 706, and the defined criteria are obtained at operation 708. In some embodiments, the understanding of the environment context can be improved by obtaining information from external sources. For example, where an assessment is being made regarding the acquisition of a potential business, external data can be obtained regarding other competitors, the products of competitors, and profits, revenue, and market share information of the business and its competitors. Based on the determination of the environment context of the assessment, the universal assessment can be refined.

Characteristics of an assessment object can be determined as more answers are provided by the respondent and as evidence and supporting rationales are provided by the respondent. Furthermore, the defined criteria can be presented in the form of questions and default answers for the respondent, and the respondent can be prompted to present evidence in support of their answer as well as a rationale in support of the answer. The defined criteria can provide guidance as to the relevant evidence and rationale that the respondent can provide.

At operation 710, a determination is made as to whether the data that is present is sufficient to make an ultimate decision for the assessment. If the data is not sufficient, the method 700 will proceed back to operation 702 and proceed through the operations again for further refinement. If the data is sufficient to make a decision, then the method 700 will proceed to operation 712. In other embodiments, the determination 710 can be provided at other positions in the method 700. In most cases, the data will not be sufficient to make a determination for several iterations of the initial operations for the method 700, and these initial operations can be performed several times until the data has been refined a sufficient amount to provide an accurate decision. As more information is obtained regarding the environment context, the assessment object and its characteristics, and the defined criteria, further questions can be presented based on the improved understanding of the environment context and/or the assessment object. Data is evaluated using an ontology at operation 712, and defined decision gates can be executed at operation at operation 714.

Operations can be performed in any order, and operations can be performed simultaneously in some embodiments. Additional operations can be performed in other embodiments, and some of the operations illustrated in FIG. 7 can be omitted in other embodiments. While the method 700 shows an iterative loop occurring only when the information is not sufficient to make a decision as determined at operation 710, the method 700 can be performed iteratively based on requests to do so from the respondent or as further data is received.

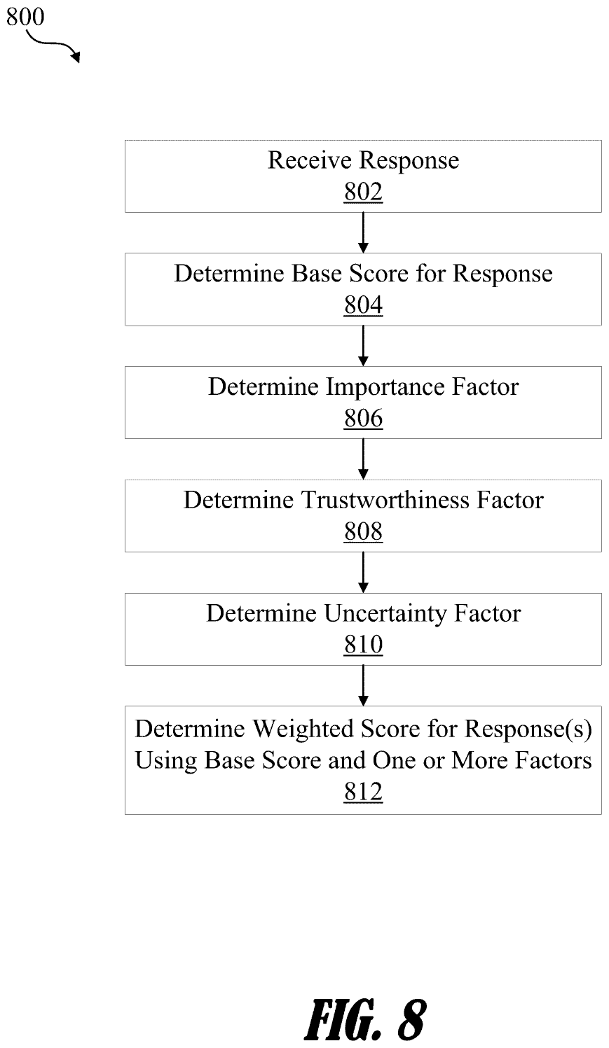

Methods are also contemplated for scoring. FIG. 8 is a flow chart illustrating an example method 800 for scoring responses. In some embodiments, the method 800 can be executed by the scoring module 404 (see FIG. 4), but the method 800 can be executed by other components or modules in other embodiments. The respondent can be prompted to respond to certain questions to elicit a response from the respondent. At operation 802, the response is received, and the response will include an answer. The response can also include a rationale provided by the respondent to support the answer, and the response can also include evidence provided by the respondent to support the answer and/or the rationale. In some embodiments, the response will simply include the answer, and the answer can be in the form of a default answer. The answer can also be in the form of a quantitative answer where the question calls for some numerical value.

At operation 804, a base score for the response is determined. The scoring module 404 (see FIG. 4) can be configured to provide various scoring adjustments based on the answers, evidence, and rationales provided by the respondent. For each responses, a score ranging from −5 to +5, a score ranging from −5 to 0, or a score ranging from 0 to +5 can be provided, with the relevant scoring range being provided based on questions asked. For example, where a question is directed towards risks for a given assessment object, then the score range of −5 to 0 will likely be appropriate, and where a question is directed towards the opportunities provided by an assessment object, then the score range of 0 to +5 will likely be appropriate.

At operation 806, an importance factor can be determined for the response. The scoring module 404 (see FIG. 4) can include an importance factor that can be dependent upon the importance of certain questions and/or responses. This importance factor can, for example, be an integer weighed from 1 to 10. Increasing the importance factor of one response will effectively reduce the importance factor of another response.

At operation 808, a trustworthiness factor can be determined. The trustworthiness factor can adjust the score associated with a particular question downwardly where the answers, evidence, and/or rationales provided in response to the question are inconsistent with answers, evidence, and/or rationales provided in response to another question. The trustworthiness factor can also adjust the score associated with a particular question downwardly where answers, evidence, and/or rationales indicate some bias in how the respondent is responding to the questions. Where responses are consistent and/or there is no bias detected, the trustworthiness factor can adjust the score associated with a particular question upwardly in some embodiments.

At operation 810, a certainty factor can be determined. The determination can be weaker where there is inherent uncertainty regarding some aspects of the assessment, and the use of the certainty factor can be beneficial to account for this. Where limited information is available regarding a certain question, a certainty factor can be reduced to effectively adjust the score downwardly for the given question. In some embodiments, where the information available for a certain characteristic of an assessment object is high, the certainty factor can actually be increased so that the score is improved due to the increased certainty. In some embodiments, the limited information can be based on the lack of supporting evidence and/or supporting rationales.

At operation 812, the weighted score for one or more responses can be determined. This can be done by taking into account the base score and one or more of the factors 806, 808, 810. In some embodiments, the base score and the various factors being used (e.g. the importance factor, the trustworthiness factor, the certainty factor) can be multiplied together to get a weighted score for the question and response. In some embodiments, a cross-product can be used to get the cumulative impact of the various responses. Through the scoring approach taken by the scoring module 404 (see FIG. 4), an objective score can be obtained to provide increased accuracy in assessments.

FIG. 9 is a flow chart illustrating an example method 900 of machine learning that can be executed at a machine learning module and that can be utilized in making universal assessments. This method of machine learning can be utilized with artificial intelligence in some embodiments. At least one processor or another suitable device can be configured to develop a model for conducting universal assessments, such as described herein in various embodiments. In some embodiments, processing circuitry 1000 (see FIG. 10) can comprise one or more processors that perform the functions shown in FIG. 9.

This system can beneficially make universal assessments by accounting for various types of data, intrinsic characteristics of assessment objects, extrinsic characteristics, assessment characteristics, etc. Further, the developed model can assign different weights to different types of data and/or characteristics that are provided. In some systems, even after the model is deployed, the systems can beneficially improve the developed model by analyzing further data points. By utilizing artificial intelligence and/or machine learning, a novice user can benefit from the experience of the models utilized, and different relationships can be identified that a novice user or even experienced users would fail to identify. Embodiments beneficially allow for accurate assessments to be provided and allow for information about these assessments to be shared with the user (such as on the display) so that the user can make well-informed decisions. Utilization of the model can prevent the need for a user to spend a significant amount of time conducting assessments, freeing the user to perform other tasks and enabling performance and consideration of complex estimations and computations that the user could not otherwise solve on their own (e.g., the systems described herein can also be beneficial for even the most experienced users). Additionally, the use of artificial intelligence and/or machine learning can help eliminate bias that can otherwise be present-models can be generated by finding relationships between different data points and characteristics, and these models can be created without the need for any initial input from a person, which can be prone to bias.

By receiving several different types of data, the example method 900 can be performed to generate complex models. The example method 900 can find relationships between different types of data that are not anticipated. By detecting relationships between different types of data, the method 900 can generate accurate models even where a limited amount of data is available.

In some embodiments, the model can be continuously improved even after the model has been deployed. Thus, the model can be continuously refined based on changes over time, which provides a benefit as compared with other models that stay the same after being deployed. The example method 900 can also refine the deployed model to fine-tune weights that are provided to various types of data based on subtle changes. For example, as the economic environment changes over time, continuous refinement over time can be helpful to ensure that any model that is developed remains effective. By contrast, where a model is not continuously refined, subsequent changes can make the model inaccurate until a new model can be developed and implemented, and implementation of a new model can be very costly, time-consuming, and less accurate than a continuously refined model.

At operation 902, one or more data points are received. These data points can be the initial data points being received, but other data points can be the initial data points that are received in some embodiments. The data points received at operation 902 preferably comprise known data on a characteristic that the model can be used to evaluate. For example, where the model is being generated to evaluate a characteristic of a certain assessment object, the data points provided at operation 902 will preferably comprise known data that corresponds to that characteristic. The data points provided at operation 902 will preferably be historical data points with verified values to ensure that the model generated will be accurate. The data points can take the form of discrete data points. However, where the data points are not known at a high confidence level, a calculated data value can be provided, and, in some cases, a standard deviation or uncertainty value can also be provided to assist in determining the weight to be provided to the data value in generating a model.

The model can be formed based on historical comparisons of a historical characteristics with historical data for other similar assessment objects, and a processor can be configured to utilize the developed model to determine an estimated characteristic properties. This model can be developed through machine learning utilizing artificial intelligence based on the historical comparisons of the historical characteristics with other historical data for similar assessment objects. Alternatively, a model can be developed through artificial intelligence, and the model can be formed based on historical comparisons of historical characteristics with other historical data for similar assessment objects. A processor can be configured to use the model and input data into the model to determine the one or more characteristics.

At operation 904, a model is improved by minimizing error between a predicted outputs and/or estimated outputs generated by the model. In some embodiments, an initial model can be provided or selected by a user. The user can provide a hypothesis for an initial model, and the method 900 can improve the initial model. However, in other embodiments, the user will not provide an initial model, and the method 900 can develop the initial model at operation 904, such as during the first iteration of the method 900. The process of minimizing error can be similar to a linear regression analysis on a larger scale where three or more different variables are being analyzed, and various weights can be provided for the variables to develop a model with the highest accuracy possible. Where a certain variable has a high correlation with the actual characteristic, that variable can be given increased weight in the model. For example, where the availability of a certain material at low pricing has a strong impact on the profitability of the potential product, this variable—the price of the material—can be given increased weight in a model used to determine whether or not to bring that product to market. In refining the model by minimizing the error between the predicted object characteristic and/or object-type generated by the model and the actual characteristics, the component performing the method 900 can perform a very large number of complex computations. Sufficient refinement results in an accurate model.

In some embodiments, the accuracy of the model can be checked. For example, at operation 906, the accuracy of the model is determined. This can be done by calculating the error between the model predicted outputs and the actual outputs. In some embodiments, error can also be calculated before operation 904. By calculating the accuracy or the error, the method 900 can determine if the model needs to be refined further or if the model is ready to be deployed. Where the characteristic is a qualitative value or a categorical value such as a yes or no answer, a business type, or some other qualitative value, the accuracy can be assessed based on the number of times the predicted value was correct. Where the characteristic is a quantitative value, the accuracy can be assessed based on the difference between the actual value and the predicted value. However, other approaches for determining accuracy can also be used.

At operation 908, a determination is made as to whether the calculated error is sufficiently low. If the error rate is not sufficiently low, then the method 900 can proceed back to operation 902 so that one or more additional data points can be received. If the error rate is sufficiently low, then the method 900 proceeds to operation 910. Once the error rate is sufficiently low, the training phase for developing the model can be completed, and the implementation phase can begin where the model can be used to predict the expected outputs.

By completing operations 902, 904, 906, and 908, a model can be refined through machine learning utilizing artificial intelligence. Notably, example model generation and/or refinement can be accomplished even if the order of these operations is changed, if some operations are removed, or if other operations are added.

During the implementation phase, the model can be utilized to provide a determined output. An example implementation of a model is illustrated from operations 910-912. In some embodiments, the model can be modified (e.g., further refined) based on the received data points, such as at operation 914.

At operation 910, further data points are received. For these further data points, the relevant output and its properties are not known in some instances. At operation 912, the model can be used to provide a predicted output data value for the further data points. Thus, the model can be utilized to determine the output.

At operation 914, the model can be modified based on supplementary data points, such as those received during operation 910 and/or other data points. By providing supplementary data points, the model can continuously be improved even after the model has been deployed. The supplementary data points can be the further data points received at operation 910, or the supplementary data points can be provided to the processor from some other source. In some embodiments, the processor(s) or other components performing the method 900 can receive external data from external sources and verify the further data points received at operation 910 using this external data. By doing this, the method 900 can prevent errors in the further data points from negatively impacting the accuracy of the model.

In some embodiments, supplementary data points are provided to the processor(s) from some other source and are utilized to improve the model. For example, supplementary data points can be saved to a memory 1004 (see FIG. 10) associated with processor 1002 (see FIG. 10), and supplementary data points can be transferred to memory 1004 from the communication bus 1014 (see FIG. 10), the network interface 1010 (see FIG. 10), and/or the user interface 1006 (see FIG. 10). In some embodiments, the supplementary data points can be transferred via the network interface 1010 from a remote device. In some embodiments, supplementary data points can be verified before being provided to the processor 1002 to improve the model, or the processor 1002 can verify the supplementary data points before utilizing the supplementary data points.

As indicated above, in some embodiments, operation 914 is not performed and the method proceeds from operation 912 back to operation 910. In other embodiments, operation 914 occurs before operation 912 or simultaneous with operation 912. Upon completion, the method 900 can return to operation 910 and proceed on to the subsequent operations. Supplementary data points can be the further data points received at operation 910 or some other data points.

FIG. 10 illustrates one exemplary architecture of the processing circuitry 1000. In other embodiments, the processing circuitry 1000 can differ in architecture and operation from that shown and described here.

The illustrated processing circuitry 1000 includes a processor 1002 which can be configured to execute various operations discussed here. However, the processor 1002 can be used to execute various functions described herein. The processor 1002 can operate using an operating system (OS), device drivers, application programs, and so forth. The processor 1002 can include any type of microprocessor or central processing unit (CPU), including programmable general-purpose or special-purpose microprocessors and/or any one of a variety of proprietary or commercially-available single or multi-processor systems.

The processing circuitry 1000 can also include a memory 1004, which provides temporary or permanent storage for code to be executed by the processor 1002 or for data that is processed by the processor 1002. The memory 1004 can include read-only memory (ROM), flash memory, one or more varieties of random access memory (RAM), and/or a combination of memory technologies. The memory 1004 can include any conventional medium for storing data in a non-volatile and/or non-transient manner. The memory 1004 can thus hold data and/or instructions in a persistent state (i.e., the value is retained despite interruption of power to the processing circuitry 1000). The memory 1004 can include one or more hard disk drives, flash drives, USB drives, optical drives, various media disks or cards, and/or any combination thereof and can be directly connected to the other components of the processing circuitry 1000 or remotely connected thereto, such as over a network.

The various elements of the processing circuitry 1000 are coupled to a bus system 1014. The illustrated bus system 1014 is an abstraction that represents any one or more separate physical buses, communication lines/interfaces, and/or multi-drop or point-to-point connections, connected by appropriate bridges, adapters, and/or controllers.

The exemplary processing circuitry 1000 also includes a user interface 1006, a display 1008, a network interface 1010, and a display controller 1012. The user interface 1006 can receive inputs from the user via touch commands that are detected on a display, based on inputs received at input keys, based on drawings or text written by a user, based on voice commands, and in other various ways. The display 1008 can present information to the user such as questions, current results of the assessment, other information about the assessment, etc. The network interface 1010 enables the processing circuitry 1000 to communicate with remote devices (e.g., digital data processing systems) over a network. The display controller 1012 can include a video processor and a video memory, and display controller 1012 can generate images to be displayed on one or more displays in accordance with instructions received from the processor 1002.

The assessment knowledge graph server 1016 can host all of the ontologies, defined assessment models, defined scoring models, and all data from each assessment response and subsequent analysis. This assessment knowledge graph server 1016 can be complaint with W3C OWL/rdf recommendations for ontology languages and the direct semantics for such languages as defined by W3C. The assessment knowledge graph server 1016 can also support W3C SPARQL ontology query language and other graph query languages.

In some embodiments, the architecture 1000 of FIG. 10 can be implemented on a Cloud system, whereby resources are allocated on demand. In such an architecture the essential need for similar resources are provided by a cloud resource environment, which act as the host computing resource environment for the universal assessment system.

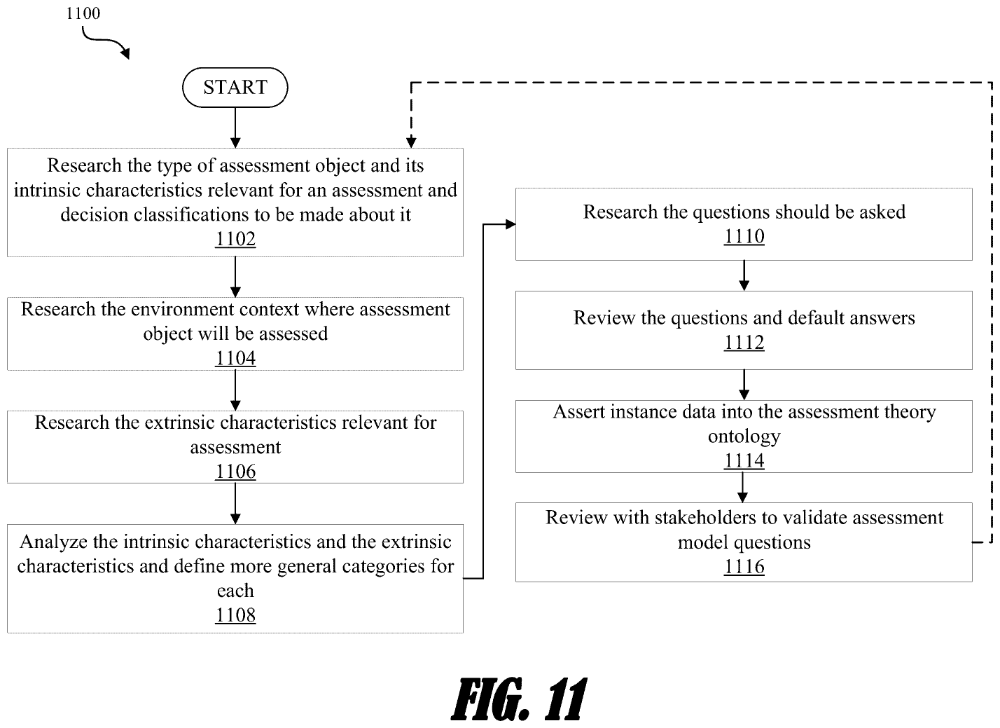

The flow chart of FIG. 11 describes one process for defining one instance of an assessment model.

At operation 1102, the type of assessment object and its intrinsic characteristics relevant for an assessment is researched, and the decision classifications to be made about it are also researched. Operation 1102 can be focused on gaining a good understanding of the object to be assessed 302, understanding the nature of the assessment 303 that will satisfy the kind of decisions 322 to be made, and then identifying and clarifying those intrinsic characteristics of the assessment object that with information about them would aid in the decision. Operation 1102 can also be focused on an understanding of these intrinsic characteristics how they would help in understanding their relationships to extrinsic characteristics.

At operation 1104, the environment context where the assessment object will be assessed is researched. Operation 1104 can be focused on identifying those environmental contexts in which the assessment object will be evaluated against. There can be more than one environmental context and the model theory can enable a separate assessment model to be defined for each environment context which by definition requires multiple assessment model definitions, or rather to combine multiple environment contexts in one assessment model definition. Both are supported by the assessment theory ontology 106A and questionnaire survey ontology 106B.

At operation 1106, the extrinsic characteristics relevant for assessment are researched. Operation 1106 identifies and defines the extrinsic characteristics that with information about them help understand the effect the assessment object has on them or vice-versa. Again the focus should be on not identifying these extrinsic characteristics in a vacuum, but rather identifying those extrinsic characteristics of the environment context that are influenced by or influence some intrinsic characteristics of the object that are relevant to the assessment focus and scope. In some embodiments, the understanding of the environment context can be improved by obtaining information from external sources. For example, where an assessment is being made regarding the acquisition of a potential business, external data can be obtained regarding other competitors, the products of competitors, and profits, revenue, and market share information of the business and its competitors. Based on the determination of the environment context of the assessment, the universal assessment can be refined.

At operation 1108, the intrinsic characteristics and the extrinsic characteristics are analyzed, and more general categories are defined for each of the assessment object characteristics.

At operation 1110, research can be done to identify questions that should be asked. This can be done to gain information about a specific assessment object for both intrinsic and extrinsic characteristics and define the possible set of default answers for each. Operation 1110 reviews the previous operations to ensure that the identified extrinsic and intrinsic characteristics cover the necessary information to make an assessment with an informed decision for the identified assessment object type.

At operation 1112, the questions and default answers are reviewed. This review can be performed to ensure that the questions and default answers provide the information necessary to the kinds of decisions for the assessment. Operation 1112 creates one or more questions 310 and answers 312 for each defined intrinsic and extrinsic characteristic. The questions can be formed in such a manner that they will have a finite set of possible answers. Questions can be of two types, those that are factual in nature and are not estimations or judgements, and those that are estimations or judgements that rely on experts or data analysis or estimation models.

At operation 1114, the ontologist asserts instance data into the assessment theory ontology 106A. This can be done by asserting the instance data in the form of rdf triples to create a new instance of an assessment model definition per exemplary classes and relations in FIG. 5A for the assessment, the assessment object, the assessment operating environment, the intrinsic characteristic (which can be independent or dependent), the extrinsic characteristic, the question, the answer, and the decisions. Operation 1114 involves creating the new assessment model instance by making data assertions or inputs to the assessment theory ontology 106A and the question survey ontology 106B. For one embodiment these are in fact rdf/owl triple assertions. An example of some of these assertions can be made using the ontology set of classes and properties as illustrated in FIG. 5A. Here are a few exemplary triples that define an assessment instance 502, and assessment environment and the relationship between them. In this example, a motor is being assessed in a manufacturing environment and an assessment model MotorAssessment has been defined as an instance of the ontology class at:Assessment, while an instance at:ManufacturingEnvironment has been defined as an instance of type at:AssessmentOperatingEnvironment. This at:MotorAssessment model instance is starting to form by now asserting a relationship at:assessObjectInEnvironment to the at:ManufacturingEnvironment. In such a manner, other instances and properties of the assessment model instance at:MotorAssessment are formed for the other classes: (i) at:MotorAssessment rdf:type at:Assessment; (ii) at:ManufacturingEnvironment rdf:type at:AssessmentOperatingEnvironment; (iii) at:MotorAssessment at:assessObjectInEnvironment at:ManufacturingEnvironment.

At operation 1116, material is reviewed with stakeholders to validate the assessment model questions. The next operation 1116 is focused on reviewing the defined assessment model with stakeholders and to make any final modifications. In some embodiments, the method 1100 can be performed iteratively so that additional refinement can occur following operation 1116. Where the method 1100 is performed iteratively, the method 1100 can proceed from operation 1116 back to operation 1102. However, some or all of the operations are performed in subsequent iterations in some embodiments.

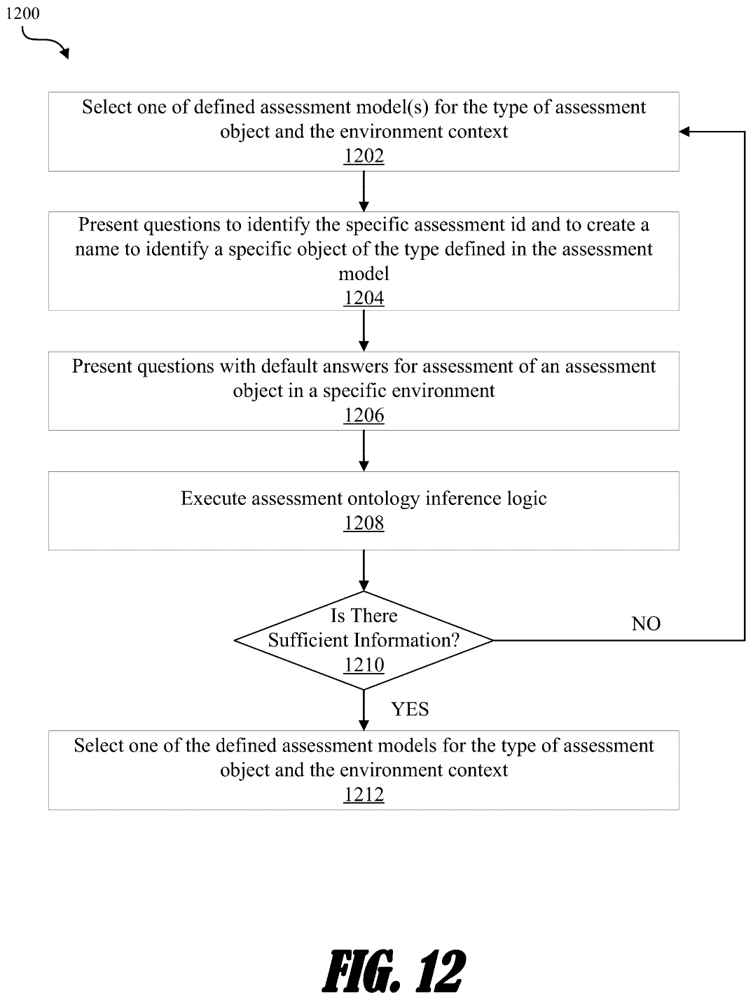

Various methods of making universal assessments are also contemplated. FIG. 12 is a flow chart illustrating one such example method 1200 that involve use of the universal assessment system. The method 1200 is beneficial in that it can be adapted for making a wide variety of determinations and to assess a wide variety of assessment objects. Notably, the operations of FIG. 12 can be performed in various orders, and the operations need not proceed in the order specified in FIG. 12.

At operation 1202, a selection of one or more defined assessment models is made for the type of assessment object and the environment context for assessing the object. If no specific assessment model is available that satisfies the need, then another one can be created as specified in FIG. 11. In this case, it can prove beneficial to copy an existing assessment model and then modify it where it has related object types and environment contexts. This would minimize the need for the creation of entirely new extrinsic and intrinsic characteristics and their associated questions and answers.

At operation 1204, questions are presented to identify the specific assessment identification and to create a name to identify a specific object of the type defined in the assessment model. Specific new instances can be created for the assessment and the assessment object.

At operation 1206, questions are presented with default answers for assessment of an assessment object in a specific environment. Questions are presented to the respondent, and respondents are prompted to provide an answer. The answer can be in the form of a default answer in some embodiments, and this can be beneficial where the answer is a qualitative one. However, the respondent can be prompted to provide a quantitative answer by selecting a default range of quantitative values that are presented for selection. Respondents can be prompted to provide answers alongside corresponding evidence and rationales for some or all of the questions. Questions can be developed using the inquiry module 406 (see FIG. 4), and the respondent can be prompted to address the questions.

At operation 1208, the assessment ontology inference logic of the innovation assessment knowledge system 106 is executed. At operation 1210, a determination is made as to whether the data that is present is sufficient to make an ultimate decision for the assessment. If the data is not sufficient, the method will proceed back to operation 1202 and proceed through the operations again for further refinement. If the data is sufficient to make a decision, then the method 1200 will proceed to operation 1212. In most cases, the data will not be sufficient to make a determination for several iterations of the initial operations for the method 1200, and these initial operations can be performed several times until the data has been refined a sufficient amount to provide an accurate decision. As more information is obtained regarding the environment context, the assessment object and its characteristics, and the defined criteria, further questions can be presented based on the improved understanding of the environment context and/or the assessment object. Data is evaluated using an ontology queries at operation 1212, and results provide at multiple levels of granularity (e.g., decision gate phases, category characteristics, question level).

At operation 1212, one of the defined assessment models are selected for the type of assessment object and the environment context. At operation 1212, the knowledge base query module 108 can be executed with the effect of garnering the assessment results and populating the interface panes as illustrated in FIGS. 6A, 6B, and 6C in one embodiment. Operations can be performed in any order, and operations can be performed simultaneously in some embodiments. Additional operations can be performed in other embodiments, and some of the operations illustrated in FIG. 12 can be omitted in other embodiments. While the method 1200 shows an iterative loop occurring only when the information is not sufficient to make a decision as determined at operation 1210, the method 1200 can be performed iteratively based on requests to do so from the respondent or as further data is received.

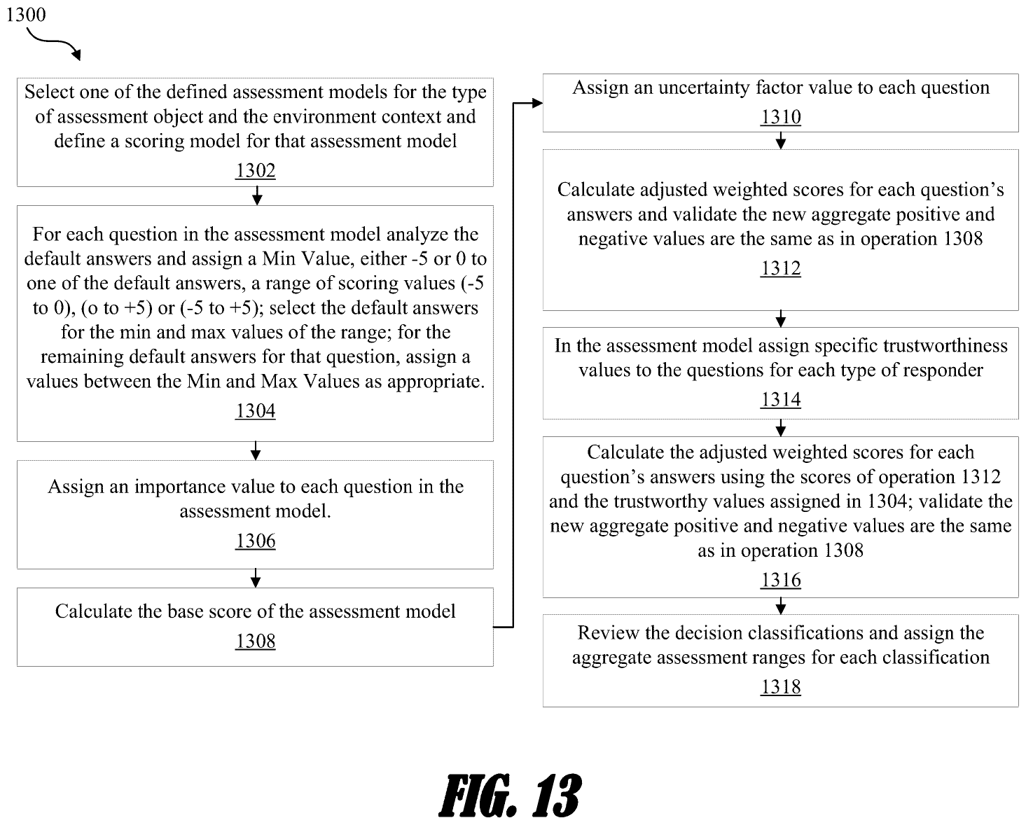

Other methods are also contemplated for scoring. FIG. 13 is a flow chart illustrating an example method 1300 for defining scoring models. In some embodiments, the method 1300 can be executed by the scoring module 404 (see FIG. 4), but the method 1300 can be executed by other components or modules in other embodiments. Since the respondent can be prompted to respond to certain questions to elicit a response from the respondent, it can be beneficial to start assigning scoring values to each question and its default answers as described below

At operation 1302, the specific assessment model is selected to have a new scoring model assigned to it and a scoring model is defined for that assessment model. Selection can be made based on the type of assessment object and based on the environment context. An assessment model can have more than one scoring model assigned to it for various interpretations from different perspectives. For example, a marketing department might decide to focus on extrinsic characteristics associated with competition, potent market penetration percentages, number of potential customers, with the effect of focusing the importance factor on these areas, but still considering other related characteristics. Though the assessment models typically can have multiple perspective focus based on the nature of the extrinsic and intrinsic characteristics, it is still possible to change the assessment model to focus on specific characteristics by having different scoring models for different perspectives. For instance, to remove the effects on a characteristics on the score it is only necessary to reduce its questions importance factor to 0. Following the process flow of 1300, a total perspective can be obtained across all characteristics. Alternatively, different perspectives can only consider one or more characteristics, decision gates, or phases.

At operation 1304, the possible range of score values is first decided for each question (e.g., −5 to 0, 0 to +5 or −5 to +5). Then an answer is selected for the Min value of the range and another answer is selected for the max value of the range. Other answers are assigned values between these Min and Max values of the range. The response answer can also include a rationale provided by the respondent to support the answer, and the response can also include evidence provided by the respondent to support the answer and/or the rationale. The existence of a rationale and/or evidence response to a question for an answer is accounted for in the scoring model by assigning an adjustment factor for each to the initial values already assigned for each case. Lack of rationale or evidence will assign a negative adjustment to lower the initial assignments defined here.

At operation 1306, an importance factor is assigned to each question in the context of the assessment perspective. As stated previously, if the characteristic or question is not in the perspective of this scoring model but exists in the assessment model, an importance factor of 0 can be assigned to the question. The question's scores than will have no impact on the assessment score. Care must be taken to consider the relative importance for each major characteristic category and for each decision phase or stage gate. If a question is unique to a stage gate, then its importance could be relative to other questions in that phase. Another approach considers importance from an overall assessment perspective and assigns importance to questions regardless of the phase or stage gate, but rather to an overall decision using information from all phases or where questions are repeated at later phases where new information is obtained. The ability to have multiple scoring models is apparent to enable this kind of flexibility of focus on scoring scope and perspective.

The scoring module 200 (see FIG. 2) can include an importance module 204 (see FIG. 2) that can determine an importance factor, and the importance factor can be dependent upon the importance of certain questions and/or responses. This importance factor can, for example, be an integer weighed from 1 to 10. Increasing the importance factor of one response will effectively reduce the importance factor of another response.

At operation 1308, a base score for the assessment scoring model is calculated. The scoring module 404 (see FIG. 4) can be configured to provide various scoring models based on the answers, evidence, and rationales defined for different perspectives of the assessment model according to the perspective of each stakeholder. The initial base score is calculated in one embodiment by first aggregating the positive scores and the negative scores to find the MinBaseRange Value and the MaxBaseRangeValue of the assessment model across all questions having an importance value greater than 0. Then, for each question's answer, a new score value is calculated by calculating the weighted score value for each default answer by the modification of the importance value. Two other score values can also be assigned to this by modifying these by two other factors: nonexistence of rationale and nonexistence of evidence. New weighted score values are calculated by adjusting the importance score weighted scores for answers to create two additional scores as defined here. If either the rationale or evidence is presented in the response, then the initial weighted importance score value is used of an answer. If one or the other occurs, then the adjusted weighted score value is used for that answer.

At operation 1310, an uncertainty factor is assigned to each question. Initially in one embodiment the questions are categorized as two types: (i) factual and (ii) estimation or judgmental. The former uncertainty factor is such that no changes are made to the score values of the answers for the weighted scores in operation 1308. But if the question is estimation or judgmental one approach considers that the question's impact should lessen due to its uncertainty by some adjustment factor. In this case, all the answers to that question would be adjusted by the same factor. Typically an uncertainty factor for factual question would be “1”, and for an estimation or judgement question the uncertainty factor could be a value between 0.5 and 0.9. This later case has the effect of lowering the impact on the score of estimation or judgmental questions. The determination can be weaker where there is inherent uncertainty regarding some aspects of the assessment, and the use of the certainty factor can be beneficial to account for this. Where limited information is available regarding a certain question, an uncertainty factor can be reduced to effectively adjust the score downwardly for the given question. In some embodiments, where the information available for a certain characteristic of an assessment object is high, the uncertainty factor can actually be increased so that the score is improved due to the increased certainty. In some embodiments, the limited information can be based on the lack of supporting evidence and/or supporting rationales.

In operation 1312, an adjusted weighted score for all question's answers is calculated, and the Max and Min aggregate range values for all positive and negative questions are validated to ensure that they are the same as those calculated in operation 1308. An adjusted weighted score can be calculated using the base scores of operation 1308 and by considering the uncertainty factor values assigned in operation 1310. All the answers to a question can be adjusted by the same uncertainty factor as calculated in operation 1308. Then the weighted impact of each question's answers to the score can be calculated to create a new set of adjusted weighted scores considering the uncertainty factor.

In operation 1314, assign trustworthiness values to the questions based for each type of responder. The assignment of specific trustworthiness values can be done in the assessment model.

In operation 1316, adjusted weighted scores for each question's answers are calculated, and the Max and Min aggregate range values for all positive and negative questions are validated to ensure that they are the same as those calculated in operation 1308. The adjusted weighted scores can be obtained by using the adjusted weighted scores of 1312 and the responder type trustworthy factor.

In operation 1318, the decision classifications are reviewed and the aggregate assessment ranges for each classification can be assigned. At operation 1318, all the score assignments can be reviewed. Furthermore, at operation 1318, these values for the scoring model can be asserted in the assessment analysis ontology of the assessment analysis module 110 stored in the innovation assessment knowledge system 106.

As used herein, “generative artificial intelligence” (i.e., generative AI or GenAI) means artificial intelligence or machine learning that can be used to generate new material, and this new material can optionally be in the form of text, video, images, audio, etc. As used herein, a “participant” is the person or group of people that are participating in a session. As used herein, a “client” is the company (if any) that the participant is associated with, and the client and the participant can be the same where the participant runs a sole proprietorship or where the participant is not associated with any company.

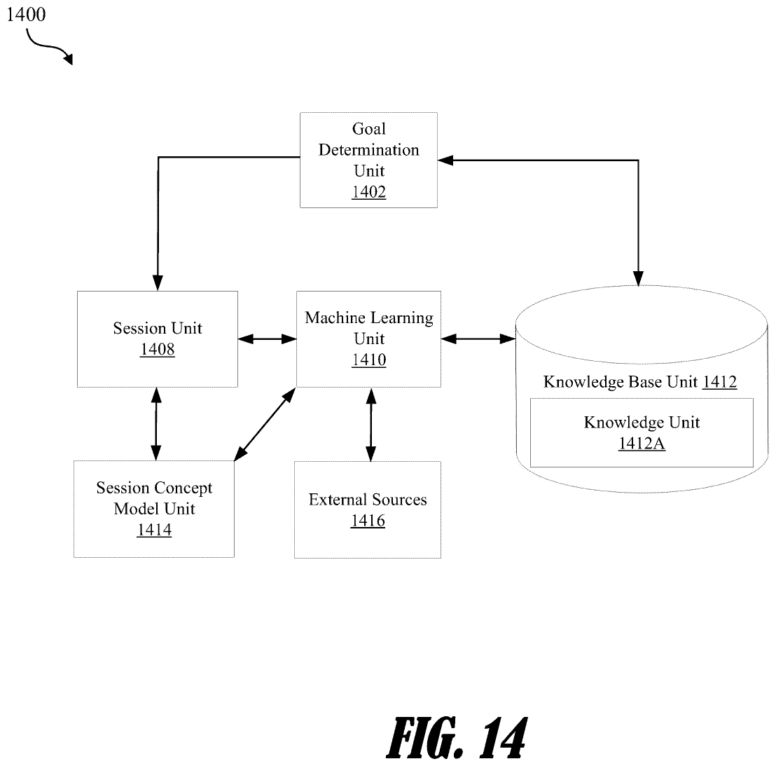

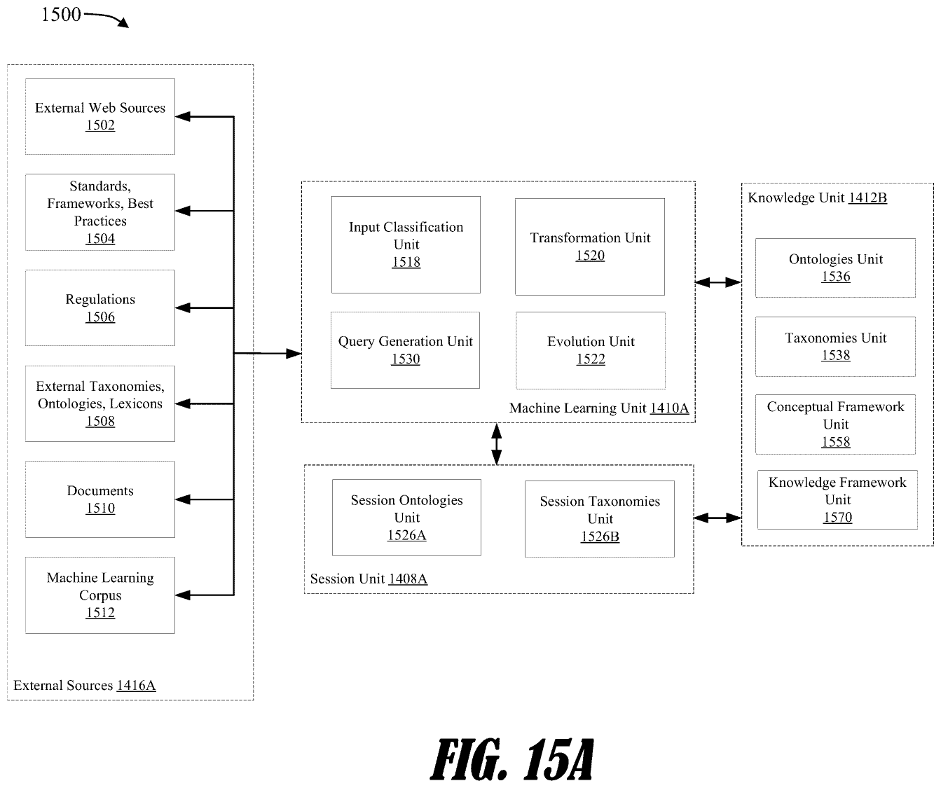

FIG. 14 is a block diagram illustrating a common session knowledge architecture for a system 1400. A machine learning unit 1410 can be incorporated into the system to provide various benefits. The machine learning unit 1410 and any other machine learning units described herein can utilize GenAI techniques, machine learning, artificial intelligence, or other similar techniques. The machine learning unit 1410 can possess a large corpus of knowledge to allow discovery about some aspects of a topic, and the machine learning unit 1410 can also create a taxonomy and/or an ontology from this knowledge and store the taxonomy and/or the ontology in the knowledge unit 1412A. Stored taxonomies and/or ontologies can be used during sessions to provide designed prompts to solicit information from participants. Stored taxonomies and/or ontologies can also be used to align responses from participants with the most closely related taxonomy. Taxonomies can include information on one or more topic(s), aspect(s), and prompt(s).

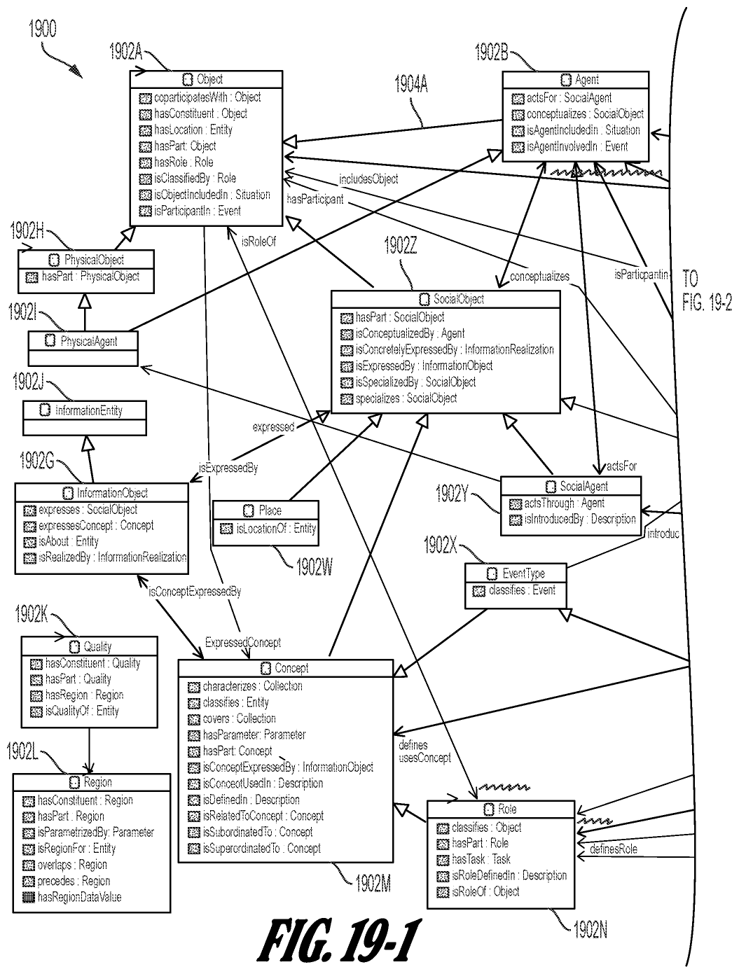

The machine learning unit 1410 can assist in the creation of session prompt-response patterns similar to those illustrated in the hierarchy 1600 of prompt-response patterns of FIG. 16. The machine learning unit 1410 can also assist in creating taxonomies, ontologies, and other material in knowledge frameworks included in a knowledge framework unit such as the knowledge unit 1412A or the knowledge framework unit 1804 of FIG. 18. The machine learning unit 1410 can be used for the purpose of guiding the acquisition and interpretation of information through use of a priori defined session ontology models. The a priori defined session ontology models can optionally focus on a particular theme, topic, context, etc. However, these ontology models can be generalized ontology models in some embodiments that do not focus on a particular theme, topic, or context. The machine learning unit 1410 can also assist in developing a knowledge base that represents the prompt-response pattern for a session, and the machine learning unit 1410 can also assist in developing logic for dynamically guiding a session based on responses so that sessions can be focused on more relevant areas. The machine learning unit 1410 can be used to discover relevant statements within participant responses, and the machine learning unit 1410 can assist with semantic alignment of material obtained from participant responses (e.g., the relevant statements) within internal standardized statement datasets. The machine learning unit 1410 can also provide updates to internal statement datasets represented by statement ontologies to cause the ontologies to evolve over time.

The system 1400 can enable a session facilitator to utilize an a priori session prompt-response pattern in a dynamic fashion in an actual session with a participant for the purpose of acquiring information from a participant. The information acquired from the client can provide the client's perspective about some aspect of a particular focus topic. In one example, the focus topic could be “innovation,” but other focus topics can be used. The client's perspective can be provided within one or more contexts. Additionally, in one example, the aspect can be an “aspirational statement for innovation,” and the context can be a particular industry of a session client. However, another aspect or context can be used in other embodiments.

Existing topic taxonomies can be acquired from various sources such as a machine learning unit, and topic taxonomies can be received from other external sources. The topic taxonomies can be relevant to the focus topic(s), the context(s), and perspective aspects(s) that are correlated with each instance of a session prompt-response interaction. A session response can be analyzed in this overall framework such that guidance is provided by the system about the next prompt-response interactions.

Components of the system 1400 of FIG. 14 can provide a session conceptual model and knowledge framework consisting of ontologies, knowledge base datasets, and the processes of a session with a client or another participant. One goal of the system 1400 is to gather perspectives from the client or participant, and the system 1400 can be designed to focus on a specific focus theme. The system 1400 has a goal determination unit 1402 that defines an agenda. The agenda can be defined prior to the active session. In an exemplary embodiment, the agenda can optionally be to solicit aspirational statements from the client or an individual participant associated with the client about their perspective of innovation, and this perspective can be provided in a particular context. The system 1400 defines a session structure to satisfy the agenda.

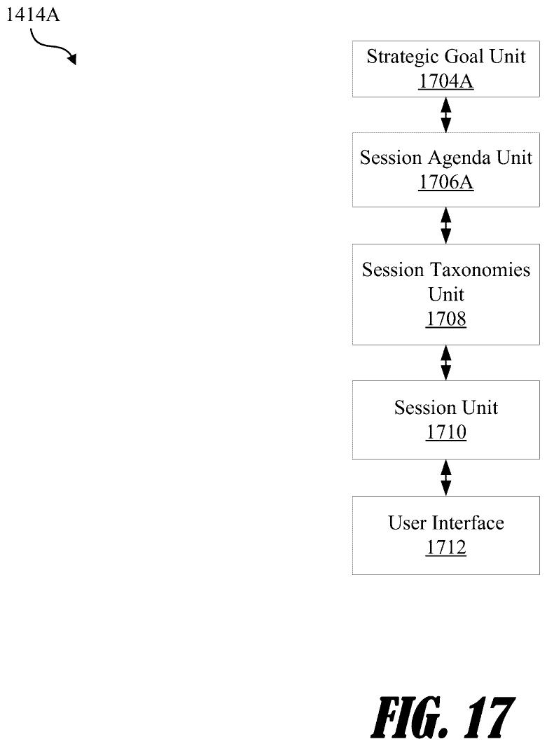

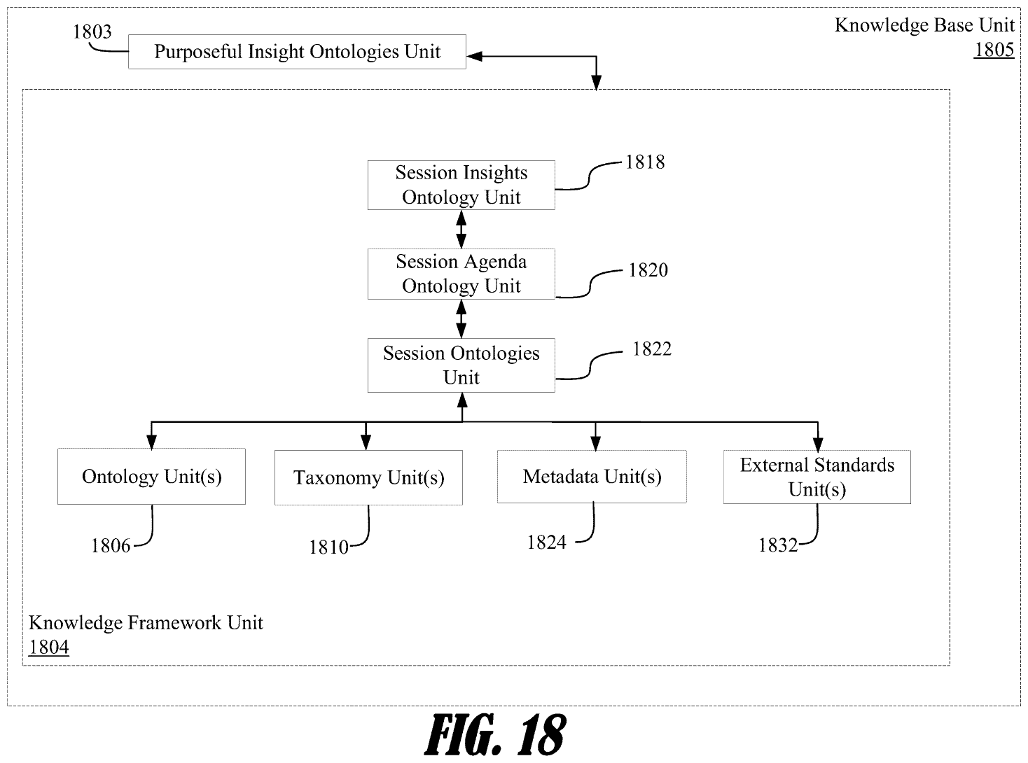

The system 1400 defines the session information gathering processes, and this can optionally be defined in session concept models at the session concept model unit 1414 of FIG. 14. Example session concept models 1414A are illustrated in FIG. 17 and are described further herein. The session concept models 1414A can be used at the session concept model unit 1414 of FIG. 14.

The system 1400 also defines roles of the client and a session facilitator for a defined agenda, which can be defined by the goal determination unit 1402. The system 1400 can also provide a set of focus topic questions or defined interactions between the session organizer and the client as a set of questions and responses. The defined agenda can also be used to gain insights and to acquire knowledge from the sessions and from other external sources.

A session unit 1408 is provided in the system 1400. The session unit 1408 provides prompts to the client and receives responses from the client that will ultimately provide session data. This session data can be used to populate the knowledge base unit 1412 to generate various ontologies, taxonomies, etc. Session data can also cause content within the knowledge base unit 1412 such as ontologies and/or taxonomies to evolve so that they become more refined as further session data is obtained. This refinement can occur within the context of a single session as additional contextual information is obtained from the client, and this refinement can also occur on a larger scale as content is obtained from a plurality of sessions. The session unit 1408 can dynamically provide prompts to the participant to elicit responses from the participant, and the machine learning unit 1410 can assist with interpreting the responses of the participant to dynamically provide further prompts that are relevant.

The session unit 1408 can have a focus topic to guide the session. For example, the focus topic can be innovation, and responses from participants can be analyzed to identify statements relevant to innovation. This can be done without context in some embodiments, but this can be done with context for the industry of the client, the functional role of the participant, demographics, and other factors. In some embodiments, the focus topic can be obtained from the goal determination unit 1402.

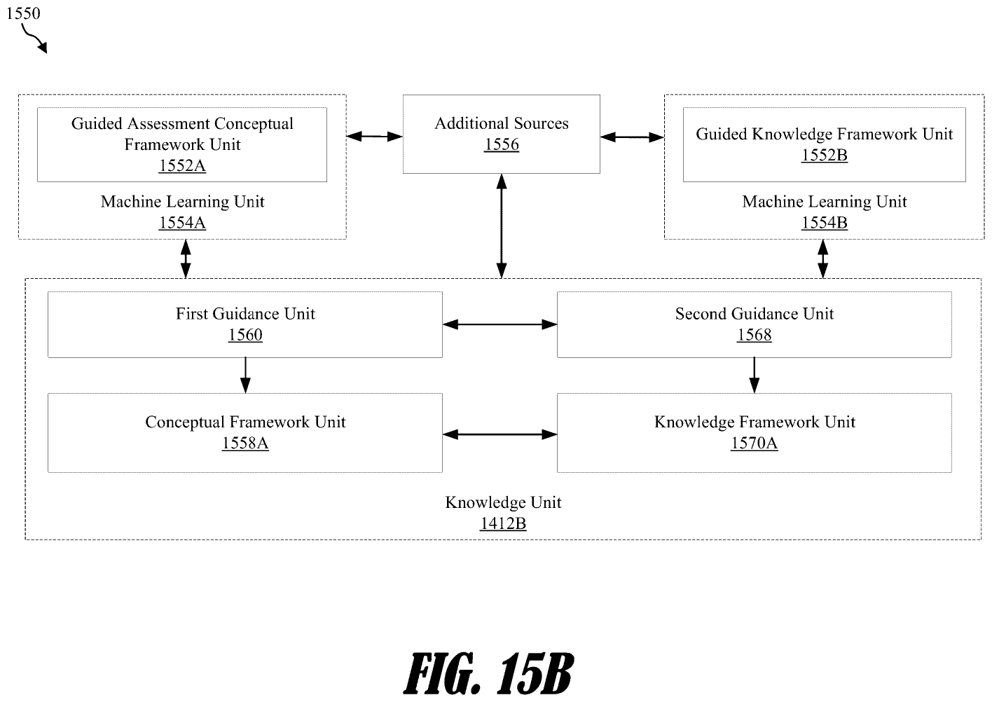

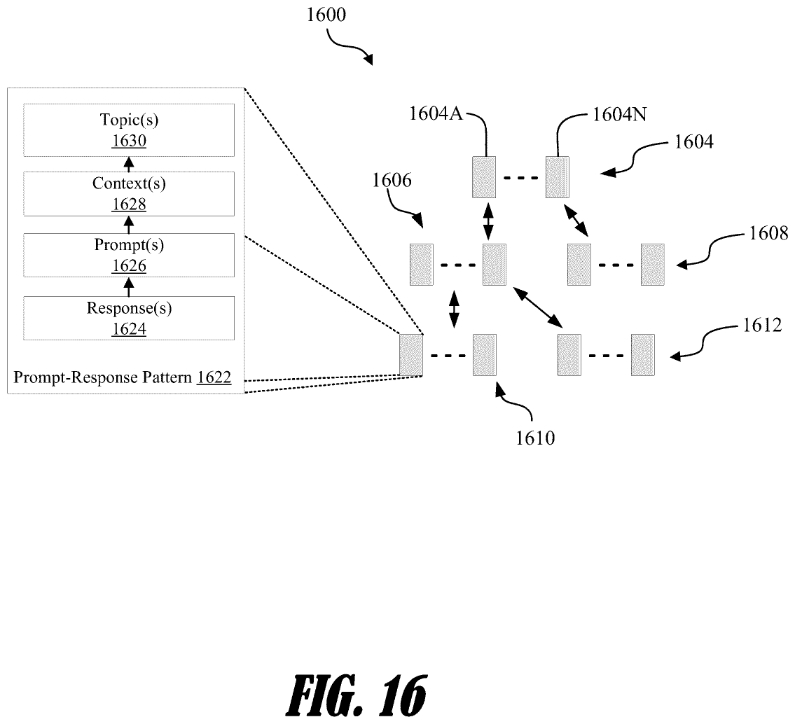

The machine learning unit 1410 can also be configured to retrieve material from various external sources 1416. As illustrated in FIG. 15A, external sources 1416A can include external web sources 1502, standards, frameworks, and best practices 1504, regulations 1506, external taxonomies, ontologies, and lexicons 1508, documents 1510, and other machine learning corpus 1512. However, the machine learning unit 1410 can be configured to receive material from other sources. The machine learning unit 1410 can identify various aspirational statement keywords or statement phrases from the external sources 1416, and the machine learning unit 1410 can populate ontologies, taxonomies, models, etc. within the knowledge base unit 1412 using the identified aspirational statement keywords or statement phrases from the external sources 1416. In some embodiments, the machine learning unit 1410 can be used to discover statements related to a focus area (e.g., innovation) at a generic level without any context, but the machine learning unit 1410 can also be used to discover statements related to a focus area for a particular context (e.g., industry, functional role for participant, location of client, etc.). The statements supplied to the knowledge base unit 1412 by the machine learning unit 1410 can eventually be supplemented from additional statements retrieved from sessions to develop robust models, ontologies, and taxonomies in the knowledge unit 1412A of the knowledge base unit 1412.

The knowledge base unit 1412 can include a knowledge unit 1412A. The knowledge unit 1412A can contain various ontologies that can be used to represent session structures, topic taxonomies, and specific session instance results. The knowledge unit 1412A can also contain ontologies for other uses such as insight ontologies to provide insights for a specific use case that can be inferred from the sessions. The knowledge unit 1412A can also contain other topic taxonomies. In some embodiments, the knowledge unit 1412A can optionally be the sole location where ontologies are stored in the system 1400, but this is not the case in other embodiments.

The system 1400 guides the session information session through a session guidance structure. This session guidance structure can be represented as an ontology instance for a session ontology. The system 1400 also has the capability to interpret responses from a session. The system 1400 can also optionally have the capability to provide guidance for the remaining session interactions dynamically to gain more detail on the areas that are the most relevant to the participating organization. For example, as responses are received in a session indicating that a particular issue is particularly relevant to a participating organization, the system 1400 can be configured to cause further inquiries into that issue or other related issues to gain details that are relevant to the participating organization.

The system 1400 can be capable of providing a somewhat semi-automated design. The system 1400 can provide the meta-level of concepts, relationships, definitions, and an overall ontology model to represent a domain focus of a topic taxonomy. These can be created via interactive conversation prompt-response patterns with a machine learning unit 1410 focused on a topic, a context, and an aspect of the topic in context. The response to the conversation prompts with machine learning unit 1410 can be used to populate a seed topic taxonomy instance in the knowledge unit 1412A, and this can be done for each topic of interest.

A somewhat complementary capability that can optionally be provided by the system is to evolve and extend into new topic taxonomies based on interactions of the machine learning unit 1410, and these interactions can be about the most relevant topic taxonomy and the need for an extension based on the responses for a particular session for a specific instance in the session guidance structure. For example, the machine learning unit 1410 can recommend extending a specific taxonomy with another node at some level for a new prompt-response pattern.

The system 1400 can have multiple ontologies and taxonomies at various locations within the architecture to represent session knowledge, the focus of the session, participant responses to prompts, focus topics, and importance of focus topics to a client.

FIG. 15A is a block diagram illustrating a system 1500 having a similar common session knowledge architecture to the system of FIG. 14, but the block diagram of FIG. 15A has greater detail regarding specific units and sources within the system 1500. Also, the connections between the different units are different in the system 1400 of FIG. 14 and the system 1500 of FIG. 15A. However, it is to be understood that the connections between units can be altered in other embodiments.

The system 1500 includes a machine learning unit 1410A, a knowledge unit 1412B, and a session unit 1408A. The conceptual model provides unique and complementary roles for the machine learning unit 1410A, the knowledge unit 1412B, and the session unit 1408A. When these units are combined in accordance with the conceptual model to form the system 1500, the system 1500 is capable of dynamically adapting sessions conducted at the session unit 1408a to participant responses. Additionally, the system 1500 can be capable of evolving topic knowledge represented in taxonomies, and the system 1500 is capable of evolving session guidance based on interpretation of session responses.

A machine learning unit 1410A is provided in FIG. 15A. This machine learning unit 1410A is the same as the machine learning unit 1410 illustrated in FIG. 14, and the machine learning unit 1410A is simply provided in greater detail in FIG. 15A. The machine learning unit 1410A can facilitate knowledge discovery at many different levels of detail and in different kinds of contexts. The machine learning unit 1410A can help facilitate identification and definition of concepts present in the discovered knowledge, and the machine learning unit 1410A can assist in the creation of ontologies with these concepts. The machine learning unit 1410A can aid in discovery of concept instances from various sources such as text documents. The machine learning unit 1410A can assist in the classification of text from various sources to a relevant taxonomy and/or ontology concept. The machine learning unit 1410A can aid in the extraction of facts and/or text from sources to a taxonomy or ontology in the knowledge unit 1412B. Additionally, the machine learning unit 1410A can help evolve the ontologies and taxonomies within the knowledge unit 1412B as appropriate for new information not directly semantically aligned with the existing knowledge framework taxonomies and ontologies.

The machine learning unit 1410A comprises various units therein. For example, the machine learning unit 1410A comprises an input classification unit 1518, a transformation unit 1520, an evolution unit 1522, and a query generation unit 1530. The input classification unit 1518 receives inputs from various external sources 1416A. In FIG. 15A, these external sources 1416A include external web sources 1502; standards, frameworks, and best practices 1504; regulations 1506; external taxonomies, ontologies, and lexicons 1508; documents 1510; and other machine learning corpus 1512. The input classification unit 1518 can be configured to classify the inputs received from the sources and provides the classified input data to the transformation unit 1520. The input classification unit 1518 is also configured to receive responses from the session unit 1408A. The input classification unit 1518 is configured to classify the input received from the session unit 1408A and to provide the classified input data to the transformation unit 1520. The input classification unit 1518 can interpret responses received from the session unit 1408A and can classify responses according to the representative taxonomy which is related to the particular prompt-response pattern. The input classification unit 1518 can work to classify responses based on the iterative and incremental interactions during a session and can consider several responses made during a session in conjunction to make determinations regarding classifications for responses based on patterns in responses.

The transformation unit 1520 can be configured to transform the classified input data into an appropriate format for use in the knowledge unit 1412B. The transformation unit 1520 can also be configured to determine where to place classified input data into the knowledge unit 1412B. The transformation unit 1520 can be configured to provide this transformed data to the knowledge unit 1412B. The transformation unit 1520 can optionally transform classified input data so that it semantically aligns with the language of a taxonomy or ontology in the knowledge unit 1412B. For example, the transformation unit 1520 can transform the classified input data so that it aligns with an OWL language so that it can be used in a particular ontology instance. In some embodiments, the input classification unit 1518 and/or the transformation unit 1520 can optionally filter data from the external sources 1416A so that only a subset of the available data that is relevant is provided to the knowledge unit 1412B. In some embodiments, the transformation unit 1520 or another part of the machine learning unit 1410A can be used to identify hypernyms, hyponyms, synonyms, and closely related statements for aspirational statements that are identified and this information can be added into the knowledge unit 1412B.

The transformation unit 1520 can also be capable of determining if a topic taxonomy instance is applicable the actual participant response. If the actual participant response does semantically align with the topic taxonomy instance, then another property can be asserted about the success of the alignment to the anticipated response. In some embodiments, the actual response can optionally be added as another phrase for responses for this topic taxonomy for its directly related prompt-response pattern. If the response is not covered in meaning by the current topic taxonomy instance, the machine learning unit 1410A and/or the transformation unit 1520 can optionally search for other topic taxonomies to discover a better match in meaning and to find another series of prompt-response patterns that are more appropriate. If another prompt-response pattern is more appropriate, then the machine learning unit 1410A and/or the transformation unit 1520 can provide this recommendation for classifying the response as off-topic for the current series of prompt-response patterns in the taxonomy. Additionally, if another prompt-response pattern is more appropriate, then the machine learning unit 1410A and/or the transformation unit 1520 can classify the response as on-topic at another series of prompt-response patterns in the taxonomy.

The machine learning unit 1410A also includes a query generation unit 1530. The query generation unit 1530 can be configured to receive natural language queries. These natural language queries can optionally be from a client or an individual participant associated with a client, but these natural language queries can be received from other sources. Based on the received natural language queries, the query generation unit 1530 can be configured to create a standard language inquiry. For example, the standard language inquiry can optionally be a SPARQL query. The standard language inquiries that are generated by the query generation unit 1530 can be directed to the knowledge unit 1412B to retrieve information from the knowledge unit 1412B. Various types of queries can be generated that are directed to the knowledge unit 1412B. For example, queries can be generated about the knowledge or data contained in the knowledge unit 1412B, about the session design, about session participant responses and taxonomy classification, about focus topic-aspect session insights, or about anything created or stored in the knowledge unit 1412B. In some embodiments, the query generation unit 1530 can be configured to create standard language inquiries based on the iterative and incremental interactions with the participant during a session.

As responses are received at the session unit 1408A, the responses can be processed and maintained in the knowledge unit 1412B. The responses can be maintained as a fact for the specific prompt-response pattern in the session structure ontology. The prompt-response pattern can have a direct relationship to a specific topic taxonomy and to a specific instance within its hierarchy.

An evolution unit 1522 can also be provided in the machine learning unit 1410A. The evolution unit 1522 can provide prompts for a particular focus topic and/or for some aspect of the focus topic. The evolution unit 1522 can be used to create various seed focus taxonomies for use in the knowledge framework, and the seed focus taxonomies can be refined based on one or more relevant focus topics, one or more relevant aspects of a focus topic, and one or more relevant contexts. The prompts generated by the evolution unit 1522 can optionally be associated with a specific context. The evolution unit 1522 can use the prompts that are generated to acquire information of interest from the external sources 1416A. The evolution unit 1522 can share information acquired from the external sources 1416A to update the knowledge unit 1412B. The information can be used to discover, create, or evolve taxonomies and/or ontologies within the ontologies unit 1536 and/or the taxonomies unit 1538. Information obtained in the knowledge unit 1412B can be used to create a taxonomy for a prompt-response pattern. Designs of prompts generated by the evolution unit 1522 can be easily modified by a change in terms for the topic and/or a change in the context to generate a different taxonomy for another prompt-response pattern. The evolution unit 1522 can work to update the knowledge framework in the knowledge unit 1412B based on the iterative and incremental interactions during a session and can consider several client responses in conjunction to make determinations as to how the knowledge framework should be updated.

The session unit 1408A is used to conduct sessions with a client (such as a company), an individual participant associated with the client (e.g., an employee at a client company), OR some other participant. Various prompts can be provided by the session unit 1408A, and various responses can be received to the prompts as well at the session unit 1408A. Data from the session unit 1408A can be provided to the machine learning unit 1410A. Data from the session unit 1408A can be related to a specific session ontology received from the ontologies unit 1536 of the knowledge unit 1412B. Data from the session unit 1408A can also be related to a prompt instance of a prompt-response pattern defined in one of the taxonomies received from the taxonomies unit 1538 of the knowledge unit 1412B. The machine learning unit 1410A can receive data from the session unit 1408A and transform this data for use in the knowledge unit 1412B. The machine learning unit 1410A can align a session participant response to the prompt-response pattern instance defined in a taxonomy and referenced by an instance of a specific session ontology instance defining the structure of the session prompt-response patterns for a particular topic, context, aspect, etc.

The session unit 1408A can optionally include a session ontologies unit 1526A and a session taxonomies unit 1526B. These session ontologies unit 1526A and the session taxonomies unit 1526B can help guide the interactive sequence of sessions. The session ontologies unit 1526A and the session taxonomies unit 1526B can contain a specific session knowledge structure taxonomy, a specific session knowledge structure ontology, other taxonomies, or other ontologies that guide the interactive sequence. In some embodiments, the session ontologies unit 1526A and the session taxonomies unit 1526B are not provided in the session unit 1408A, and the specific session knowledge structure taxonomy, a specific session knowledge structure ontology, or other taxonomies or ontologies can be obtained from the knowledge unit 1412B to guide the interactive sequence of sessions. The interactive sequence of sessions can also be guided by an analysis of the response in a specific context within the specific session knowledge structure taxonomy or ontology, or the interactive sequence can be guided with the assistance of another ontology or another taxonomy. The guidance provided by the ontologies and taxonomies of the session ontologies unit 1526A and the session taxonomies unit 1526B can assist in determining the next series of prompt-responses patterns to be explored and in determining the next specific prompt-response pattern within a series of prompt-response patterns to be explored.

In the knowledge unit 1412B, various units can be provided. These units can include an ontologies unit 1536 and a taxonomies unit 1538, but other units can optionally be provided as well. The ontologies unit 1536 can be configured to include insight ontologies that provide insights for a specific use case that can be inferred from the sessions, but the ontologies unit 1536 can be configured to include other ontologies. Some ontologies in the ontologies unit 1536 can be used to represent session structures, topic taxonomies, and specific session instance results. The taxonomies unit 1538 can be configured to include various taxonomies.

All ontologies of the ontologies unit 1536 can represent the design structure of any session to include the hierarchical tree-like structure of a set of prompt/response patterns. Each session instance can be directly related to a hierarchical instance within a topic taxonomy structure, which represents a particular focus concept.

In some embodiments, the ontologies of the ontologies unit 1536 can include a specific session ontology. The session ontology can additionally or alternatively be provided in the session ontologies unit 1526A if one is provided in the session unit 1408A. The session ontology can define various concepts into classes. The session ontology can also define relationships between the classes to represent all necessary information about a session, its agenda, designed session prompt-response pattern, session participants, the goal of the session, and all related topic taxonomies. The session ontology can also represent specific participant responses to the specific session prompt-response pattern defined in an instance of the session structure ontology.

The ontologies unit 1536 can also provide insights about responses in a session. For example, these insights could possibly be about common areas of response and context, areas of risk, and divergence of interests in certain areas. Insights could also include other logical or quantitative statistical insights that can be gained from reasoning about any session set of responses. In some embodiments, ontologies can reason about the evolving taxonomies and insights for topics with and without context, such as commonly identified areas across industries or unique areas in an industry.

The taxonomies unit 1538 can include topic taxonomies that represent a particular aspect of a focus topic. The topic taxonomies can be provided with no context, with one context in mind, or with multiple contexts in mind for a particular aspect of the focus topic. Topic taxonomies can also represent the associated prompt that was used by the machine learning unit 1410A to discover a set of possible responses. Over time, the set of possible responses for each prompt can evolve as new information is discovered by sessions and by new added external sources relevant to that topic and context.

A client or a participant can potentially provide a response that is not semantically aligned with the current set of possible meanings defined in a relevant taxonomy. For example, the taxonomy can be highly developed with respect to certain topics, but the client or individual participant can be asking about other topics for which the taxonomy is less developed. In such a scenario, the machine learning unit 1410A can be deployed to determine other areas in the taxonomy that are semantically related. Additionally or alternatively, the machine learning unit 1410A can decide to add another type of response as a variation for the prompt-response pattern, and this can essentially extend the current taxonomy based on session responses. Additionally or alternatively, the machine learning unit 1410A can recommend from the set of topic taxonomies where the response best fits, and this information can be provided to a session facilitator in some embodiments. Where a response is not semantically aligned with the current set of possible meanings defined in the relevant taxonomy, the machine learning unit 1410A can take this into account and can use the response to identify another prompt-response pattern in the current session structure that better aligns with the actual participant interest expressed by their response.

One goal of a session is to acquire information about focus topic(s) from a perspective of participants. Therefore, prompt-response patterns can be designed to provide prompts that solicit a response from the participant, with this response including the participant's aspirations, judgements, beliefs, or statements about some aspect of the focus topic(s).

In some embodiments, the knowledge unit 1412B can also include a conceptual framework unit 1558 and a knowledge framework unit 1570. Another example conceptual framework unit 1558A and another example knowledge framework unit 1570A are described in greater detail in reference to FIG. 15B. In some embodiments, the conceptual framework unit 1558 and the knowledge framework unit 1570 can be separate units from the ontologies unit 1536 and the taxonomies unit 1538. However, in other embodiments, the ontologies unit 1536 and the taxonomies unit 1538 can optionally be omitted or these units 1536, 1538 can be included as part of the conceptual framework unit 1558 and/or the knowledge framework unit 1570.

FIG. 15B illustrates a knowledge system 1550 that is supported by machine learning techniques such as GenAI. The knowledge system 1550 includes a first machine learning unit 1554A, a second machine learning unit 1554B, and a knowledge unit 1412B. In some embodiments, each of these machine learning units 1554A, 1554B, and the knowledge unit 1412B can be guided by human stakeholders based on the stakeholders' goals, aspirations, and ideas. Additionally, ideas can be integrated into prompt engineering for GenAI as an example of how context on the GenAI guided assessment conceptual framework can be guided. This integration can be supported by an evolving library that is contained within the computer knowledge framework of the knowledge unit 1412B, and the evolving library can be fed back into the machine learning units 1554A, 1554B for context definitions.

The first machine learning unit 1554A can help support the creation of a conceptual model in the conceptual framework unit 1558A of the knowledge unit 1412B so that the conceptual model is formed with an appropriate level of context, and the first machine learning unit 1554A can assist in the creation and alignment of components within the conceptual model.

The first machine learning unit 1554A and the second machine learning unit 1554B can support the evolution of conceptual models at the conceptual framework unit 1558A and the computer knowledge framework at the knowledge framework unit 1570A of the knowledge unit 1412B. While two machine learning units are included in the system 1550, only one machine learning unit can be included in another system. Alternatively, additional machine learning units can be included.

The conceptual framework unit 1558A and the knowledge framework unit 1570A can provide feedback to each other over time, with information at the knowledge framework unit 1570A providing guidance to the evolution of the conceptual models of the conceptual framework unit 1558A and with information at the conceptual framework unit 1558A providing guidance to the evolution of the computer knowledge framework(s) at the knowledge framework unit 1570A. This feedback between the conceptual framework unit 1558A and the knowledge framework unit 1570A can enable a real time evolution of the knowledge system 1550. Additionally, the second machine learning unit 1554B can be used to suggest guidance inferences that can be axiomatized in ontology axioms for inference within the knowledge framework unit 1570A. Furthermore, knowledge framework ontologies within the knowledge framework unit 1570A can be analyzed by the second machine learning unit 1554B to formalize the common vocabularies as well as taxonomies that can be developed.

The first machine learning unit 1554A includes a guided assessment conceptual framework unit 1552A. The guided assessment conceptual framework unit 1552A can provide a guided assessment conceptual framework that is customizable by focus area and context views or perspectives, by clients and/or stakeholders, by assessment categories, by guidance transformation actions, by industry and/or function, by the relevant domain for an assessment, by standards and/or frameworks, and/or by data interpretation (e.g., internal data interpretation and/or external data interpretation). The guided assessment conceptual framework may be used as a resource at the conceptual framework unit 1558A.

The knowledge system 1550 also includes a second machine learning unit 1554B, and this second machine learning unit 1554B includes a guided knowledge framework unit 1552B. The second machine learning unit 1554B can help support the creation of the computer knowledge framework in the knowledge unit 1412B and can assist in the creation and alignment of components within the computer knowledge framework. The guided knowledge framework unit 1552B can execute various tasks. For example, the guided knowledge framework unit 1552B can represent extensible and aligned concepts, entities, frameworks, assessments, sessions, surveys, and guidance. The guided knowledge framework unit 1552B can provide a hierarchical ontology knowledge framework, and this hierarchical ontology knowledge framework can be provided in a transparent, explainable, and customizable manner. The guided knowledge framework unit 1552B can provide a complete GenAI assessment and guidance meta framework conceptual model and populated data definitions. The guided knowledge framework unit 1552B can provide an extensible and customizable framework via alignment and definitions of categories, capabilities, levels, and guidance actions. The guided knowledge framework unit 1552B can store default GenAI foundational and multiple customized frameworks for reuse. The guided knowledge framework unit 1552B can be extensible with other ontologies, taxonomies, and standards frameworks. Additionally, the guided knowledge framework unit 1552B can be created using GenAI, which can accelerate customization with large language models and with external data (e.g., standards, frameworks, research, vendors, etc.).

The knowledge system 1550 includes a knowledge unit 1412B, and the knowledge system 1550 includes a conceptual framework unit 1558A at the knowledge unit 1412B. The conceptual framework unit 1558A can be configured to provide a conceptual model that is readily understandable by a human. The conceptual model can include narrative descriptions, explanations, conversations, conceptual diagrams, definitions, standards, best practices, and papers, but other materials can be included in the conceptual model as well. The conceptual framework unit 1558A can be configured to customize the conceptual model from one or more focus perspectives that are accelerated in speed, completion, and context using GenAI capabilities. The conceptual framework unit 1558A can work in conjunction with a first guidance unit 1560. The first guidance unit 1560 can be configured to receive material from the machine learning unit 1554A, from the additional sources 1556 or from the second guidance unit 1568 associated with the knowledge framework unit 1570A. The material received at the first guidance unit 1560 can be used in the conceptual framework unit 1558A to assist in developing the conceptual model. The conceptual framework unit 1558A can include a foundational framework and can be customized for the purposes of a particular assessment.

The knowledge unit 1412B can be semantically aligned with the conceptual model generated by the conceptual framework unit 1558A, and this semantic alignment can be accomplished with machine learning techniques such as GenAI. The knowledge framework ontology and knowledge graph components can be created using machine learning techniques such as GenAI, and alignment of the computer knowledge frameworks formed in the knowledge unit 1412B with conceptual models of the conceptual framework unit 1558A can be accomplished through the use of machine learning techniques such as GenAI. The knowledge unit 1412B includes a second guidance unit 1568 and a knowledge framework unit 1570A. The second guidance unit 1568 can be configured to receive material from the machine learning unit 1554B, from the additional sources 1556 or from the first guidance unit 1560 associated with the conceptual framework unit 1558. The material received at the second guidance unit 1568 can be used in the conceptual framework unit 1558 to assist in developing the conceptual model. The knowledge framework unit 1570A can include a foundational framework and can be customized for the purposes of a particular assessment.

In some embodiments, the knowledge framework unit 1570A can assist in the creation and enhancement of a computer explicit knowledge representation. This computer explicit knowledge representation can include ontologies, knowledge graphs, taxonomies, vocabularies, inference conditions of satisfaction, etc., but the computer explicit knowledge representation can include other materials as well.

The knowledge system 1550 can be configured so that the definition and uses of multiple context profiles can be used and combined in the use of machine learning techniques such as GenAI, and these definitions and uses can be stored in the knowledge unit 1412B or the knowledge framework unit 1570. The machine learning units 1554A, 1554B can be used to discover common context interests and views from already defined frameworks (e.g., the Department of Defense Architecture Framework (“DoDAF”)) and from other sources.

The first guidance unit 1560 and the second guidance unit 1568 can both receive data from additional sources 1556. The additional sources 1556 can include internal sources from within the knowledge system 1550, but the additional sources 1556 can also include external sources from outside of the knowledge system 1550. The additional sources 1556 can include data regarding a domain focus, a stakeholder focus, an assessment focus, an opportunity focus, a challenge focus, a capability maturity focus, a session focus, a survey focus, a guidance and insights focus, an internal data interpretation focus, an external data interpretation focus, a business use case focus, and a foundational model focus for GenAI. The material provided by the additional sources 1556 can assist in guiding the machine learning units 1554A, 1554B, the conceptual framework unit 1558A, and the knowledge framework unit 1570A during formation of models and frameworks to help discover and align knowledge concepts.

The system 1550 and other systems, devices, etc. described herein can be configured to consider various factors in creating and enhancing knowledge frameworks. For example, the systems can consider the identity of stakeholders, the stakeholder objectives, and the framework use objectives with respect to stakeholder objectives. The systems can formulate an approach to apply the framework components to achieve the framework use objectives and the stakeholder objectives. Systems may also consider the possible stakeholder guidance actions that can satisfy the objectives as well as the opportunities and related challenges that stakeholders should address. Systems can also be configured to discover relevant domain knowledge to help identify and understand the opportunities and the challenges to develop appropriate guidance for stakeholders. Systems can identify relevant domain knowledge from various sources to obtain credible and trustworthy information, and relevant domain knowledge can be obtained from internal or external sources in some embodiments. Additionally, domain knowledge can be identified that is relevant to the objectives at hand, and domain knowledge can be obtained for different scopes, for different details, and for different standards or frameworks. Systems can identify particular contexts that are useful for understanding stakeholder objectives, and these contexts may differ based on industry or functional role. Systems can determine which assessments can be taken to provide more specific stakeholder relevant knowledge, with or without context. For example, assessments can be taken in the form of analytics based assessments, survey based assessments, capability maturity assessments, and dynamic live session assessments. Systems can identify relationships between possible guidance actions and possible services. The system can guide the creation, alignment and interpretation of knowledge for the knowledge framework, and this can optionally be done by determining relevant domain knowledge, by interpreting assessment knowledge, by interpreting relevant analytics, and by aligning with possible guidance actions and business use cases to realize specific opportunities and to mitigate challenges satisfying select stakeholder objectives. The framework can also identify or align guidance actions with services, and can also guide actions for specific investment areas.

In some embodiments, prompts may be utilized with GenAI to develop use cases for various contexts, and these use cases can often be unique to a particular context. The use cases can be a purposeful application of the use of GenAI technology to provide some benefit to a user or business. Use cases can be a business use cases in some embodiments. Multiple levels of information can be provided for a business use case. High level information can be provided so that the business use case description provides a description about the business use of the technology, and detailed level information can be provided that provides an explanation of the business benefits from a particular business use case, the unique enabling technology characteristics for the business use case, and the challenges overcome by the business use case. Use cases can also be system use cases. System use cases can describe what the system does and describe what the system does to provide a user some capabilities. System use cases can describe system behavior, and system use cases can have the purpose of providing sufficient information to act as a set of requirements for the design of a system support the use case.

GenAI can be utilized to identify credible and potentially successful use cases. For example, GenAI may be used to discover business use cases using an industry only approach where prompts are used to find use cases relevant to a specific industry. Different industries have different challenges, and each industry has different areas where technology like GenAI can have the most benefits and impact. Different industries can be selected to identify the nature of the focus of a business use case that would be most relevant for GenAI benefits to business in a particular industry. Where GenAI is used to discover business use cases using an industry only approach, GenAI may be used to discover business use cases for particular industries such as in healthcare, financial services, manufacturing, retail, telecommunications, energy, transportation, media and entertainment, or in another industry. Where the industry only approach is utilized, resulting business use cases that were identified tend to be more generalized relative to other approaches. The prompts can be framed in a manner to seek the industries that would benefit the most from the use of GenAI, and the prompts can be framed in a manner to establish a format that the use cases are presented in. For example, the prompt may be configured to cause use cases to be presented with a corresponding industry, use case title, brief description, business benefit, potential revenue, a specific service type, a particular GenAI capability or capabilities that would be used, a challenge, or a mitigation type. In some embodiments, prompts may be configured to cause the presentation of potential use cases in a specified order such as by the highest potential revenue or by some other metric.

In one example industry only approach, GenAI can be asked via a series of prompts to identify the ten most relevant industries that could benefit from the use of GenAI, and then GenAI can be used to identify four business use cases for each of the ten industries. The business use cases can optionally be unique to each particular industry in some embodiments. However, a different number of industries and/or a different number of business use cases can be identified for the industries.

In another example industry only approach, GenAI can be used to identify eight different industries that can benefit from the use of GenAI and four business use cases for each industry. For example, industries such as transportation, media and entertainment, retail, healthcare, energy, financial services, manufacturing, and telecommunications can be identified. For the transportation industry, business use cases can be GenAI driven route optimization, GenAI enabled predictive maintenance for vehicle fleets, GenAI powered traffic management, or GenAI enhanced fleet telematics. As another example, for the media and entertainment industry, the business use cases can be GenAI driven content recommendations, GenAI powered content creation and curation, GenAI powered audience analytics, GenAI powered content monetization strategies.

Business use cases can be described in various ways. In one embodiment, prompts can be configured to cause GenAI to provide a case title, a detailed description of the business use case, and a description of the benefit of the business use case. In one example embodiment, the use case title can be AI-driven Innovation Discovery. The corresponding detailed description the business use case can be “Implementing GenAI to analyze a vast array of data sources, such as scientific journals, patents, conference proceedings, and reports on industry trends, to systematically identify potential areas for innovation in the target industry; GenAI can track the emergence and evolution of new technologies, find gaps in the existing market offerings, and detect opportunities for R&D investments; by leveraging natural language processing, machine learning, and advanced analytics, the AI system can extract insights, recognize patterns, and make connections between seemingly unrelated data sets; this enables organizations to stay ahead of the competition, develop innovative products and services, and align their R&D strategy with market needs.” Furthermore, the description of the benefit of the business use case can be “Adopting AI-driven innovation discovery can lead to accelerated innovation development, resulting in increased competitiveness, market share, and revenue growth; the ability to identify gaps in existing solutions and anticipate potential future trends allows enterprises to focus their R&D investments strategically, maximizing return on investment and reducing risk.” This case title, detailed description, and benefit description are merely exemplary, and other case titles, detailed descriptions, and benefit descriptions can be used.

GenAI can also be used to discover business use cases using an approach that considers the organizational functional area only. Different enterprise functions have different areas of business focus for a business use case that is relevant to the specificity of their function. With an organizational functional area approach, GenAI may be used to discover business use cases for particular organizational functional areas such as marketing and sales, supply chain and logistics, customer service and support, human resources, finance and accounting, research and development, information technology management and cybersecurity, operations and process improvement, and other organizational functional areas. Where the organizational functional area only approach is utilized, resulting business use cases tend to be less generalized relative to other industry only approaches but more generalized than approaches that considered both the industry and organizational functional area.

Additionally, in some example embodiments, GenAI can be asked via prompts to identify the five most relevant organizational functional areas that could benefit from the use of GenAI and then to identify some five business use cases per functional area. However, a different number of business use cases and/or functional areas can be used in other embodiments.

GenAI can be used to discover business use cases using an approach that considers both the industry and organizational functional area. With an approach that considers both the industry and organizational functional area, GenAI may be used to discover business use cases for a particular industry and for a particular organizational functional area within that industry. For example, GenAI may be used to discover business use cases for the healthcare industry for the particular organizational functional area of customer service and support, GenAI may be used to discover business use cases for the telecommunications industry for the particular organizational functional area of information technology management and cybersecurity, and so forth. In one example embodiment, GenAI can be asked via prompts to identify the four different functional areas within ten different industries. However, a different number of functional areas and/or industries can be used in other embodiments.

Regardless of whether or not an industry only approach, an organizational functional area approach, or a hybrid approach considering both an industry only approach and an organizational functional area approach are used, the results can be easily used in conjunction with other material within a knowledge unit 1412B (see FIG. 15B). In this way, more any knowledge graphs and/or use case ontologies can be refined in greater detail using material from both GenAI and from client sessions. Material can be used to create an extensible knowledge graph that can enable further alignment with information sources once transformed into a use case ontology and knowledge graph. This approach offers full explainability and a knowledge asset useful to support other KPMG applications and alignments with other information sources, such as analytics, KPMG taxonomy of services, etc.

FIG. 16 illustrates a hierarchy 1600 of prompt-response patterns. The hierarchy 1600 has a hierarchical tree-like structure of specific prompt-response patterns, with each having a direct relation to a specific topic taxonomy. Each prompt-response pattern within the hierarchy of prompt-response patterns can possess a structure similar to the prompt-response pattern 1622. The prompt-response pattern 1622 can be defined with a focus on one or more topics 1630, one or more contexts 1628, one or more prompts 1626, and one or more possible responses 1624 as shown in the prompt-response pattern 1622.

Instances in the sessions can be directly related to a specific prompt-response pattern in the hierarchy 1600. A session ontology instance can be used to provide a representation of a designed session that satisfies an overall agenda for a session. In some embodiments, the possible next session prompt-response pattern can be provided to the session facilitator based on the recommendation of machine learning unit, which can analyze one or more responses to previous prompt-response patterns. In other embodiments, a group of potential session prompt-response patterns can be provided to the session facilitator based on the recommendation of the machine learning unit, and the session facilitator can select a specific prompt-response pattern from the group. As a further alternative, the machine learning unit can automatically select the next prompt-response pattern to be used based on the previous response(s).

Within the hierarchy 1600, a first series of prompt-response patterns 1604 is provided. In FIG. 16, the first series of prompt-response patterns 1604 includes a first prompt-response pattern 1604A through a final prompt-response pattern 1604N. Additionally, a second series of prompt-response patterns 1606, a third series of prompt-response patterns 1608, a fourth series of prompt-response patterns 1610, and a fifth series of prompt-response patterns 1612 are also included in the hierarchy 1600. However, additional series of prompt-response patterns can be added to the hierarchy 1600, series can be removed from the hierarchy 1600, or series can be rearranged within the hierarchy 1600. Each series of prompt-response patterns can include one or more prompt-response patterns therein in some embodiments.

In some embodiments, a focus topic might look at the specific innovation areas of impact for an organization, and prompt-response patterns can be directed towards exploring a session participant's perspective of areas that are most important. This can be done by assessing aspirational response statements in responses. The response statements can optionally be used for creating Pareto type ordered lists of importance to enable a meaningful interpretation of statements that the system could support with its ontologies and its use of the machine learning techniques such as GenAI.

The hierarchy 1600 of prompt-response patterns can enable a sequence of a set of prompt-response interactions as a session progresses. After a first response is received that is associated with a first prompt-response pattern 1604A, different approaches can be taken. For example, the first response can be used to dynamically guide the session to another prompt-response pattern within the first series of prompt-response patterns 1604. For example, based on a first response that is received, the session can be guided to another prompt-response pattern within the first series of prompt-response patterns 1604. The prompt-response pattern that is selected can simply be the next prompt-response pattern in the first series of prompt-response patterns 1604 in some embodiments, but the prompt-response pattern can instead be the next most relevant prompt-response pattern in the first series of prompt-response patterns 1604 and one or more prompt-response patterns in the first series of prompt-response patterns 1604 can be skipped at least temporarily. Alternatively, the first prompt-response pattern 1604A can be used to dynamically guide the session to another prompt-response pattern within another series of prompts. For example, based on receipt of the first prompt-response pattern 1604, it can be determined that the second series of prompt-response patterns 1606 is more relevant to the client and/or to the session agenda for the session. As responses are obtained from the participant, a session unit 1408, 1408A, machine learning unit 1410, 1410A, or another unit can optionally decide to extend sessions based on an analysis of a response and/or alignment with other relevant topic taxonomies.

The creation of the hierarchy of prompt-response patterns and a session guidance structure model can be accomplished with the use of the machine learning unit 1410A (see FIG. 15A). The taxonomies and ontologies can guide the session with prompt-response patterns for a focus topic, and the taxonomies and ontologies can assist in semantically aligning session prompt-response patterns by participants to these taxonomies. In some embodiments, the taxonomies and ontologies can be context specific based on a specific industry for the client, a specific functional role for the client, a specific aspect of the client's business that the participant is focusing on, etc. However, in other embodiments, the taxonomies and ontologies are not context specific.

Each series of prompt-response patterns in the hierarchy 1600 can be directly related to one or more taxonomies within the session taxonomy unit 1526B. The session taxonomy unit 1526B (see FIG. 15A) can provide topic prompts for use in the prompt/response patterns. The interactive sequence of the system can be guided by session ontologies unit 1526A (see FIG. 15A) and/or the session taxonomies unit 1526B (see FIG. 15A), which can contain a specific session knowledge structure taxonomy, a specific session knowledge structure ontology, or other taxonomies or ontologies that guide the interactive sequence. In some embodiments, the session ontologies unit 1526A and the session taxonomies unit 1526B are not provided in the session unit 1408A, and the specific session knowledge structure taxonomy, a specific session knowledge structure ontology, or other taxonomies or ontologies can be obtained from the knowledge unit 1412B to guide the interactive sequence of the system. The interactive sequence of the system can also be guided by an analysis of the response in a specific context within the specific session knowledge structure taxonomy or ontology, or the interactive sequence can be guided with the assistance of another ontology or another taxonomy. The guidance provided by the ontologies and taxonomies of the session ontologies unit 1526A and the session taxonomies unit 1526B can assist in determining the next series of prompt-response patterns to be explored and in determining the next specific prompt-response pattern within a series of prompt-response patterns to be explored.

During sessions, prompt(s) can be presented to the participant. The prompt(s) can be correlated with a defined prompt-response pattern 1622. Each prompt-response pattern 1622 can be focused on one or more topics, one or more contexts, one or more prompts, and one or more responses. The participant responds to the issuance of the prompt to generate a response. The response can be aligned to a specific response defined in an existing topic prompt pattern. The response can also be aligned at another location in the current topic taxonomy, or the response can extend the current topic taxonomy. As another alternative, the response can be matched with another topic taxonomy where the other topic taxonomy is of greater relevance for the response.

Responses can be received in a variety of ways. Responses can optionally be received through text, speech, drawings, touch, etc. Responses can optionally be received in the form of sticky notes that are subsequently transformed into digital form and then asserted as part of session data into the knowledge base. In some embodiments, sticky notes are scanned for recognizable characters, and data from the sticky notes can be automatically aligned to the knowledge base with an associated context. Alternatively, sticky notes can be scanned, and data from the sticky notes can be reviewed by a session facilitator. Further details regarding the receipt of sticky notes can be found in U.S. Provisional Pat. App. No. 63/419,390, which is entitled “System and Method for Digitizing and Mining Handwritten Notes to Enable Real-Time Collaboration” and which is incorporated by reference herein for all purposes.

In some embodiments, a machine learning unit can provide support during sessions. The machine learning unit can recommend that the next prompt-response pattern is as designed in the current session ontology instance. For example, the machine learning unit can recommend that the next most relevant prompt-response pattern is used. This can optionally be done where the machine learning unit selects a series of prompt-response patterns to utilize and continues to present the next most relevant prompt-response pattern in the same series of prompt-response patterns. Alternatively, the machine learning unit can recommend that prompt-response patterns be used to explore potentially relevant topics that have not yet been evaluated.

A series of prompts can be crafted for use by a machine learning unit, and this can be done to create the session ontology used at the session ontologies unit 1526A. The series of prompts can be crafted using taxonomies related to the topic at issue and/or certain aspects of a topic to relate prompt-response patterns in the session structure. The series of prompts can be crafted using the specific topic, context, and instances to relate to prompt-response patterns in the session structure.

Sessions can work to fulfill a session goal and to satisfy an agenda. The sessions can have a predefined session seed structure that guides the session facilitator with specific prompt-response patterns to interact with the participants to gain their beliefs, insights, statements, judgement, and topics most relevant and important to them. The prompt-response patterns can be topic-specific and/or context-specific in some embodiments.

Instances of a session can each be instances of a session structure ontology and can be focused on one or more topics with varying levels of detail as defined in the topic taxonomies. One potential benefit of the session ontology structure can be its ability to provide a core logical guidance session mechanism that allows multiple dimensions of context to be used in reasoning and classifying a response for use in deciding where to go next in the session interactions.

In one embodiment, the sessions can provide guidance from an origination node from one prompt-response pattern in one taxonomy to one or more other nodes of different prompt-response pattern in the same or other taxonomies. Dependent on the response to a prompt in an origination node, the machine learning unit and any logic controlling the guidance can choose one of the possible defined nodes in the current series from the current node.

In some embodiments, the sessions can be configured to receive commands from a session facilitator, and the sessions can be adapted based on the commands from the session facilitator. Thus, the session facilitator can manually override the natural flow of sessions and can cause the system to issue a new or different prompt in the session ontology. Additionally or alternatively, sessions can cause various prompts to be presented to the session facilitator, and the session facilitator can select a specific prompt from the presented options.

In some embodiments, the sessions can evolve dynamically by proposing a brand-new additional sub-tree structure from the current session structure, and the new sub-tree structure can be a variant of the current session structure.

Additionally, any prompt-response patterns discussed herein can optionally be represented as OWL ontologies in the knowledge framework.

FIG. 17 is a block diagram illustrating an example session conceptual model 1414A. Information is gathered from clients in sessions for particular focus areas. These focus areas can be one or more topics of interest, and example focus areas could be innovation, safety, financials, etc.

Various entities can be involved in a session. A session facilitation team can assist in managing a particular session, and the session facilitation team can include a session manager. In some embodiments, the session facilitation team only includes the session manager without further individuals on the session facilitation team. In some embodiments, the session manager is constrained or guided by a requirement to satisfy the session purpose set forth in the session agenda and the strategic goal. A session manager for the session interacts with the client or the participant to gather data about the focus areas. The session manager can optionally use a set of well-defined interactions, and these interactions can optionally include specific questions to solicit a desired response type.

A strategic goal unit 1704A is included, and this strategic goal unit 1704A defines the overall purpose that results of the session will support. The purpose can be to acquire client or participant specific information that is useful for providing insights for a focus area. For example, the goal can be to obtain specific information for providing insights about specific client opportunities for innovation in various contexts. Additionally, the purpose can be to build knowledge about sentiments of a client or participant towards a particular focus area, and these can be aggregated with knowledge about sentiments of other clients and participants to assist with strategic planning for improvements in the focus area. For example, where the particular focus area is innovation in the computer science field, the sentiments can be obtained from the client or participant to assist with strategic planning for improvements in innovation in the computer science field.

The session agenda unit 1706A defines the scope and details of the session agenda of a session in support of an overall strategic goal. A session taxonomies unit 1708 can be configured to hold various taxonomies and prompt-response patterns for use in sessions. The session taxonomies unit 1708 can be similar to the session taxonomies unit 1526B of FIG. 15A. Prompt-response patterns can be retrieved from the session taxonomies unit 1708 for use in a session unit 1710. The session unit 1710 can be similar to the session unit 1408 of FIG. 14 and the session unit 1408A of FIG. 15A. Prompts from the prompt-response patterns can be presented to a participant at a user interface 1712, and prompts can be provided to the client or the participant that focus on the particular focus areas. Responses from the client or the participant can be retrieved at the user interface 1712. The user interface 1712 can be used to retrieved metadata about the client. This client data can optionally include data about the industry for the client, the location of the client, etc.

Session data includes all information gathered from the session, including client data and focus question responses. In some embodiments, client data and/or responses can be provided as sticky notes. The session sticky notes are handwritten responses to prompts or questions with respect to some focus area.

During sessions, session sticky note raw data can be received at a user interface 1712 or in another way directly from a participant during a session. The session sticky note raw data can be handwritten notes, symbols, drawings, etc. retrieved from a client. The session sticky note raw data can be retrieved on a video wall, typed from a keyboard, handwritten on a tablet, etc. The session sticky note raw data can undergo sticky note data ETL (extract, transform, load) processes. The sticky note data ETL processes include a technology that transforms the content of the sticky note into sticky note extracted data that can be asserted to a knowledge base as part of the session data. The sticky notes extracted data is a digital representation of words, characters, and other symbols in session sticky note raw data.

As responses are received at the user interfaces 1712, these responses can be shared with the session unit 1710, and the responses can be used to update the status and/or the concepts of session specific data related to goal satisfaction at the strategic goal unit 1704A, the session agenda at the session agenda unit 1706A, and/or the prompt-responses or taxonomies at the session taxonomies unit 1708.

Sessions can be conducted with a particular client, a participant from that client, or with any other participant group having interest or judgements about some aspect of some topic of interest. For purposes of simplification, various embodiments of the systems are described herein as being conducted with a client. However, these systems can be conducted with other participants or group participants that do not have the role of client. These participants and/or group participants can be interested parties having varied roles in society with respect to the aspect of the topic. For example, participants and/or group participants can be customers, providers of a good or service, and/or any kind of set of stakeholders being impacted or having an interest in one or more aspects of the topic. In some uses, the client is the organization providing the information in response to inquiries and information gathering processes conducted by the session facilitator. Additionally, the client can be aware of and can agree to provide information for the defined goal established by the session agenda unit 1706A with respect to a focus area. In some embodiments, the particular industry of the client can be obtained during a session as client data. Other client information such as location, and nature of services or products provided will also be known and can be obtained during a session. A participant is the individual associated with a particular client that is participating in the session. In some embodiments, the functional role of the participant can be obtained in a session as client data. The functional role could be the specific job of the participant in the client company. This functional role could be human resources, sales, operations staff, upper management, etc. Information retrieved about the client and/or the participant can be used to obtain additional contextual information that can be associated with aspirational statements or keyword phrases provided by the client and/or the participant. These can enable a better understanding of the areas of importance for a focus area like innovation for particular contexts.

Information obtained from the information gathering processes conducted in the session conceptual model 1414A of FIG. 17 can be asserted appropriately to specific areas in the knowledge frameworks of the knowledge framework units of FIG. 18. This information can be aligned with other existing datasets contained in the various ontologies in the knowledge framework. In some embodiments, the knowledge frameworks can be updated during a session, and the updated knowledge framework can be utilized to gain more relevant information during the session.

FIG. 18 is a block diagram illustrating an example knowledge base unit 1805 comprising a knowledge framework unit 1804. This knowledge base unit 1805 can be used in place of the knowledge base unit 1412 of FIG. 14. The knowledge base unit 1805 comprises a purposeful insight ontologies unit 1803. The purposeful insight ontologies unit 1803 includes one or more ontologies that reason about the knowledge contained in the knowledge framework unit 1804. The purposeful insight ontologies unit 1803 can reason about both dynamic knowledge obtained in a session and a priori defined knowledge relevant to the strategic goal and session agenda. The purposeful insight ontologies unit 1803 can also reason about other sessions related to the same topic and/or aspect of the topic. The purposeful insight ontologies unit 1803 reasons about the insights from a session represented and inferred from the session insights ontology unit 1818. For example, the session insights ontologies unit 1818 can optionally collect aspirational statements for innovation by client, by industry, by impact area, and by functional role. The purposeful insights ontology of the purposeful insight ontologies unit 1803 infers new judgements, or instantiation of satisfaction of purposeful concepts as defined in its classes. An exemplary judgement or concept that could be inferred from the criteria for satisfaction of the concept class in the purposeful insight ontology unit 1803 can be to define whether the session insights of the session insights ontology unit 1818 satisfy the necessary criteria for judging whether application of a specific innovation in an existing product would increase sales revenue. In this example embodiment, the topic is product innovation, and the topic aspect is increased sales revenue. In order to reach this judgement, multiple insights can be inferred from the session responses by multiple participants, especially those having the role of market research and product management. Each ontology in the purposeful insight ontologies unit 1803 can create inferred insights about the focus question responses and/or session data. In some embodiments, the purposeful insight ontologies unit 1803 includes ontologies that are not limited by a specific strategic goal or purpose, and the purposeful insight ontologies unit 1803 can instead include ontologies that can be assessed with another intent. The purposeful insight ontologies unit 1803 can be configured to transform user questions into ontology queries.

The knowledge framework unit 1804 comprises various ontologies, taxonomies, and datasets. The knowledge framework unit 1804 contains the ontologies representing knowledge about the session according to the session conceptual model 1414A (see FIG. 17). The knowledge framework unit 1804 also contains the dynamic knowledge base of facts from session data that are asserted consistent with the language and defined classes of the session ontology in the session ontologies unit 1822.

The session ontologies unit 1822 includes a session ontology that can organize and interpret all relevant information regarding a session. The session ontologies unit 1822 can optionally interpret the relevant information regarding a session by itself. However, in some embodiments, the session ontologies unit 1822 can optionally interpret the relevant information regarding a session in conjunction with other ontologies in the ontology unit(s) 1806 such as a focus and impact area ontology and/or a question ontology. The session goal ontology can represent the scope and focus for the reason of the session and can define the kind of knowledge required for the strategic goal of the session. The session goal ontology can also organize and builds hierarchical meaning that can ultimately be used by the purposeful insights ontology.

The knowledge framework unit 1804 includes a session insights ontology unit 1818 that is configured to include a session insights ontology that can define the reasoning concepts and conditions of satisfaction for these concepts or ontology classes, which represent some insight type. The session insights ontology can have defined one or more defined insights classes. Each defined insight class can have one or more of its own condition(s) of satisfaction. If the condition(s) of satisfaction are satisfied semantically for a defined insight class, then that defined insight class can interpret data instances asserted in the knowledge base consistent with the other ontologies of in the purposeful insight ontologies unit 1803. An insight concept can optionally be defined to determine whether a session agenda item has been satisfied according to some criteria. For example, the session agenda items can be to evaluate whether all the participants in manufacturing, marketing, and human resources have all responded with to a series of prompts successfully, and that all responses were positive. This defines conditions of satisfaction that each identified role responds positively to a series of prompts in the session. The knowledge framework unit 1804 also includes a session agenda ontology unit 1820 configured to provide a session agenda ontology that represents the scope and focus for the reason of the session and defines the kind of knowledge required for the strategic goal of the session 1722. The session goal ontology 1836A can also organize and build hierarchical meaning that can ultimately be used by the purposeful insights ontology of the purposeful insight ontologies unit 1803.

The knowledge base unit 1805 of FIG. 18 can include one or more metadata units 1824 to add additional meaning to client response(s) or participant response(s). For example, metadata unit(s) 1824 can include client metadata that can contain metadata with attributes of the client. The client metadata can optionally include an industry of the client, a functional roles for certain participants of the client, location, date, or some other data. Client metadata can optionally be supplied by the participant for the client, but the client metadata can optionally be supplied by the client itself. The client metadata can be organized and interpreted by the session ontology of the session ontologies unit 1822.

The metadata unit(s) 1824 can also include participant metadata that can include metadata with attributes of the specific individual participant in the session. The participant metadata can include information such as a functional role of the participant, a level of authority for the participant, a native language for the participant, etc. Participant metadata can optionally be supplied by the client for the participant, but the participant metadata can additionally or optionally be supplied by the participant. In some embodiments, participant metadata is common for functional areas across different industries but unique to a particular functional role. Participant metadata provides another dimensional context for use in weighing the individual participant's contribution or unique perspective.

The metadata unit(s) 1824 can also include industry metadata. The industry metadata can include metadata with attributes of the particular industry or industries that the client is associated with. The metadata unit(s) 1824 can also include functional role metadata. The functional role metadata can include metadata regarding the particular functional role of the participant in the session. Metadata units(s) 1824 can additionally or alternatively obtain metadata regarding sessions, session question prompts, location of the client, languages spoken by the participant, location of the participant, innovation impact areas, sticky note responses, innovation sentiments, etc.

Additionally, one or more external standards units 1832 can be provided to enable the extraction of material from resources with external standards. External standards can be related to industry classifications for a client, a functional role of a participant, taxonomies related to possible functional roles of a participant, industry taxonomies, industry classification taxonomies, innovation impact categories, standards sentiments, domain language or query language, etc. Ontologies, taxonomies, and other content can be obtained from the external standards unit(s) 1832 in some embodiments.

The external standards unit(s) 1832 can provide an external standards innovation impact categories taxonomy. The external standards innovation impact categories taxonomy can be configured to identify potential impact areas in the focus area for the client. For example, one potential impact area could be innovation on manufacturing. Potential impact areas are highly dependent on the industry and the nature of the business. Initial impact categories can optionally have a seed data set developed from the responses to carefully structured prompts that derive from existing corpus. Client responses can be aligned with this initial seed data and will be extended when new impacts areas are discovered. The impact areas can optionally be contextualized by the focus question, the industry, the focus area, and/or the functional role of the client individual participant.

The knowledge framework unit 1804 can also include one or more additional ontology units 1806. Ontology unit(s) 1806 can be related to various topics and can be relevant to different contexts. Ontology unit(s) 1806 can include a question ontology, a focus and impact area ontology, a prompt ontology, an industry ontology that provides context based on industry, a functional role ontology that provides context based on a functional role of a participant, external standard ontologies, universal session structure ontologies, universal prompt-response ontologies, perspective ontologies with top-of-mind perspectives of a client or participant, and a variety of other ontologies.

Ontologies can optionally obtain data sets derived from importing external standards for statements. By doing so, the knowledge framework unit 1804 can leverage known meanings and definitions that support the strategic goal of the session (e.g., to interpret client response data to identify any aspirational statements for innovation). The external standards provide a very large lexicon of statement responses, and the external standards can also have intentional metadata associated with statement responses such as being positive or negative in connotation. Other clustering information contained in standards such as hypernyms, hyponyms, and synonyms can also be used to identify a client's data response as a kind of statement. The statement lexicon can also be extended with additional vocabulary that are matched to a specific standard. Machine learning units can use GenAI or other techniques to provide an initial alignment of client response data to questions in the innovation statement metadata.

A focus and impact area ontology can be provided in the ontology unit(s) 1806. The focus and impact area ontology can identify the focus for the session information gathering from the client perspective. For example, the focus could be “innovation.” The focus and impact area ontology also identifies the impact area that the client wishes to focus on. For example, the impact area could be “automation for manufacturing.” The focus and impact area ontology can represent knowledge about meaning of the focus question responses and/or other session data in the context of the focus area and the scope of the focus question. The focus question responses and/or the session data can optionally include two dynamic data sets. For example, these can include innovation statement data and data regarding a client perspective of an innovation impact area, with both of these optionally being formed from the digital transformation of session sticky note raw data. Other meanings can be defined for response data by different ontologies at this level for focus and impact area ontologies. The knowledge framework unit 1804 is easily scalable in the number and type of focus and impact area ontologies, depending on the nature of the focus area, the session agenda, and the strategic goal. For example, other kinds of focus areas could be on specific areas of innovation such as machine learning and its potential impact on a business within a certain industry.

The ontology unit(s) 1806 can also include a question ontology. The question ontology can represent the set of prompts for information within the session with an objective of guiding the client to provide response information relevant to one or more focus areas. For example, the question ontology can provide a series of prompts to guide the participant to provide response information relevant to innovation from the specific functional role perspective of the participant.

Ontology unit(s) 1806 or taxonomy unit(s) 1810 can optionally include a universal session model ontology or universal session model taxonomy. These can optionally define the roles of client, session manager, prompts, and responses as session data.

The knowledge framework unit 1804 can also include one or more taxonomy units 1810. The taxonomy unit(s) 1810 can optionally include an industry taxonomy unit, a perspective taxonomy that provides top-of-mind perspectives of a client or a participant, a topic prompt taxonomy, an industry taxonomy that provides context based on industry, a functional role taxonomy that provides context based on a functional role of a participant, prompt-response pattern taxonomies, external standard taxonomies, universal session structure taxonomies, and universal prompt-response taxonomies. The taxonomy unit(s) 1810 can also include other taxonomies as well.

An overall universal taxonomy can be included in the knowledge framework unit 1804 in some embodiments. Where provided, the overall universal taxonomy can potentially evolve as other individual seed topic taxonomies are developed for specific topics with components structured with metadata concepts. Taxonomies can be focused based on topic, context, aspect, prompt, and/or response. A universal topic taxonomy can evolve and grow and be used as a resource by a machine learning unit to create a session structure instance satisfying some session agenda. A universal session structure can also evolve an intimate connection to the universal topic taxonomy. This universal session structure links not only to the universal topic taxonomy but also links to session agenda concepts that might be needed in new session structures.

From this universal taxonomy, new session structure instances can be created from known agenda concepts. Prompt-response patterns or nodes can be selected from the universal session structure, and this selection can be made with the appropriate level of detail based on the available context.

Taxonomies in the taxonomy unit(s) 1810 and other taxonomies discussed herein can optionally be represented as OWL ontologies in the knowledge framework. Taxonomies in the taxonomy unit(s) 1810 and other taxonomies discussed herein can represent a breakdown structure of a topic, shifting from general aspects to more specific aspects within the taxonomy. These taxonomies can also include possible responses to prompts with some context, and the taxonomies can also include aspirational statements or keyword phrases at different levels of the taxonomy.

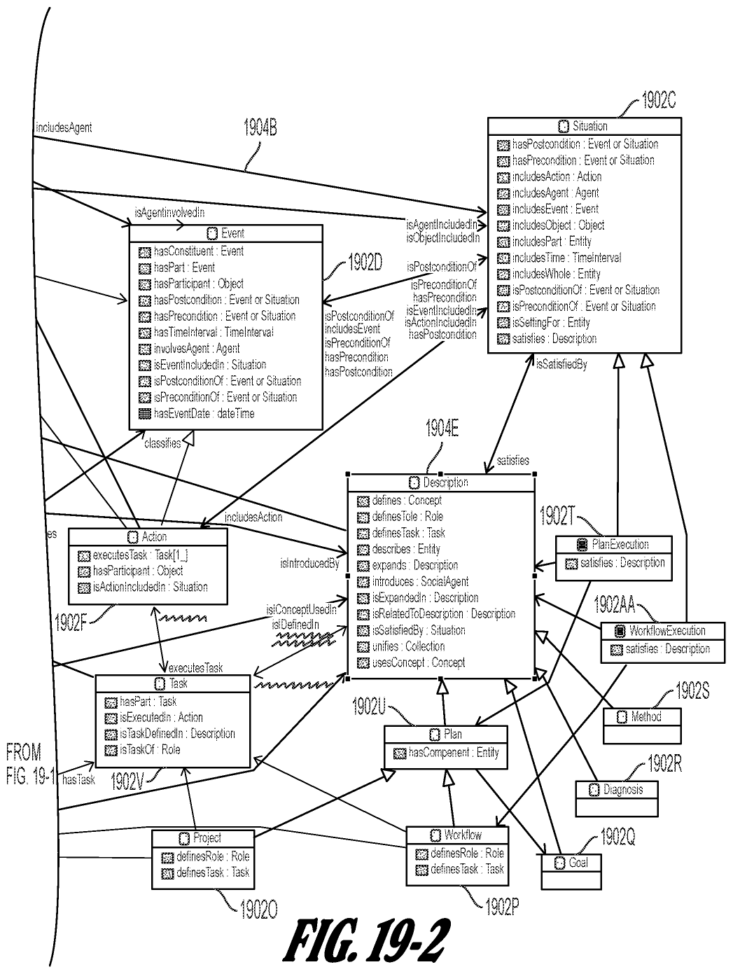

FIGS. 19-1 to 19-2 provide a schematic diagram illustrating an example ontology class diagram 1900 with associations between different characteristics. The ontology class diagram 1900 is customized to represent core knowledge about sessions. Various classes are presented in the ontology class diagram 1900. For example, an object class 1902A, an agent class 1902B, a situation class 1902C, an event class 1902D, a description class 1902E, an action class 1902F, and an information object class 1902G are illustrated in the ontology class diagram 1900 along with numerous other classes. The situation class 1902C has a defining structure and concepts and for a session. The event class 1902D is the actual occurrence of a session which actualizes or realizes a session in situation. The event class 1902D identifies actual participants in the event and any data derived from it, such as an information object subclass of session data created by a participant physical agent. The participant physical agent can be a kind of social agent with a functional role. The description class 1902E includes information regarding focus questions and impact areas, and the description class 1902E can optionally comprise other information. The information object class 1902G includes information regarding sticky note data that is provided in response to session questions. Each class can have relationships with other classes, and these relationships are illustrated by lines connecting the various classes in the ontology class diagram 1900. The line 1904A illustrates a relationship between the object class 1902A and the agent class 1902B, and the line 1904B illustrates a relationship between the agent class 1902B and the situation class 1902C. However, there are several other lines in the ontology class diagram 1900, showing that there are many other relationships between the various classes. For example, the situation class 1902C has relationships to various other classes such as the object class 1902A, the agent class 1902B, the event class 1902D, the description class 1902E, and the action class 1902F.

Other classes are also illustrated in the ontology class diagram 1900 of FIGS. 19-1 to 19-2. These classes include a physical object class 1902H, a physical agent class 1902I, an information entity class 1902J, a quality class 1902K, a region class 1902L, a concept class 1902M, a role class 1902N, a profile class 19020, a workflow class 1902P, a goal class 1902Q, a diagnosis class 1902R, a method class 1902S, a plan execution class 1902T, a plan class 1902U, a task class 1902V, a place class 1902W, an event type class 1902X, a social agent class 1902Y, a social object class 1902Z, and a workflow execution class 1902AA. However, other classes can be added to the ontology class diagram 1900. In other ontology class diagrams, some of these classes can be omitted, and the relationships between the different classes can differ in other ontology class diagrams.

FIGS. 19-1 to 19-2 illustrate an example of a relatively simple ontology class diagram 1900, but other ontology class diagrams can have increased complexity—as more and more relationships are identified, the complexity of the ontologies can increase. Other simpler ontology class diagrams can be formed as well.

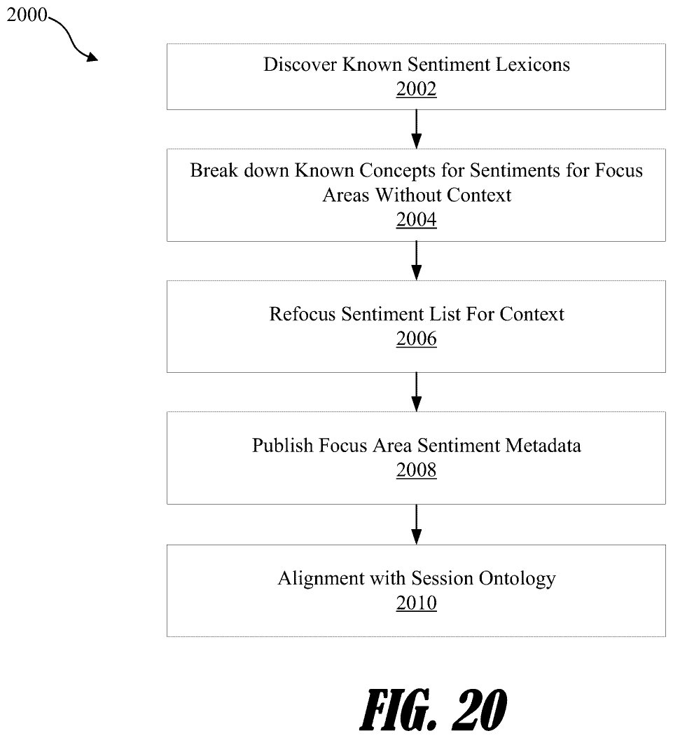

Another tool was used to discover massive corpus using machine learning to drill down and discover other statements that might have been expressed for innovation. FIG. 20 is a flow chart illustrating an example method 2000 for discovering statements for a focus topic aspect sentiment. This method 2000 can optionally use machine learning such as GenAI to discover statements for a focus topic aspect sentiment. At operation 2002, known sentiment lexicons are discovered. At operation 2004, known concepts for sentiments are broken down for focus areas without context. At operation 2006, the sentiment list is refocused for context. At operation 2008, focus area sentiment metadata is published. At operation 2010, sentiments and metadata are aligned with a session ontology.

The method 2000 illustrated in FIG. 20 was used to research keywords and concepts for a particular purpose. The method 2000 illustrated in FIG. 20 can optionally be used for aspirational statement keywords for a focus topics such as innovation, with no context, and the method 2000 can then be used to provide further clarity based on the industry context, to provide further clarity based on the functional role context, and then for discovering impact areas of innovation for an organization.

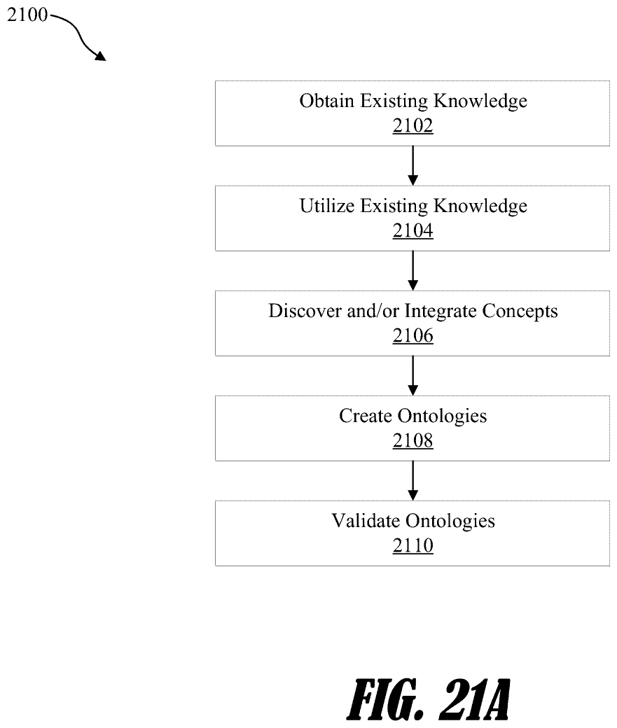

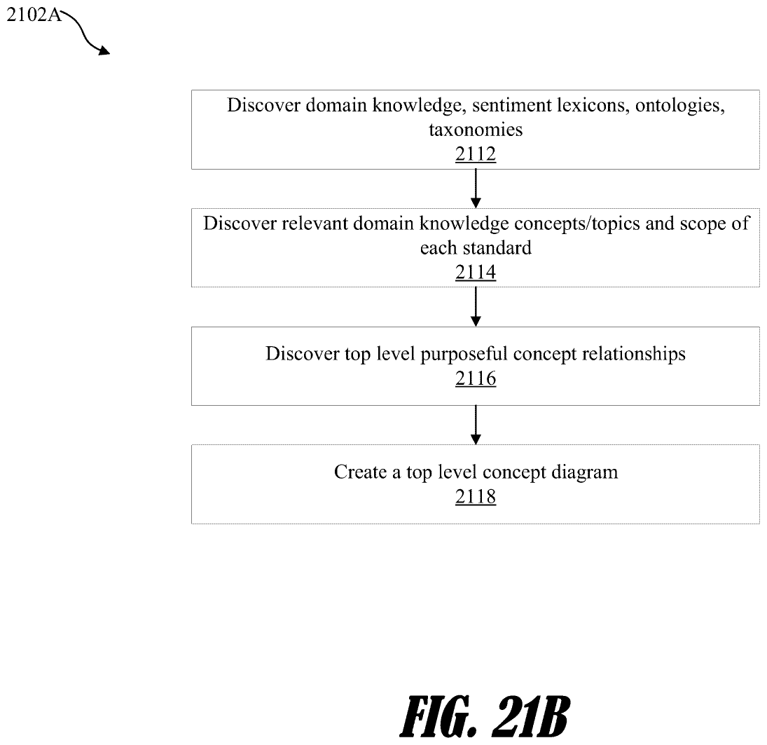

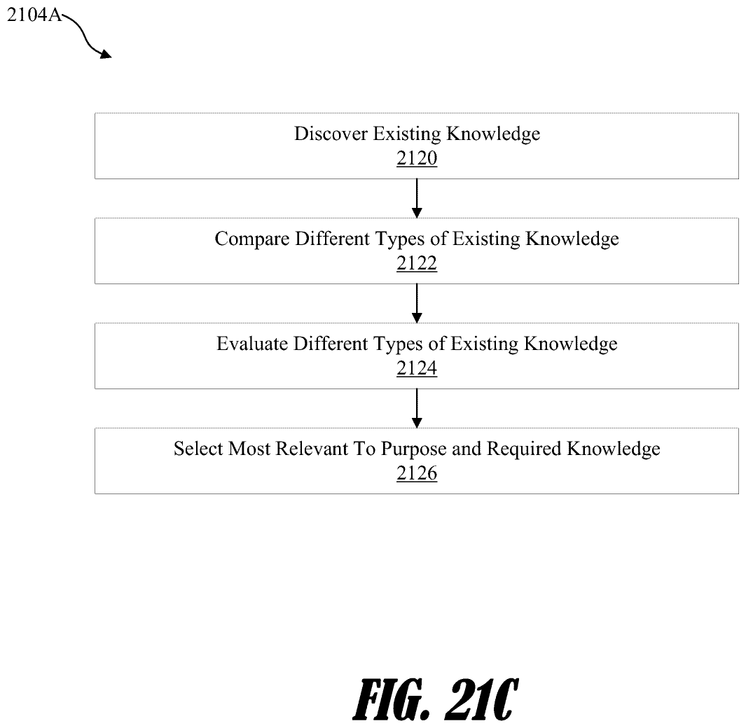

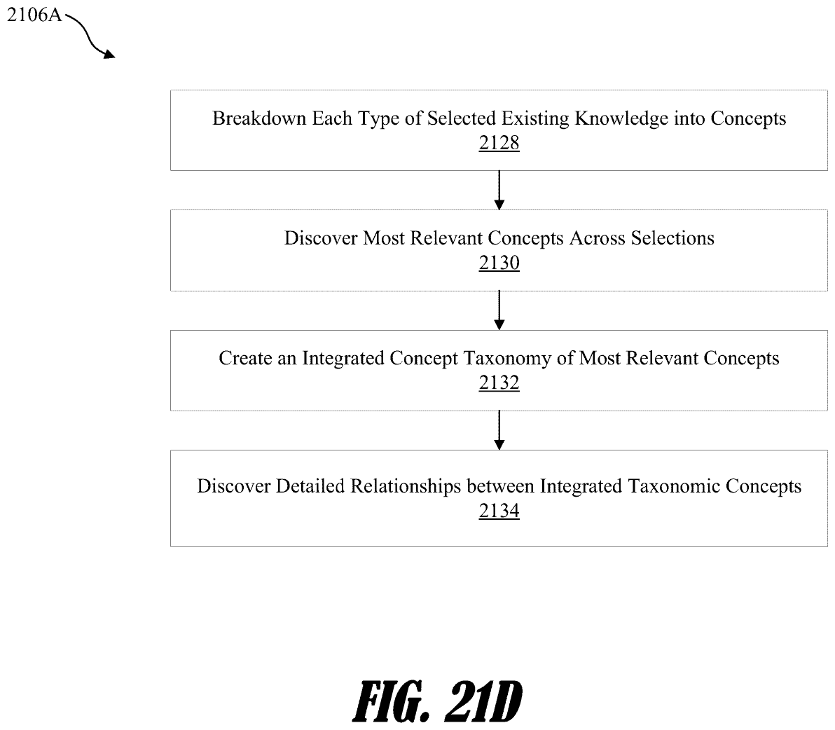

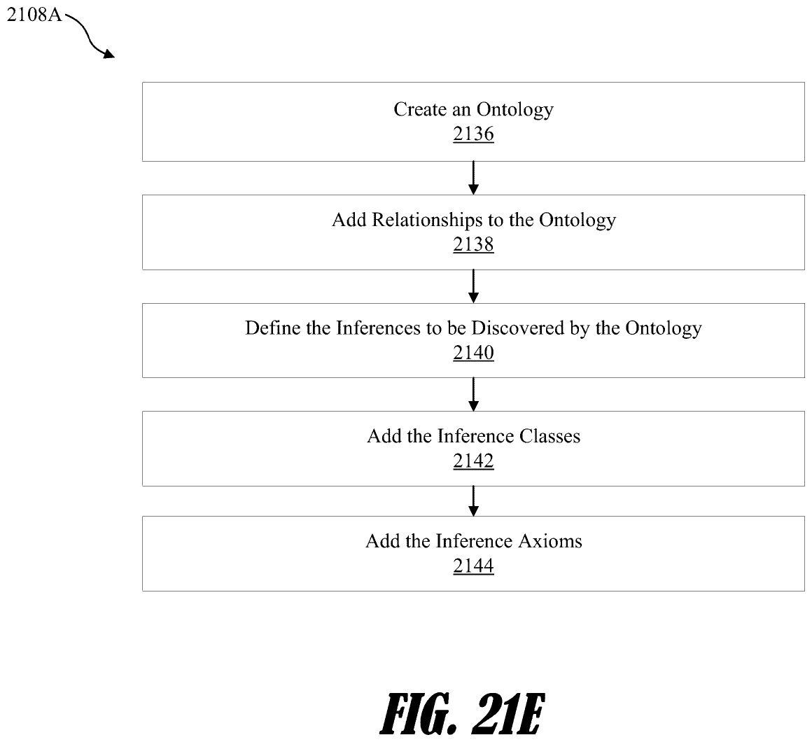

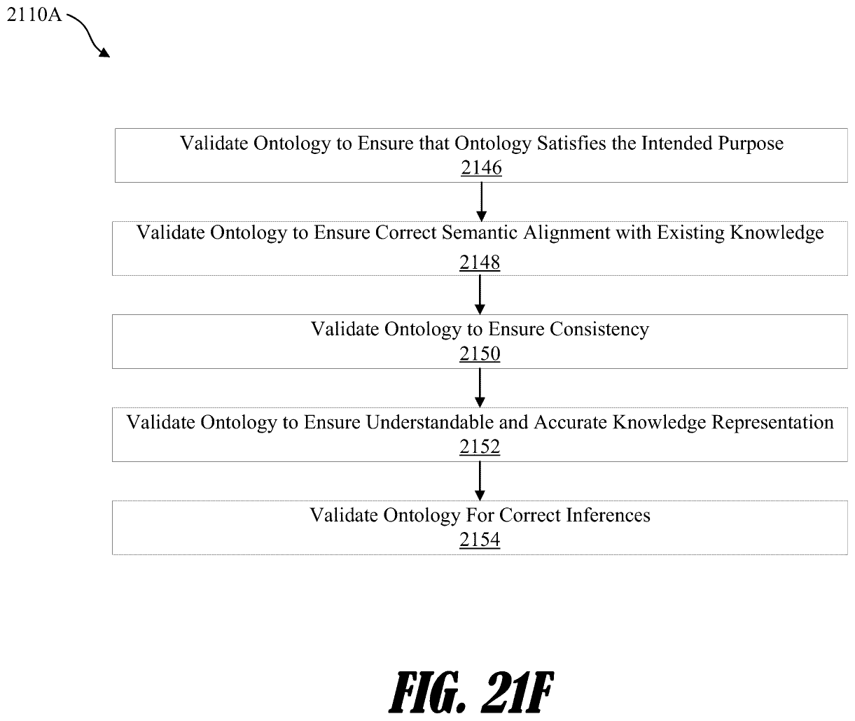

FIG. 21A is a flow chart illustrating an example method 2100 for discovering concepts and keywords related to a topic and to metadata. At operation 2102, existing knowledge is obtained. Further details regarding operation 2102 are provided in method 2102A of FIG. 21B. At operation 2104, existing knowledge is utilized. Further details regarding operation 2104 are provided in method 2104A of FIG. 21C. At operation 2106, concepts are discovered and/or integrated. Further details regarding operation 2106 are provided in method 2106A of FIG. 21D. At operation 2108, ontologies are created. Further details regarding operation 2108 are provided in method 2108A of FIG. 21E. At operation 2110, ontologies are validated. Further details regarding operation 2110 are provided in method 2110A of FIG. 21F.

FIG. 21B is a flow chart illustrating an example method 2102A for obtaining existing knowledge. At operation 2112, domain knowledge, sentiment lexicons, ontologies, and taxonomies are discovered. At operation 2114, relevant domain knowledge concepts/topics and scope of each standard are discovered. At operation 2116, top level purposeful concept relationships are discovered. These can be affective, with the relationships to innovation, hypernyms, hyponyms, and innovation area concepts. At operation 2118, a top level concept diagram is created. This diagram can include features related to innovation, context, industry, function, and responder geolocation.

FIG. 21C is a flow chart illustrating an example method 2104A for utilizing existing knowledge. At operation 2120, existing knowledge is discovered. This existing knowledge can optionally be provided in the form of standards, frameworks, taxonomies, reference data models, and/or ontologies of domain knowledge. The ontologies of domain knowledge can be ontologies of either internal or external domain knowledge. At operation 2122, the existing knowledge that has been discovered is compared. The existing knowledge can be compared for scope, domain focus, and level of detail. At operation 2124, the different types of existing knowledge are evaluated. This evaluation is undertaken to assess whether the different types of existing knowledge are relevant to the purpose at hand and to the required knowledge. At operation 2126, the most appropriate types of existing knowledge are selected. This selection can be performed by identifying the type or types of existing knowledge that are the most relevant to the purpose at hand and to the required knowledge.

FIG. 21D is a flow chart illustrating an example method 2106A for discovering and/or integrating concepts. At operation 2128, each type of selected existing knowledge is broken down into concepts. In one embodiment, the method 2106A can be performed after method 2104A, and the selected existing knowledge can be selected at operation 2126. At operation 2130, most relevant concepts are discovered across selections. At operation 2132, an integrated concept taxonomy of the most relevant concepts is created. At operation 2134, detailed relationships are discovered between integrated taxonomic concepts.

FIG. 21E is a flow chart illustrating an example method 2108A for creating ontologies. At operation 2136, an ontology is created. The ontology is created with one class for each concept in the integrated domain and topic taxonomy. At operation 2138, relationships are added to the ontology, and this can be done to satisfy a conceptual graph. At operation 2140, the inferences to be discovered by the ontology are defined. At operation 2142, the inference classes are added. At operation 2144, the inference axioms are added.

FIG. 21F is a flow chart illustrating an example method 2110A for validating ontologies. At operation 2146, the ontology is validated to ensure that the ontology satisfies the intended purpose. At operation 2148, the ontology is validated to ensure that there is a correct semantic alignment with existing knowledge. At operation 2150, the ontology is validated to ensure consistency. At operation 2152, the ontology is validated to ensure understandable and accurate knowledge representations. At operation 2154, the ontology is validated for correct inferences.

In some embodiments, some or all of the methods performed in FIGS. 21A-21F can be combined together. For example, in one embodiment, a combined method can be performed that includes method 2102A of FIG. 21B, method 2104A of FIG. 21C, method 2106A of FIG. 21D, method 2108A of FIG. 21E, and method 2110A of FIG. 21F. These methods 2102A, 2104A, 2106A, 2108A, 2110A can be performed in order in some embodiments, but the order of the methods can be rearranged in other embodiments.

Additionally, an area that was explored using machine learning was to prompt machine learning to discover keywords or concepts as word phrases that represented aspirational statements. This can optionally be conducted using GenAI techniques, but other techniques could also be used. These aspirational statements could be either positive, negative, or relatively neutral connotations for a particular focus theme such as “innovation.” By evaluating these aspirational statements, knowledge bases can be at least partially populated with relevant aspirational statements. These aspirational statements can also be utilized to aid in semantic alignment of a knowledge base with session notes. In some embodiments, the aspirational statements discovered using machine learning can optionally be utilized to discover an initial set of concepts and keywords for a particular focus theme, these aspirational statements can be utilized as the initial foundational knowledge within a knowledge base, and the knowledge base can evolve over time as it is populated with further information from further sessions.

For example, GenAI was utilized to form an initial list of aspirational statements that had positive and negative connotations for the particular focus theme of innovation where a generalized context was utilized. Some of the most commonly used aspirational statements with a positive connotation included the following terms: advancement, creative, cutting-edge, development, evolution, forward-thinking, innovative, invention, modern, novel, pioneering, progress, revolutionary, risk-taking, sophisticated, trendsetting, unique, up-to-date, visionary, and world-class. Some of the most commonly used aspirational statements with a negative connotation included the following terms: complacency, decline, destruction, failure, hindrance, incompetence, inefficiency, neglect, obstacle, opposition, poverty, regression, risk, shortage, stagnation, suppression, threat, unsustainability, vulnerability, and waste.

These are generic aspirational statements that are be related to the particular focus theme of “innovation” regardless of the specific industry context or functional role context. Thus, the generic aspirational statements are those that might be expressed without regard to industry or functional role. As a session is conducted with one client, the list of aspirational statements can also evolve with possible new words as further context is obtained from the client. Additionally, after sessions are conducted with clients, the list of aspirational statements can evolve as further information is obtained from clients—for example, where one or more clients use certain aspirational statements in a manner that suggests a strong positive connotation for the aspirational statement, then this aspirational statement can be added to the list or a strength value of the aspirational statement can be updated to indicate that the aspirational statement has a stronger positive connotation.

As explained further herein, more lists have also been obtained of aspirational statements that had positive and negative connotations for the particular focus theme of innovation where more specific contexts were utilized. Where specific contexts were utilized, the lists evolved further to make certain aspirational statements more relevant. For example, where the particular focus theme is innovation and the aspirational statements are being made in the context of the manufacturing industry, aspirational statements with a positive connotation could include the terms “efficiency,” “productivity,” and “optimization.” Where the particular focus theme is innovation and the aspirational statements are being made in the context of the construction industry, aspirational statements with a positive connotation could include the terms “robust infrastructure” or “revolutionary design.”

The list of aspirational statements can also be focused based on the functional role of the client. For example, where the particular focus theme is “innovation” and the aspirational statements are being made by a client having a functional role of “executive management,” some of the most commonly used aspirational statements with a positive connotation included the following terms: ambitious, bold, creative, daring, energetic, forward-thinking, groundbreaking, innovative, motivated, optimistic, pioneering, progressive, revolutionary, strategic, successful, transformative, visionary, winning, zealous, and zestful. Additionally, where the particular focus theme is “innovation” and the aspirational statements are being made by a client having a functional role of “executive management,” some of the most commonly used aspirational statements with a negative connotation included the following terms: apathetic, complacent, cynical, defeatist, hesitant, inadequate, indecisive, inflexible, lazy, narrow-minded, obstinate, outdated, passive, rigid, skeptical, stubborn, unambitious, uncreative, unmotivated, and unwilling.

As another example, where the particular focus theme is “innovation” and the aspirational statements are being made by a client having a functional role of “IT management,” some of the most commonly used aspirational statements with a positive connotation included the following terms: advancement, creative, cutting-edge, efficiency, innovative, leadership, modern, motivation, optimization, pioneering, progress, revolutionary, strategic, success, technological, transformation, trendsetting, upgrading, visionary, and winning. Additionally, where the particular focus theme is “innovation” and the aspirational statements are being made by a client having a functional role of “IT management,” some of the most commonly used aspirational statements with a negative connotation included the following terms: antiquated, complacency, costly, deficient, failure, hindrance, inadequate, inefficient, obsolete, outdated, overly-complex, poor, risky, sluggish, stagnant, unproductive, unsatisfactory, unsuccessful, unwieldly, and wasteful.

Some aspirational statements having positive or negative connotations are generic and can be applicable regardless of the particular industry or functional role. Aspirational statements can be general statements related to innovation, statements related to particular areas that could respond positively to innovation, and statements related to an effect of innovation.

As another example, where the particular focus theme is “innovation” and the aspirational statements are being made by a client having a functional role of “human resources,” some of the most commonly used aspirational statements with a positive connotation included the following terms: agile working, change management, collaborative environment, creative thinking, cross-functional teams, employee engagement, employee retention, flexible working, innovation culture, knowledge sharing, learning and development, mentoring, performance management, process improvement, recruitment and selection, reward and recognition, strategic planning, talent acquisition, talent management, and workplace diversity. Many of the aspirational statements in this list appear to be words that express an area in human resources that could respond positively to innovation, and many of these aspirational statements could be added as potential organization impact areas for those in a human resources functional role.

As another example, where the particular focus theme is “innovation” and the aspirational statements are being made by a client having a functional role of “sales,” some of the most commonly used aspirational statements with a positive connotation included the following terms: adaptability, agility, automation, creativity, customer centricity, differentiation, efficiency, experimentation, forward thinking, innovation, market disruption, networking, out-of-the-box thinking, personalization, proactivity, resourcefulness, strategic thinking, technology integration, trend analysis, and value proposition.

As another example, where the particular focus theme is “innovation” and the aspirational statements are being made by a client having a functional role of “marketing,” some of the most commonly used aspirational statements with a positive connotation included the following terms: creative thinking, digital transformation, disruptive innovation, entrepreneurial mindset, future-proofing, game-changing, innovative solutions, market disruption, market research, new technologies, out-of-the-box thinking, pioneering strategies, product development, revolutionary ideas, strategic planning, trend analysis, user experience, value proposition, visionary leadership, and win-win-solutions.

As another example, where the particular focus theme is “innovation” and the aspirational statements are being made by a client having a functional role of “market research,” some of the most commonly used aspirational statements with a positive connotation included the following terms: agile methodology, brainstorming, creative thinking, data analysis, design thinking, disruptive innovation, experimentation, focus groups, ideation, in-depth interviews, iterative process, market research, new product development, open innovation, qualitative research, quantitative research, rapid prototyping, strategic planning, trend analysis, and user experience (UX) design.

As shown by the lists of aspirational statements discussed herein where different functional roles are used, the lists have some overlap where aspirational statements are included on multiple lists. Where this is the case, the aspirational statements are more generic in nature and tend to cross functional roles. Additionally, the lists also include several aspirational statements that are unique to a particular functional role. The knowledge frameworks described in various embodiments herein can optionally incorporate datasets based on the aspirational statements with positive, negative, and/or neutral connotations in various contexts, and these aspirational statements can be incorporated into ontologies. The ontologies can conceptualize aspirational statements as neutral or as having a positive or negative connotation based on the context.

Similarly, the list of aspirational statements can also be focused based on the particular industry for a client. Many of the identified aspirational statements based on the particular industry focus were provided in the form of aspirations or goals that those in the particular industry wished to obtain, and these types of aspirational statements could be classified as industry specific aspirational statements. Identified aspirational statements were also focus areas in an industry or a desired or potential effect of innovation on a particular industry. Ontologies can optionally be organized such that industry specific aspirational statements are separated from generic innovation aspirational statements and functional role aspirational statements.

Where the particular focus theme is “innovation” and the aspirational statements are being made by a client in the “computer” industry, some of the most commonly used aspirational statements with a positive connotation included the following terms: leveraging technology to create new solutions, utilizing data to make informed decisions, automating processes for improved efficiency, developing cutting-edge artificial intelligence, exploring the potential of virtual reality, finding ways to maximize cloud computing, pioneering machine learning algorithms, creating software applications to improve user experience, developing the internet of things (IoT), enhancing cybersecurity protocols, investigating blockchain technology, utilizing big data to drive insights, expanding the capabilities of robotics, exploring quantum computing, understanding the implications of 5G networks, optimizing data center operations, optimizing user interfaces, utilizing machine learning to drive insights, integrating smart devices into everyday life, and exploring the potential of augmented reality.

As another example, where the particular focus theme is “innovation” and the aspirational statements are being made by a client in the “energy services” industry, some of the most commonly used aspirational statements with a positive connotation included the following terms: developing new and efficient energy solutions, utilizing clean energy sources, maximizing energy efficiency, harnessing the power of data to optimize energy usage, integrating renewable energy sources into existing infrastructure, leveraging cutting-edge technologies to reduce energy costs, creating smart energy systems that respond to consumer needs, establishing a culture of sustainability, developing new business models to enable the energy transition, pursuing new methods of energy storage, exploring ways to increase access to energy services, transitioning to a low-carbon economy, creating innovation solutions to reduce energy wastage, investing in renewable energy research and development, developing intelligent energy networks, encouraging energy efficiency through consumer education, promoting energy conservation through smart technologies, utilizing smart grid solutions to reduce energy costs, creating energy systems that are resilient to climate change, and advancing the energy sector through digital transformation.

As another example, where the particular focus theme is “innovation” and the aspirational statements are being made by a client in the “pharmaceutical” industry, some of the most commonly used aspirational statements with a positive connotation included the following terms: developing cutting-edge treatments for rare diseases, pioneering personalized medicine solutions, offering more efficient drug delivery systems, creating treatments with fewer side effects, advancing the use of analytics and artificial intelligence in drug discovery, exploring new ways to combat antibiotic resistance, utilizing big data to improve patient outcomes, leveraging new technologies to reduce drug development costs, establishing global partnerships to advance drug development, developing innovative approaches to clinical trials, improving access to essential medicines, exploring alternative sources of financing for drug development, advocating for regulatory reforms that reduce drug prices, harnessing the power of gene editing and gene therapy, creating novel treatments for neglected diseases, pursuing the use of digital therapeutics, expanding the capabilities of regenerative medicine, developing novel drug delivery systems, exploring the potential of nanotechnology, and pioneering the use of virtual reality in drug development.

Additionally, aspirational statements be important innovation areas for an organization. Where the particular focus theme is “innovation” and the aspirational statements are being made by a client in the “pharmaceutical” industry, some of the important innovation areas identified in aspirational statements were: next-generation medicine, drug discovery, patient-centric solutions, novel therapies, clinical trial innovation, personalized medicine, innovative drug delivery, precision medicine, digital health, disruptive technologies, genomics, artificial intelligence, biomarkers, big data, molecular diagnostics, remote clinical trials, process automation, automated compliance, wearable technologies, and robotic process automation.

As another example, where the particular focus theme is “innovation” and the aspirational statements are being made by a client in the “manufacturing” industry, some of the important innovation areas identified in aspirational statements were: automation, continuous improvement, design thinking, digital transformation, efficiency, industry 4.0, innovation, lean manufacturing, machine learning, mass customization, modularization, process automation, quality control, robotics, six sigma, smart manufacturing, supply chain management, technology integration, total quality management, and value stream mapping.

As another example, where the particular focus theme is “innovation” and the aspirational statements are being made by a client in the “telecommunications” industry, some of the important innovation areas identified in aspirational statements were: 5G technology, artificial intelligence, augmented reality, big data, cloud computing, connected devices, digital transformation, edge computing, internet of things, machine learning, mobile applications, network automation, network security, open source software, robotics, smart cities, software defined networking, streaming services, wearable technology, and wireless communications.

As another example, where the particular focus theme is “innovation” and the aspirational statements are being made by a client in the “software” industry, some of the important innovation areas identified in aspirational statements were: agile methodology, automation, cloud computing, data analytics, DevOps, digital transformation, gamification, internet of things, machine learning, mobile applications, open source, predictive analytics, process automation, robotics, security, software as a service (SaaS), software development, user experience (UX), virtual reality (VR), and wearable technology.

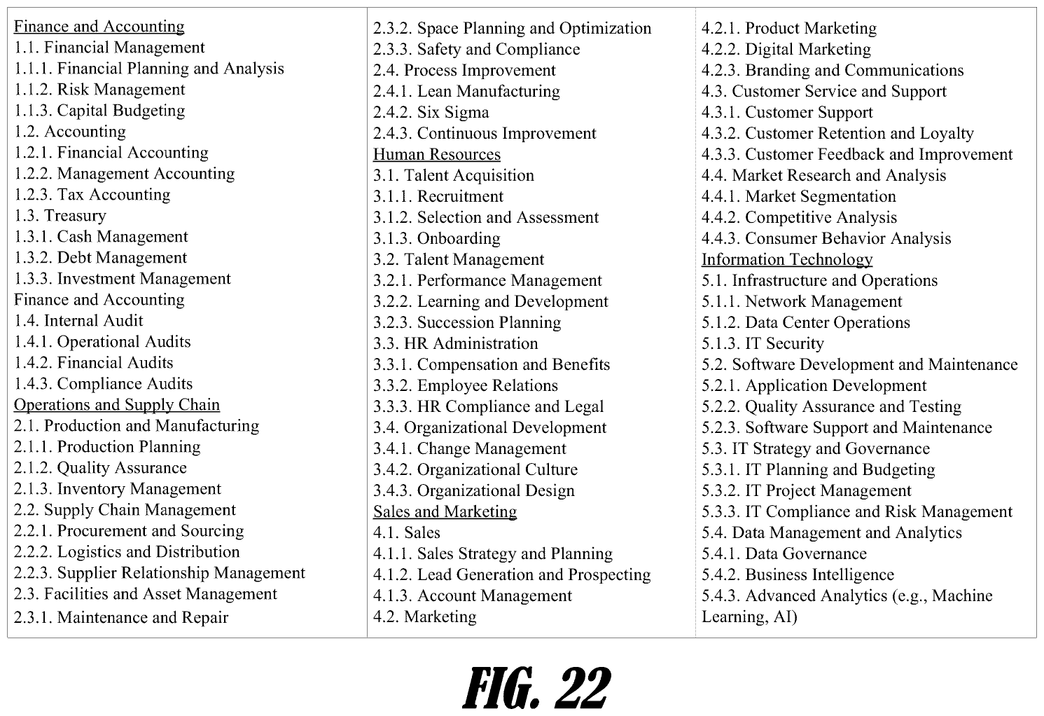

Additionally, top-of-mind ideas can be related to various major business entity functional areas. For example, FIG. 22 illustrates a taxonomy with various major business entity functional areas. As illustrated in FIG. 22, operational functions of a business entity can be organized into the primary categories of finance and accounting, operations and supply chain, human resources, sales and marketing, and information technology. Within each of these primary categories, there are various subcategories. For example, within the primary category of finance and accounting, subcategories can be provided in the form of a financial management subcategory, an accounting subcategory, a treasury subcategory, and an internal audit subcategory. The subcategories can even include additional layers of subcategories. For example, the financial management subcategory can include separate subcategories for financial planning and analysis, risk management, and capital budgeting. By providing further layers of subcategories, session participant responses can be more specifically aligned to the appropriate business entity functional areas. The taxonomy of FIG. 22 was created using GenAI and can serve as a seed taxonomy for the first interpretation of the intended context of a Top-of-Mind ideas expressed by a participant during a session prompt. Additional subcategories and layers of subcategories can be created and included in taxonomies, and the taxonomy illustrated in FIG. 22 is merely provided for the purposes of explanation.

For each of the subcategories used in the taxonomy of FIG. 22, possible aspirational responses are provided that are associated with the subcategories. These aspirational responses are responses to prompts for top-of-mind statements by participants. For example, within the finance and accounting primary category, various possible aspirational responses are provided.

For the financial management subcategory, a possible aspirational response can be “strong financial management is the cornerstone of a successful and sustainable organization.” For the financial planning and analysis subcategory, possible aspirational responses could be “strategic financial planning enables proactive decision-making and organizational agility” and “data-driven analysis informs business decisions and uncovers opportunities for growth.” For the risk management subcategory, possible aspirational responses could be “comprehensive risk management protects the organization and ensures long-term stability” and “a culture of risk awareness fosters proactive mitigation and strengthens resilience.” For the capital budgeting subcategory, possible aspirational responses could be “efficient capital allocation optimizes resources and maximizes returns on investments” and “strategic capital budgeting supports innovation and sustainable growth.”

For the accounting subcategory, possible aspirational responses could be “transparent and accurate accounting builds trust and credibility among stakeholders.” For the financial accounting subcategory, possible aspirational responses could be “timely and accurate financial reporting ensures regulatory compliance and stakeholder confidence” and “high-quality financial information provides a solid foundation for decision-making.” For the management accounting subcategory, possible aspirational responses could be “effective management accounting drives informed and operational decisions” and “cost control and performance evaluation contribute to operational efficiency and profitability.” For the tax accounting subcategory, possible aspirational responses could be “expert tax planning and compliance minimize risks and optimize financial outcomes” and “a reasonable approach to tax accounting reflects good corporate citizenship.”

For the treasury subcategory, possible aspirational responses could be “prudent treasury management ensures financial stability and supports strategic goals.” For the cash management subcategory, possible aspirational responses could be “effective cash management optimizes working capital and ensures business continuity” and “efficient cash flow forecasting and monitoring supports financial planning and resource allocation.” For the debt management subcategory, possible aspirational responses could be “balanced debt management strategies align with risk tolerance and financial objectives” and “proactive debt monitoring and restructuring ensure long-term financial health.” For the investment management subcategory, possible aspirational responses could be “strategic investment management diversifies financial assets and maximizes returns” and “a disciplined approach to investment selection aligns with organizational goals and risk appetite.”

For the internal audit subcategory, possible aspirational responses could be “robust internal audits contribute to operational excellence and risk mitigation.” For the operational audits subcategory, possible aspirational responses could be “systematic operational audits drive process improvements and optimize performance” and “a culture of continuous improvement supports organizational growth and efficiency.” For the financial audits subcategory, possible aspirational responses could be “financial audits validate the integrity and accuracy of financial information.”

Various aspirational responses described herein can be static in the sense that they do not change much over time. Additionally, aspirational responses can be universal in the sense that they do not change much across different contexts, different clients, different functional roles for participants, etc. For aspirational responses that are static and/or universal, the set of keywords associated with the theme will likely be largely fixed.

Other aspirational responses are likely to be highly contextual in the sense that the keywords evolve dynamically over time. These aspirational responses are highly dependent on the specific circumstances of the context, the client, the functional role of the participant, etc. For example, a highly contextual aspirational responses can be appropriate for one industry classification (e.g., financial services, manufacturing, pharmaceuticals), one client function (e.g., accounting, finance, engineering), functional role of the participant (e.g., associate, manager, director, executive), or regional norms, etc. However, the highly contextual aspirational response cam have little value for another industry classification, client function, functional role, regional norm, etc. The aspirational responses can also differ based on other factors such as vertical industry, function, and demographics. Other factors revealed during specific sessions can also affect relevance of certain aspirational responses.

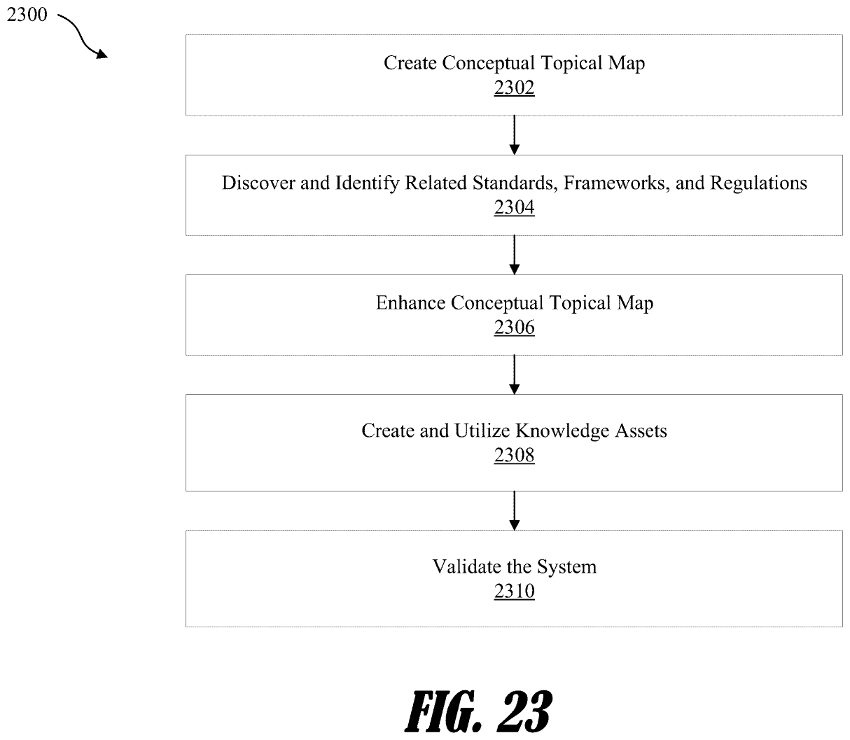

In some embodiments, methods can be provided for developing a knowledge system using machine learning techniques like GenAI, and FIG. 23 is a flow chart illustrating one such example method 2300. At operation 2302, a conceptual topical map can be formed. In doing so, it can be determined what the goal is for the conceptual topical map. The conceptual topical map can be used as a map for a particular knowledge journey. The conceptual topical map can include domains, major topics, and/or top level concepts. In creating the conceptual topical map at operation 2302, relevant sources of information can be discovered to obtain foundational domain knowledge. Additionally, in creating the conceptual topical map at operation 2302, the impact of context on scope and granularity of domain knowledge can be defined. Furthermore, in creating the conceptual topical map at operation 2302, relevant top level domain concepts can be selected and described for each major topic.

At operation 2304, standards, frameworks, and regulations can be discovered and identified that are related to the conceptual topical map. Relevant topics can eventually be discovered, aligned with, and added to a conceptual topic map created in operation 2302. Topics related to standards, frameworks, and regulations can be broken down into top level concepts and added to the created conceptual topic map. At operation 2304, positive and negative examples for standards, frameworks, and regulations can be created that can be integrated into the conceptual topic map. For example, a positive example could be an example scenario that would meet a particular regulation, and a negative example could be an example scenario that would fail to meet a regulation. Furthermore, compliance rules for the standards, frameworks, and regulations can be discovered and added to the conceptual topic map with corresponding explanations in operation 2304.

At operation 2306, the conceptual topical map can be enhanced. At operation 2306, details about the conceptual topical map can be provided to enhance the conceptual topical map. For example, detail regarding specific subtopics within the conceptual topical map can be added. Furthermore, once the conceptual topical map is developed, a specific subtopic can be selected that is relevant to a particular purpose and/or context. The conceptual topical map can also be configured to create a taxonomy, and the taxonomy can have a human definitional structure and can be used in other computers. During the creation and enhancement of the conceptual topic map, provenance with standard regular document text can be maintained.

At operation 2308, knowledge assets can be created and utilized. One knowledge asset can be created from the taxonomy, the conceptual topical map, and/or previous results. Additionally, the knowledge asset can be formed with relationships identified for domain and context concepts. In some embodiments, a second knowledge asset can be created for the standards, regulations, and frameworks. In some embodiments, the first and second knowledge assets can be aligned based on their relationships. For example, where knowledge assets are both related to compliance in a specific area, then this relationship between the knowledge assets can be identified and the knowledge assets can be aligned based on this relationship. In some embodiments, knowledge reasoning compliance rules can be created and tested.

At operation 2310, the system can be validated. The system can be validated by testing the system to ensure that the system can utilize the knowledge asset to query external information and its corpus to provide specific guided context responses. The system can also be validated by testing results using positive and negative examples, with these positive and negative examples being created in operation 2304. The system can also be validated to ensure that the system uses the knowledge asset to provide accurate data extraction and semantic alignment.

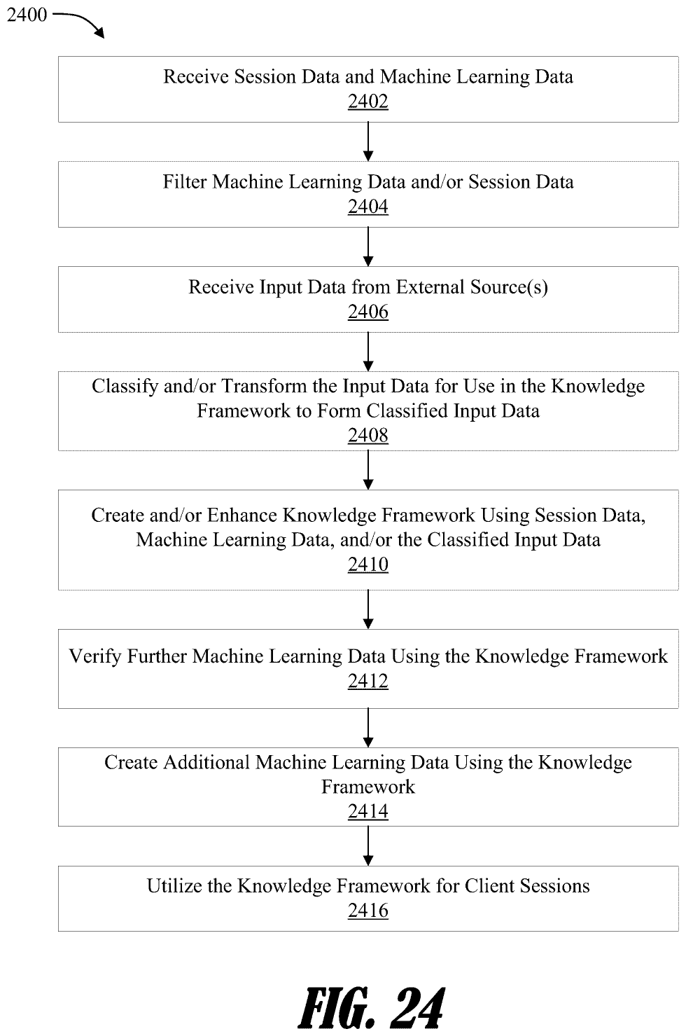

FIG. 24 illustrates another example method 2400 for development and use of a knowledge framework. At operation 2402 of the method 2400, session data and machine learning data are received. The session data is related to responses received from a participant in a session. The session data can include an ontology and/or a taxonomy, and the ontology and/or the taxonomy can be used to guide a client session.

At operation 2404, machine learning data and/or session data is filtered. This filtering can occur before any further use of the machine learning data or the session data. Filtering can be performed by identifying trustworthy data and untrustworthy data, and filtering can result in the use of only trustworthy data. The knowledge framework itself may be used to filter certain machine learning data or session data. Scoring approaches similar to those discussed in FIG. 8 and at other locations herein may be adapted for use in filtering machine learning data or the session data.

At operation 2406, input data is received from one or more external sources. A wide array of external sources may be used to provide input data. For example, the external sources 1416A of FIG. 15A may be used, but other external sources may also be used. At operation 2408, the input data is classified and/or transformed for use in the knowledge framework to form classified input data. The input data can be transformed into a different format for use in the knowledge framework. For example, the input data can be transformed so that the resulting classified input data semantically aligns with language of a taxonomy or an ontology in the knowledge framework. The input data can include data from one or more external sources, and the input data can include data related to at least one of a domain, a stakeholder, an assessment, an opportunity, a use case, a challenge, a capability maturity level, a session focus, a survey focus, a guidance focus, an insight focus, a data interpretation focus, a foundational models focus, an external web source, a standard, a framework, a best practice, a regulation, a taxonomy, an ontology, a lexicon, a machine learning corpus, or another document.

At operation 2410, the knowledge framework can be created and/or enhanced using session data, machine learning data, and/or classified input data. In some embodiments, the knowledge framework can optionally be iteratively enhanced based on the machine learning data, the session data, and/or the classified input data, and this iterative enhancement can optionally occur automatically at regular intervals. In some embodiments, the knowledge framework is a large language model. In some embodiments, the knowledge framework comprises an ontology and/or a taxonomy, and the creation and/or enhancement of the knowledge framework can be accomplished by evolving the ontology and/or the taxonomy based on machine learning data. In some embodiments, creation and/or enhancement of the knowledge framework can be performed using a weighted scores, with these weighted scores being determined using the method 800 of FIG. 8.

At operation 2412, further machine learning data is received, and this further machine learning data is verified using the knowledge framework. The further machine learning data is distinct from the machine learning data that is received at operation 2404. In some embodiments, verification of the further machine learning data is performed automatically and periodically.

At operation 2414, additional machine learning data is created using the knowledge framework. At operation 2416, the knowledge framework is utilized for client sessions. The knowledge framework can be utilized by assessing whether a topic taxonomy instance in the knowledge framework is applicable to a participant response. If it is determined that the topic taxonomy instance is not applicable to the participant response, then another topic taxonomy instance can be searched for in attempt to identify a match of the participant response. The knowledge framework can also be utilized in client sessions in various other ways. For example, the knowledge framework can assist in guiding the prompt-response patterns presented during a client session, and the knowledge framework can be utilized in other ways as discussed herein.

While various flow charts have been illustrated herein, the operations of the flow charts can be rearranged in other embodiments. Further, operations that are illustrated can be omitted in some embodiments or additional operations can be added. Operations can also be performed simultaneously in some embodiments.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A computer-implemented system for development and use of a knowledge framework, the system comprising:
one or more processors; and
a memory including computer program code configured to, when executed, cause the one or more processors to:
receive session data related to responses received from a participant in a session;
receive machine learning data;
create or enhance the knowledge framework based on the machine learning data and the session data; and
create additional machine learning data using the knowledge framework as a source of information.

2. The computer-implemented system of claim 1, wherein the one or more processors include a session unit, a machine learning unit, and a knowledge framework unit, wherein the session unit is configured to generate the session data, wherein the machine learning unit is configured to generate the machine learning data, and wherein the knowledge framework unit is configured to develop the knowledge framework by receiving the machine learning data from the machine learning unit, receiving the session data from the session unit, and creating or enhancing the knowledge framework based on the machine learning data and the session data.

3. The system of claim 1, wherein the knowledge framework is iteratively enhanced based on the machine learning data and the session data.

4. The system of claim 1, wherein the computer program code is configured to, when executed, cause the one or more processors to:
filter the machine learning data and the session data before use of the machine learning data and the session data in creating or enhancing the knowledge framework.

5. The system of claim 4, wherein the machine learning data and the session data are filtered by identifying data that is trustworthy and data that is untrustworthy, wherein only the data that is trustworthy is used to create or enhance the knowledge framework.

6. The system of claim 1, wherein the computer program code is configured to, when executed, cause the one or more processors to:
verify further machine learning data using the knowledge framework.

7. The system of claim 6, wherein verifying the further machine learning data using the knowledge framework is performed automatically and periodically.

8. The system of claim 1, wherein the knowledge framework is a large language model.

9. The system of claim 1, wherein the knowledge framework comprises an ontology or a taxonomy, wherein creating or enhancing the knowledge framework is performed by evolving the ontology or the taxonomy within the knowledge framework unit based on the machine learning data.

10. The system of claim 1, wherein the computer program code is configured to, when executed, cause the one or more processors to:
receive input data from at least one external source; and
classify the input data to form classified input data for use in the knowledge framework.

11. The system of claim 10, wherein the computer program code is configured to, when executed, cause the one or more processors to:
transform the classified input data into a different format for use in the knowledge framework.

12. The system of claim 11, wherein the computer program code is configured to, when executed, cause the one or more processors to:
transform the classified input data so that the classified input data semantically aligns with language of a taxonomy or an ontology in the knowledge framework.

13. The system of claim 11, wherein the session data comprises a participant response, wherein the computer program code is configured to, when executed, cause the one or more processors to:
assess whether a topic taxonomy instance is applicable to the participant response; and
search for a second topic taxonomy instance to identify a match for the participant response.

14. The system of claim 10, wherein the knowledge framework is created or enhanced based on the machine learning data, the session data, and the classified input data.

15. The system of claim 14, wherein the input data includes data from one or more external sources, and wherein the input data includes data related to at least one of a domain, a stakeholder, an assessment, an opportunity, a use case, a challenge, a capability maturity level, a session focus, a survey focus, a guidance focus, an insight focus, a data interpretation focus, a foundational models focus, an external web source, a standard, a framework, a best practice, a regulation, a taxonomy, an ontology, a lexicon, a machine learning corpus, or another document.

16. The system of claim 1, wherein the session data comprises an ontology or a taxonomy, and wherein the ontology or the taxonomy guide a client session.

17. The system of claim 1, wherein the computer program code is configured to, when executed, cause the one or more processors to:
receive at least one response;
determine a base score for the at least one response;
determine one or more scoring adjustments; and
determine a weighted score for the at least one response based on the base score and the one or more scoring adjustments.

18. The system of claim 17, wherein the one or more scoring adjustments includes at least one of an importance level scoring adjustment based on an importance level of the at least one response, a trustworthiness scoring adjustment based on a trustworthiness of the at least one response, or a certainty scoring adjustment based on an uncertainty level of the at least one response.

19. The system of claim 17, wherein creating or enhancing the knowledge framework is performed using the weighted score for the at least one response.

20. The system of claim 1, wherein the knowledge framework has components that represent knowledge understandable by both humans and computers, and wherein the knowledge framework provides a contextual interpretation of data provided to the knowledge framework by other units.

21. A method for development and use of a knowledge framework, the method comprising:
receiving session data related to responses received from a participant in a session;
receiving machine learning data;
creating or enhancing the knowledge framework based on the machine learning data and the session data; and
creating additional machine learning data using the knowledge framework as a source of information.

22. The method of claim 21, further comprising:
receiving at least one response;
determining a base score for the at least one response;
determining one or more scoring adjustments; and
determining a weighted score for the at least one response based on the base score and the one or more scoring adjustments.

23. A non-transitory computer readable medium for the development and use of a knowledge framework, the non-transitory computer readable medium having stored thereon software instructions that, when executed by one or more processors, cause the one or more processors to:
receive session data related to responses received from a participant in a session;
receive machine learning data;
create or enhance the knowledge framework based on the machine learning data and the session data; and
create additional machine learning data using the knowledge framework as a source of information.

24. The non-transitory computer readable medium of claim 23, wherein, when executed by one or more processors, the software instructions cause the one or more processors to:
receive additional data from one or more sources,
wherein the knowledge framework is created or enhanced based on the machine learning data, the session data, and the additional data.
